(19) United States
(12) Patent Application Publication
(10) Pub. No.: US 2025/0085513 A1
(43) Pub. Date: Mar. 13, 2025

(54) OPTICAL SYSTEM AND IMAGE PICKUP APPARATUS

(71) Applicant: CANON KABUSHIKI KAISHA, Tokyo (JP)

(72) Inventor: Yuma KOBAYASHI, Tochigi (JP)

(21) Appl. No.: 18/823,825

(22) Filed: Sep. 4, 2024

(30) Foreign Application Priority Data
Sep. 12, 2023 (JP) 2023-147355

(51) Int. Cl. G02B 13/00; G03B 5/00; G03B 13/32

(52) U.S. Cl. CPC G02B 13/0055; G03B 5/00; G03B 13/32; G03B 2205/0007

(57) ABSTRACT

An optical system includes a first transmissive reflective surface, a second transmissive reflective surface located closer to an image than the first transmissive reflective surface, and a lens located closer to an object than the first transmissive reflective surface or closer to the image than the second transmissive reflective surface. The first transmissive reflective surface is configured to move in an optical axis direction during focusing. The lens is separated from each of the first transmissive reflective surface and the second transmissive reflective surface.

### BACKGROUND

### Technical Field

The present disclosure relates to an optical system and an image pickup apparatus.

### Description of Related Art

The miniaturization of imaging optical systems has recently been emphasized due to the prevalence of smartphone cameras, the shift from single-lens reflex cameras to mirrorless cameras in the high-end camera market, and the like. Japanese Patent Laid-Open No. 2005-352273 discloses a compact optical system (polarized light reflecting imaging system) including a polarizing element and a half-mirror.

The optical system disclosed in Japanese Patent Laid-Open No. 2005-352273 has a dark F-number, e.g., 2.85. Due to this configuration, the amount of light from the polarized light reflecting imaging system becomes one-eighth when randomly polarized light is incident thereon. Therefore, the system is configured with an F-number brighter than that of a normal optical system. In addition, the optical system disclosed in Japanese Patent Laid-Open No. 2005-352273 cannot satisfactorily suppress aberrations during focusing or increase the imaging magnification, and thus cannot realize high optical performance over a wide focus range.

### SUMMARY

An optical system according to one aspect of the disclosure includes a first transmissive reflective surface, a second transmissive reflective surface located closer to an image than the first transmissive reflective surface, and a lens located closer to an object than the first transmissive reflective surface or closer to the image than the second transmissive reflective surface. The first transmissive reflective surface is configured to move in an optical axis direction during focusing. The lens is separated from each of the first transmissive reflective surface and the second transmissive reflective surface. An image pickup apparatus having the above optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a schematic diagram illustrating an optical path of an optical system according to each example.

FIG. 2 is a schematic diagram illustrating another optical path of the optical system according to each example.

FIG. 3 is a sectional view of an optical system according to Example 1.

FIGS. 4A and 4B are aberration diagrams of the optical system according to Example 1.

FIG. 5 is a sectional view of an optical system according to Example 2.

FIGS. 6A and 6B are aberration diagrams of the optical system according to Example 2.

FIG. 7 is a sectional view of an optical system according to Example 3.

FIGS. 8A and 8B are aberration diagrams of the optical system according to Example 3.

FIG. 9 is a sectional view of an optical system according to Example 4.

FIGS. 10A and 10B are aberration diagrams of the optical system according to Example 4.

FIG. 11 is a sectional view of an optical system according to Example 5.

FIGS. 12A and 12B are aberration diagrams of the optical system according to Example 5.

FIG. 13 is a sectional view of an optical system according to Example 6.

FIGS. 14A and 14B are aberration diagrams of the optical system according to Example 6.

FIG. 15 is a sectional view of an optical system according to Example 7.

FIGS. 16A and 16B are aberration diagrams of the optical system according to Example 7.

FIG. 17 is a sectional view of an optical system according to Example 8.

FIGS. 18A and 18B are aberration diagrams of the optical system according to Example 8.

FIG. 19 is a sectional view of an optical system according to Example 9.

FIGS. 20A and 20B are aberration diagrams of the optical system according to Example 9.

FIG. 21 is a sectional view of an optical system according to Example 10.

FIGS. 22A and 22B are aberration diagrams of the optical system according to Example 10.

FIG. 23 is a sectional view of an optical system according to Example 11.

FIGS. 24A and 24B are aberration diagrams of the optical system according to Example 11.

FIG. 25 is a sectional view of an optical system according to Example 12.

FIGS. 26A and 26B are aberration diagrams of the optical system according to Example 12.

FIG. 27 is a sectional view of an optical system according to Example 13.

FIGS. 28A and 28B are aberration diagrams of the optical system according to Example 13.

FIG. 29 is a sectional view of an optical system according to Example 14.

FIGS. 30A and 30B are aberration diagrams of the optical system according to Example 14.

FIG. 31 is a sectional view of an optical system according to Example 15.

FIGS. 32A and 32B are aberration diagrams of the optical system according to Example 15.

FIG. 33 is a sectional view of an optical system according to Example 16.

FIGS. 34A and 34B are aberration diagrams of the optical system according to Example 16.

FIG. 35 is a sectional view of an optical system according to Example 17.

FIGS. 36A and 36B are aberration diagrams of the optical system according to Example 17.

FIG. 37 is a sectional view of an optical system according to Example 18.

FIGS. 38A and 38B are aberration diagrams of the optical system according to Example 18.

FIG. 39 is a sectional view of an optical system according to Example 19.

FIGS. 40A and 40B are aberration diagrams of the optical system according to Example 19.

FIG. 41 is a sectional view of an optical system according to Example 20.

FIGS. 42A and 42B are aberration diagrams of the optical system according to Example 20.

FIG. 43 is a sectional view of an optical system according to Example 21.

FIGS. 44A and 44B are aberration diagrams of the optical system according to Example 21.

FIG. 45 is a sectional view of an optical system according to Example 22.

FIGS. 46A and 46B are aberration diagrams of the optical system according to Example 22.

FIG. 47 is a sectional view of an optical system according to Example 23.

FIGS. 48A and 48B are aberration diagrams of the optical system according to Example 23.

FIG. 49 is a sectional view of an optical system according to Example 24.

FIGS. 50A and 50B are aberration diagrams of the optical system according to Example 24.

FIG. 51 is a sectional view of an optical system according to Example 25.

FIGS. 52A and 52B are aberration diagrams of the optical system according to Example 25.

FIG. 53 is a sectional view of an optical system according to Example 26.

FIGS. 54A and 54B are aberration diagrams of the optical system according to Example 26.

FIG. 55 is a schematic diagram of the image pickup apparatus having the optical system according to any one of the above examples.

### DESCRIPTION OF THE EMBODIMENTS

Referring now to the accompanying drawings, a detailed description will be given of embodiments according to the disclosure.

The optical system (imaging optical system) according to each example performs imaging by forming an object image on an image plane, by disposing an image sensor, photosensitive film, or the like on the image plane and by capturing an image. The optical system according to each example includes, in this order from the object side to the image side, a first refractive lens L1, a first transmissive reflective (e.g., transflective) surface HM1, a quarter waveplate QWP, and a second transmissive reflective surface HM2. Light incident from the object side transmits through the first transmissive reflective surface HM1 and the quarter waveplate QWP in this order, and is reflected by the second transmissive reflective surface HM2. The light then transmits through the quarter waveplate QWP, is reflected on the first transmissive reflective surface HM1, transmits through the quarter waveplate QWP and the second transmissive reflective surface HM2, and enters an image plane IM such as an image sensor or photosensitive film. Thus, a phase shifter may be disposed between the first transmissive reflective surface HM1 and the second transmissive reflective surface HM2. The phase shifter can use, for example, a quarter waveplate (QWP) or a 45° optical rotator (such as a Faraday rotator).

The first and second transmissive reflective surfaces HM1 and HM2 do not necessarily have a transmittance of 50% and a reflectance of 50%. A ratio of the transmittance to the reflectance for randomly polarized light may be in a range of 1:3 to 3:1. Randomly polarized light is light with Stokes parameters S0=1, S1=S2=S3=0. Each of the first and second transmissive reflective surfaces HM1 and HM2 may absorb light. A lens (light transmitting members made of glass or resin) may be formed or cemented on both sides or one side of the first transmissive reflective surface HM1 or the second transmissive reflective surface HM2. In other words, at least one of the first transmissive reflective surface and the second transmissive reflective surface may be provided on a cemented surface of two light transmitting members.

The quarter waveplate QWP may use, for example, a crystal, polymer film, or liquid crystal alignment layer having birefringence. A laminate of such crystals, polymer films, or liquid crystal alignment layers may also be used. Properly laminating them can provide a phase difference close to a quarter of the wavelength in a wide wavelength range. For example, “WA-140T” by Nippon Kayaku Co., Ltd., “Polar Correct” by Colorlink Japan Co., Ltd., or the like can be used. The quarter waveplate QWP is not limited to the above example, and may be one using a sub-wavelength structure or meta-structure. More specifically, for example, an inorganic waveplate by Dexerials Corporation or a product named “Nanoable Waveplate” by ENEOS Corporation can be used.

The quarter waveplate QWP may be cemented, for example, with the first transmissive reflective surface HM1 or the second transmissive reflective surface HM2. The quarter waveplate QWP may also be disposed separately from these transmissive reflective surfaces. For example, the film as the quarter waveplate QWP may be inserted directly into the optical path, or the film may be bonded to a glass plate and inserted into the optical path. A lens may be formed or cemented on both sides or one side of the quarter waveplate QWP. For example, a lens may be molded on one side or both sides of the inorganic waveplate using wafer-level optics technology as a substrate.

In a case where an optical system with such a configuration is entirely extended during focusing (i.e., focusing is performed by moving all lenses back and forth along the optical axis by the same moving amount), image quality deteriorates during the extension. An in-focus range generally expected for an imaging lens is from infinity to a distance of more than 0.1 times, and focusing may be able to be performed at least in this range and that high image quality may be secured. Focusing up to a high magnification can be performed. In each example, changing an in-focus position is called focusing. A direction in which optical elements such as lenses and transmissive reflective surfaces are moved during focusing is along the optical axis unless otherwise specified, and a description such as “in the direction along the optical axis” may be omitted. In general, as an optical system has a larger aperture diameter, it becomes more difficult to maintain high image quality over a wide imaging magnification range. The optical system according to each example achieves high image quality over a wide imaging magnification range despite their large apertures.

The optical system according to each example is an imaging optical system that can change an in-focus position by moving the first transmissive reflective surface HM1 back and forth along the optical axis. The optical system according to each example includes a refractive lens that does not move when the in-focus position is changed, or a distance between the refractive lens and the first transmissive reflective surface HM1 changes and the refractive lens is not integrated with any one of the first transmissive reflective surface HM1 and the second transmissive reflective surface HM2 (e.g., the refractive lens is separated from each transmissive reflective surface). The refractive lens, as used herein, does not include an optical element that is a parallel plate or a nearly parallel plate, such as a protective filter, sensor protective glass, IR cut filter, UV cut filter, and low-pass filter. An example of a refractive lens that is not a nearly parallel plate is a spherical lens, for example, in which the absolute value of the radius of curvature of at least one surface is smaller than 1/20 of the overall focal length of the optical system. In addition, “integrated” here means that the lens is cemented, paired, or fixed (e.g., it does not matter if another lens is intervened), and “not integrated” means that an air gap is intervened (e.g., interposed therebetween).

Thus, moving the first transmissive reflective surface HM1 independently during focusing can provide high image quality over a wide focus range. Moving the reflective surface with high aberration correction capability can provide high image quality over a wide focus range. As in each numerical example described later, the first transmissive reflective surface HM1 may have a flat surface. In this case, even if the first transmissive reflective surface HM1 is moved along with focusing and the second transmissive reflective surface HM2 is fixed, high image quality can be achieved. This is for the following reasons. For example, as the first transmissive reflective surface HM1 is moved forward, a distance between the first transmissive reflective surface HM1 and the second transmissive reflective surface HM2 increases. This is equivalent to extending an optical path length from a point where the light beam is reflected by the second transmissive reflective surface HM2 to the image plane, and moving the second transmissive reflective surface HM2 with high aberration correction capability in a pseudo manner. Therefore, even if the first transmissive reflective surface HM1 does not have power, the second transmissive reflective surface HM2 can be moved in a pseudo manner by moving the first transmissive reflective surface HM1, and high image quality can be achieved over a wide focus range.

In order to move an optical element for focusing, a space is required to accommodate the movement. The first transmissive reflective surface HM1 is suitable as a unit to be moved during focusing, since it is easy to secure this space on the object side. If the second transmissive reflective surface HM2 is moved for focusing, it is difficult to secure this space. As in each numerical example described later, the second transmissive reflective surface HM2 may have a shape which is concave toward the object side or may be flat. For focusing from infinity to a close distance, the second transmissive reflective surface HM2 often needs to move toward the image side. In a case where a longer back focus is required, such as in a lens for a lens interchangeable type camera, a non-usable space is to be provided on the image side of the second transmissive reflective surface HM2. Even if the back focus can be reduced, it is difficult to secure sufficient space for focusing. This is because a refractive lens is to be placed on the image side of the second transmissive reflective surface HM2 to correct the image plane fluctuation or to increase the light condensing power and increase the Fno.

In the optical system according to each example, the following inequality (1) may be satisfied:

$$- 1. \leq φ fr / φ total \leq 0.42 \qquad ( 1 )$$

where φfr is refractive power a portion of the optical system on the object side of the first transmissive reflective surface HM1, and φtotal is power of the (entire) optical system.

In the optical system according to each example, a reflective surface has the highest aberration correcting ability. The reflective surface has a Petzval sum with the opposite sign to the refractive power of the reflective surface, and does not generate chromatic aberration. The way of effectively utilizing this reflective surface is important in achieving high image quality over a wide focus range despite the large aperture.

Satisfying inequality (1) can make a light beam enter the reflective surface at a high ray height and exit the reflective surface at an angle close to the normal to the reflective surface (generally, as an incident angle relative to the surface normal increases, the aberration of the ray increases). Therefore, high image quality can be realized in a wide focus range. In a case where the value becomes higher than the upper limit of inequality (1), a ray is largely converged on the front side (object side) of the first transmissive reflective surface HM1, and an incident ray height on the reflective surface reduces. Hence, the contribution of the reflective surface to the aberration correction becomes small, and it is difficult to realize high image quality in a wide focus range. On the other hand, in a case where the value becomes lower than the lower limit of inequality (1), the effective diameter of the reflective surface increases, the size of the entire optical system increases, and the weight of the lens unit (focus unit) that is moved during focusing increases. In addition, the optical system as a whole tends to have an increased characteristic of an inverted telephoto type, so the overall optical length increases. In a case where the weight of the focus unit increases, a large and high-thrust motor is to be used during autofocus (AF), which increases the size and the manufacturing cost. The refractive power on the object side of the first transmissive reflective surface HM1 is, for example, the refractive power of a subgroup from the first surface to the third surface in numerical example 1 described later.

In the optical system according to each example, the following inequality (2) may be satisfied:

$$0.15 \leq Hm 2 / f \leq 3. \qquad ( 2 )$$

where Hm2 is a distance from the optical axis to the reflection point in a direction perpendicular to the optical axis when an on-axis marginal ray is reflected by the second transmissive reflective surface HM2, and f is a focal length of the (entire) optical system.

In a case where the value becomes higher than the upper limit of inequality (2), the transmissive reflective surface becomes too large for the specification of the optical system, and the size of the entire optical system increases. In addition, in the optical system according to each example, the transmissive reflective surface having reflective power tends to have high tilt sensitivity to aberrations. Thus, the transmissive reflective surface having reflective power may have a tilt adjusting mechanism, and in a case where this mechanism is incorporated, the diameter of the optical system including the lens barrel becomes even larger. On the other hand, in a case where the value becomes lower than the lower limit of inequality (2), the incident ray height on the reflective surface becomes too low, and the longitudinal chromatic aberration cannot be sufficiently corrected. As the aperture diameter increases, the influence of longitudinal chromatic aberration on image quality increases, so the longitudinal chromatic aberration may be particularly small in a lens having a large aperture diameter such as the optical system according to the example.

In the optical system according to each example, the following inequality (3) may be satisfied:

$$0. \leq dpupil / f \leq 2.0 \qquad ( 3 )$$

where dpupil is a distance from a surface closest to the object to the entrance pupil of the optical system.

Here, the entrance pupil is an entrance pupil for an on-axis light beam, which is an entrance pupil at a maximum aperture in an optical system having an aperture stop). In a case where the value becomes higher than the upper limit of inequality (3), shielding of an off-axis light beam by the lens barrel and the outer periphery of the lens and consequently the peripheral dimming increase. In order to prevent light shielding, the lens diameter on the object side is to be increased, and thus the size of the entire optical system increases. By definition, the value never becomes lower than the lower limit of inequality (3) in a general optical system.

In the optical system according to each example, the following inequality (4) may be satisfied:

$$0.6 \leq Pm 1 / Ppupil \leq 2. \qquad ( 4 )$$

where Pm1 is an effective diameter of the first transmissive reflective surface HM1, and Ppupil is an entrance pupil diameter of the optical system.

Here, the entrance pupil is an entrance pupil for an on-axis light beam. The effective diameter of the first transmissive reflective surface HM1 is the larger of a diameter of an area through which a normal light beam transmits and a diameter of an area that reflects it in the first transmissive reflective surface HM1. In a case where the value becomes higher than the upper limit of inequality (4), the effective diameter of the first transmissive reflective surface HM1 is large relative to the entrance pupil diameter, and the weight of the focus unit increases. On the other hand, in a case where the value becomes lower than the lower limit of inequality (4), the effective diameter of the first transmissive reflective surface HM1 relative to the entrance pupil reduces, and shielding of the off-axis light beam and consequently the peripheral dimming increase. In addition, the first transmissive reflective surface HM1 and the second transmissive reflective surface HM2 cannot sufficiently correct aberrations, and image quality cannot be improved.

In the optical system according to each example, the following inequality (5) may be satisfied:

$$0.5 \leq Fno \leq 2.5 \qquad ( 5 )$$

where Fno is an F-number of the optical system.

In a case where the value becomes higher than the upper limit of inequality (5), a light amount reaching the image plane becomes too small, together with the loss of light due to each transmissive reflective surface. In addition, the polarizer (polarizing plate) and polarization-selective transmissive reflective element described later generally cannot completely absorb or reflect light in the absorption axis or reflection axis direction, respectively. Thus, the light for the characteristic error reaches the image plane directly without being reflected by either of the two transmissive reflective surfaces, for example, and becomes ghost light. Since the intensity of this ghost light does not depend on the F-number, the ghost light intensity relatively decreases as the F-number becomes brighter. Thus, the value may be within the range of inequality (5) from the viewpoint of reducing ghost light intensity. In addition, in the general case where the medium on the image side is air, the value never becomes lower than the lower limit of inequality (5).

Assume that the optical system according to each example includes a refractive lens that is disposed on the object side of the first transmissive reflective surface HM1, is configured to integrally move with the first transmissive reflective surface HM1 during focusing, and has an air gap between it and the first transmissive reflective surface HM1. Then, the following inequality (6) may be satisfied:

$$- 1. \leq φ b / φtotal \leq 0.7 \qquad ( 6 )$$

where φb is refractive power of a portion of the optical system on the object side of a lens unit that moves integrally with the first transmissive reflective surface HM1 during focusing.

During focusing, a light beam that is generally as close to a parallel light beam as possible may enter the focus unit, and by doing so, high image quality can be achieved over a wide focus range. In a case where the value becomes higher than the upper limit of inequality (6), light with a strong convergence tendency enters the focus unit and this is not suitable due to the above reasons. In addition, the back focus reduces unless the focus unit has strong negative power. Thus, this is not suitable for applications that require a relatively long back focus, such as those for lens interchangeable type camera systems. In addition, the light rays converge largely on the front side of the first transmissive reflective surface HM1, and the incident ray height on the reflective surface reduces. Therefore, the contribution of the reflective surface to aberration correction decreases, and it becomes difficult to realize high image quality over a wide focus range. On the other hand, in a case where the value becomes lower than the lower limit of inequality (6), the effective diameter of the reflective surface and finally the size of the entire optical system increase, and the weight of the lens unit (e.g., focus unit) that is moved during focusing increases. In addition, the overall optical system tends to have an increased characteristic of an inverted telephoto type, so the overall optical length increases.

In the optical systems according to each example, the following inequality (7) may be satisfied:

$$0.005 \leq \vert Δ df \vert / f / Fno \leq 1. \qquad ( 7 )$$

where |Δdf] is a moving amount (during focusing) when the in-focus position is changed from infinity to a distance corresponding to 10 times the focal length of the (entire) optical system.

In a case where the value becomes higher than the upper limit of inequality (7), a moving amount for focusing increases. The moving (or extending) amount of the focus unit increases, and the optical system becomes large during movement (extension). Alternatively, the moving amount of the focus unit becomes too large, and the AF time becomes long. On the other hand, in a case where the value becomes lower than the lower limit of inequality (7), a focusing amount becomes too small for the depth of field, and fine focusing becomes difficult.

In the optical system according to each example, a distance (spacing) between the first transmissive reflective surface HM1 and the second transmissive reflective surface HM2 may change during focusing. Since normal light passes the area between the reflective surfaces a total of three times, by making this spacing variable, high image quality can be realized over a wide focus range while a moving amount of the optical element along with focusing is suppressed.

In the optical system according to each example, in changing an in-focus position (during focusing), the aperture stop SP may be moved integrally with the first transmissive reflective surface HM1. Thus, the aperture stop SP or the entrance pupil is moved toward the object side along with focusing, and thereby the one-sided aperture for focusing from infinity to a close distance can be suppressed. The one-sided aperture is a phenomenon in which the center of an off-axis light beam passes a position away from the center of the aperture stop when an off-axis light beam passes the aperture stop. In a case where a distance between the centers is small, this is not a big problem, but in a case where the distance is large, problems such as peripheral dimming or an uneven blur shape when the aperture is narrowed occur.

In the optical system according to each example, a refractive lens disposed outside an area between the first transmissive reflective surface HM1 and the second transmissive reflective surface HM2 may be moved along with focusing. That is, at least one of a refractive lens on the object side of the first transmissive reflective surface HM1 and a refractive lens on the image side of the second transmissive reflective surface HM2 may be moved as a focus unit (or floating unit). The lens between the two transmissive reflective surfaces acts on the light beam three times, so it has a strong influence on aberration correction, but a fine adjustment of the aberration correcting effect is difficult. A refractive lens configured to act on the light beam only once to moderately affect the aberration, and disposed outside the transmissive reflective surface may be moved as a focus unit (or floating unit).

In the optical system according to each example, each of the first transmissive reflective surface HM1 and the second transmissive reflective surface HM2 may not rotate by 0.50 or more around the optical axis in changing the in-focus position. As described later, in the optical system according to each example, the relative angles of the quarter waveplate QWP and each transmissive reflective surface with the optical axis as the rotation axis are important for suppressing ghosts and securing a light amount of normal light. Thus, the rotational movement of each of the first transmissive reflective surface HM1 and the second transmissive reflective surface HM2 around the optical axis during focusing may be sufficiently small. In a case where all anisotropic elements such as the quarter waveplate QWP and each transmissive reflective surface rotate by the same amount, there is no problem in terms of suppressing ghosts and securing a light amount of normal light. However, in a case where the polarization degree of the light incident on the optical system is not low, a transmitting light direction changes due to the equal rotation of each element. Therefore, depending on the object, brightness changes and color changes may occur along with focusing.

In the optical systems according to each example, the following inequality (8) may be satisfied:

$$0. \leq \vert θ m \vert \leq 8. \qquad ( 8 )$$

where θm (°) may be the smaller of an open angle of the first transmissive reflective surface HM1 and an open angle of the second transmissive reflective surface HM2.

Here, the open angle is an angle of a surface normal relative to a direction perpendicular to the optical axis, and is evaluated at the maximum value within the effective surface. The effective surface is an area through which normal light (i.e., non-ghost or non-stray light) transmits.

As described later, in the optical system according to each example, one of the first transmissive reflective surface HM1 and the second transmissive reflective surface HM2 may use a polarization-selective transmissive reflective element such as a polarizing beam splitter (PBS), and the other may use a half-mirror. The half-mirror can be formed by depositing a metal or dielectric multilayer film on glass or resin by vapor deposition or sputtering, so it can support a relatively wide range of open angles. On the other hand, it is difficult to form a polarization-selective transmissive reflective element on a curved surface. In a case where the shape is close to a flat surface, it can be manufactured using a process similar to that of the flat surface, but as the surface shifts from the flat surface, a special process is to be used. Thus, in a case where the value becomes higher than the upper limit of inequality (8), it is difficult to form a polarization-selective transmissive reflective element. By definition, the value never becomes lower than the lower limit of inequality (8).

In a case where a flexible material such as a resin film or a wire grid with a resin film as a base material is used as the polarization-selective transmissive reflective element, the surface accuracy of the transmissive reflective surface is to be properly maintained. Thus, in a case where one of the first transmissive reflective surface HM1 and the second transmissive reflective surface HM2 is made of such a material, it may be cemented with glass or hard resin with a glass transition temperature of 40° C. or higher. Both surfaces may be cemented with glass or hard resin with a glass transition temperature of 40° C. or higher. The adhesive (e.g., comprising an elastic adhesive) for cementing is not particularly specified here, but the adhesive layer may be 25 μm or less, or 15 μm or less. In a case where only one surface is cemented, a holder may not directly contact the transmissive reflective surface in holding the lens. For example, it may be held at the cemented glass or hard resin portion. This configuration can reduce the surface distortion of the transmissive reflective surface.

Regarding surface precision, the roughness of the reflected wavefront may be sufficiently smooth, and rms of the component of 1/mm or more on the reflected wavefront may be 10 nm or less, and rms of the component of 0.05/mm or more and 1/mm or less may be 10 nm or less. This configuration can sufficiently suppress deterioration of image quality caused by poor surface precision of the reflective surface.

In each example, at least one of the first transmissive reflective surface HM1 and the second transmissive reflective surface HM2 may be spherical. Using an aspheric surface is beneficial in aberration correction, but it is more difficult to make the surface shape closer to a designed value than a spherical surface. Therefore, manufacture becomes easier if it uses a spherical surface. In addition, fine processing marks tend to remain on the aspheric surface, and in a case where such processing marks remain on a reflective surface in particular, patterns resulting from the processing marks are likely to be reflected in the image degradation (bokeh). In lenses having large aperture diameters for image and video applications, users also emphasize the quality of the image degradation, so such patterns may not appear.

The optical system according to each example may include an image stabilizing unit. The image stabilizing unit is a unit that provides the optical system with a blur preventing function such as camera shake caused due to moving the camera by an identifiable, or proper, amount (e.g., according to a detected blur amount) in the direction perpendicular to the optical axis during imaging. The image stabilizing unit may be placed on the object side of the first transmissive reflective surface. In this way, the image stabilizing unit can be incorporated without increasing the overall length of the optical system. The transmissive reflective surface may not be used as the image stabilizing unit because aberrations during the image stabilizing operation become large.

In a case where the optical system according to each example has an image stabilizing unit, the following inequality (9) may be satisfied:

$$0.6 \leq β \leq 1.5 \qquad ( 9 )$$

where β is a lateral magnification of a lens unit on the image side of the second transmissive reflective surface HM2.

In a case where the value becomes higher than the upper limit of inequality (9), the number of lens units on the image side of the second transmissive reflective surface HM2 increases, and the overall length or the aberration of the lens unit on the image side of the second transmissive reflective surface HM2 increases. On the other hand, in a case where the value becomes lower than the lower limit of inequality (9), a moving amount in the direction perpendicular to the optical axis of the image stabilizing unit for a sufficient image stabilizing effect becomes too large, and it becomes difficult to configure a drive mechanism that performs image stabilization.

The optical system according to each example may be a coaxial system. This configuration increases the ease of manufacturing each component and facilitates the assembly process. However, the effective diameters and outer diameters of the lens and transmissive reflective surface do not need to be rotationally symmetric, and, for example, rectangular ones may be used.

The optical system according to each example may be a primary imaging system. In a case where the optical system is a secondary or higher order imaging system, the light rays that have been imaged once are to be re-imaged, and the overall length increases.

In a case where the optical system according to each example has an AF function, and a large aperture diameter with an F-number of 1.4 or less, high stopping accuracy of the focus unit is required. Thus, for example, mechanical stoppers are provided at two points at infinity and a close distance, and the focus unit is moved so as to press against the stoppers, AF can be performed with high stopping accuracy at least for infinity and the close distance.

Inequalities (1) to (9) may be replaced with inequalities (1a) to (9a) below:

$$- 0.8 \leq φ fr / φtotal \leq 0.405 \qquad ( 1 a )$$

$$0.165 \leq Hm 2 / f \leq 2. \qquad ( 2 a )$$

$$0. \leq dpupil / f \leq 1.75 \qquad ( 3 a )$$

$$0.7 \leq Pm 1 / Ppupil \leq 1.9 \qquad ( 4 a )$$

$$0.5 \leq Fno \leq 2.4 \qquad ( 5 a )$$

$$- 0.75 \leq φ b / φtotal \leq 0.65 \qquad ( 6 a )$$

$$0.01 \leq \vert Δ df \vert / f / Fno \leq 0.9 \qquad ( 7 a )$$

$$0. \leq \vert θ m \vert \leq 6. \qquad ( 8 a )$$

$$0.6 \leq β \leq 1.2 \qquad ( 9 a )$$

Inequalities (1) to (9) may be replaced with inequalities (1b) to (9b) below:

$$- 0.5 \leq φ fr / φtotal \leq 0.35 \qquad ( 1 b )$$

$$0.18 \leq Hm 2 / f \leq 1. \qquad ( 2 b )$$

$$0. \leq dpupil / f \leq 1.4 \qquad ( 3 b )$$

$$0.75 \leq Pm 1 / Ppupil \leq 1.85 \qquad ( 4 b )$$

$$0.52 \leq Fno \leq 2.2 \qquad ( 5 b )$$

$$- 0.5 \leq φ b / φtotal \leq 0.6 \qquad ( 6 b )$$

$$0.015 \leq \vert Δ df \vert / f / Fno \leq 0.8 \qquad ( 7 b )$$

$$0. \leq \vert θ m \vert \leq 5. \qquad ( 8 b )$$

$$0.6 \leq β \leq 1. \qquad ( 9 b )$$

As described later, in the optical system according to each example, a polarization-selective transmissive reflective element may be used as one of the first transmissive reflective surface HM1 and the second transmissive reflective surface HM2. Examples of the polarization-selective transmissive reflective element include “WGF” manufactured by Asahi Kasei Corporation, “IQP-E” manufactured by 3M Company, and “ProFlux” manufactured by Moxtek, Inc. The transmittance of the reflection axis of the polarization-selective transmissive reflective element may be about 1% or less, or 0.5% or less, or 0.25% or less, on average in the use wavelength range. Thus, stray light that reaches the image plane without being reflected once by the reflection surface (this will be called a “single-path ghost”) can be effectively suppressed. However, even if the polarization-selective transmissive reflective element has a high transmittance of the reflection axis, the single-path ghost can be suppressed by using it in combination with a linear polarizer. A half-mirror or cholesteric liquid crystal can be used as the other transmissive reflective surface. In a case where a half-mirror is used, a light amount of randomly polarized light incident from the object side becomes 12.5% or less up to a time when the light reaches the image plane. By using cholesteric liquid crystal, the light amount on the image plane can be approximately doubled compared to that in a case where a half-mirror is used.

The optical system according to each example having the following configuration, for example, can suppress the decrease in the light amount in the normal imaging optical path while reducing ghost light (unnecessary light leakage) that transmits through the transmissive reflective surface from the optical path without being reflected even once.

The optical system according to each example may use as the polarization-selective reflective element an optical element created by forming a grid on a lens reflective surface during lens molding and then by evaporating, printing, or lithographing a metal or dielectric material.

### Configuration 1 Utilizing Polarization

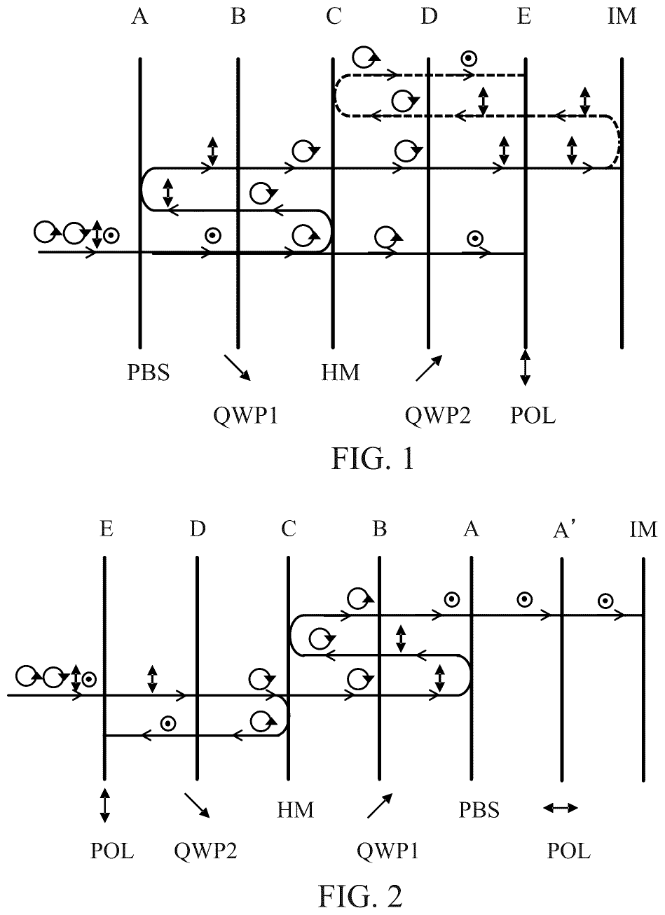

Referring now to FIG. 1, a description will be given of a configuration utilizing polarization. FIG. 1 is a schematic diagram illustrating an optical path of an optical system according to this example. The optical system according to this example includes two transmissive reflective surfaces. Here, the transmissive reflective surface disposed on the object side of the optical system according to this configuration includes a polarization-selective transmissive reflective element (polarizing beam splitter: PBS): A. The transmissive reflective surface disposed on the image plane side of the imaging optical system according to this example includes a half-mirror (HM): C. A first quarter waveplate (QWP1): B is disposed between the polarization-selective transmissive reflective element PBS and the half-mirror HM. A second quarter waveplate (QWP2): D and a linear polarizer (POL): E are disposed between the half-mirror HM and the image plane IM. Here, the polarization-selective transmissive reflective element A is an element configured to reflect linearly polarized light polarized in the same direction as that when it has transmitted through the linear polarizer E, and to transmit linearly polarized light perpendicular to this direction.

The polarization-selective transmissive reflective element is, for example, a wire grid polarizer or a reflection type polarizer having a laminated retardation film configuration. At this time, the wire grid forming surface or retardation film surface of the polarization-selective transmissive reflective element A functions as a transmissive reflective surface. The wire grid polarizer does not necessarily have to be made of aligned metal wires, but may be anything including thin metal or dielectric layers arranged at predetermined intervals as long as it can function as a polarization-selective transmissive reflective element. For example, an element having metal or dielectric layers aligned by vapor deposition may be used.

The first quarter waveplate B and the second quarter waveplate D are arranged with their slow axes tilted at 45° relative to the polarization transmission axis of the linear polarizer E. Here, the first quarter waveplate B and the second quarter waveplate D may be arranged with their slow axes tilted at 90°. Due to this arrangement, in a case where a ray transmits through the first quarter waveplate B and the second quarter waveplate D, the wavelength dispersion characteristics of the waveplates are cancelled out. The half-mirror C is a half-mirror formed, for example, by a dielectric multilayer film or metal deposition, and the half-mirror C functions as a transmissive reflective surface. The linear polarizer E is, for example, an absorption type linear polarizer.

A description will now be given of the optical path selection and function in the configuration utilizing the polarization. Light incident on the optical system from the object side becomes linearly polarized light by the polarization-selective transmissive reflective element A, becomes circularly polarized light by the first quarter waveplate B, and enters the half-mirror C. A part of the light that reaches the half-mirror C is reflected, becomes circularly polarized in the reverse direction, and returns to the first quarter waveplate B.

The reverse-circularly polarized light that has returned to the first quarter waveplate B returns to the polarization-selective transmissive reflective element A by the first quarter waveplate B as linearly polarized light polarized in a direction orthogonal to the direction when the light first transmitted through the polarization-selective transmissive reflective element A, and is reflected by the polarization-selective transmissive reflective element A. Here, due to the polarization selectivity of the polarization-selective transmissive reflective element A, linearly polarized light polarized in the direction perpendicular to the direction when the light first passed the polarization-selective transmissive reflective element A is reflected.

A part of the light that has reached the half-mirror C transmits through it, becomes linearly polarized light by the second quarter waveplate D polarized in the same direction as that when the light passed the polarization-selective transmissive reflective element A, enters the linear polarizer E, and is absorbed by the linear polarizer E.

The light reflected by the polarization-selective transmissive reflective element A becomes circularly polarized by the first quarter waveplate B and enters the half-mirror C. A part of the light that has reached the half-mirror C transmits through it and enters the second quarter waveplate D. Due to the second quarter waveplate D, the incident light becomes linearly polarized light polarized in a direction parallel to that of the linearly polarized light reflected by the polarization-selective transmissive reflective element A. The light that transmits through the second quarter waveplate D enters the linear polarizer E. Here, the polarization of the light and the transmission axis of the linear polarizer E match, so most of the light transmits and is guided to the image plane IM.

Due to the above action, only the light that transmits through the polarization-selective transmissive reflective element PBS, is reflected by the half-mirror C, is reflected by the polarization-selective transmissive reflective element PBS, and transmits through the half-mirror C is guided to the image plane IM. In a case where a cholesteric liquid crystal is used instead of the half-mirror C, the cholesteric liquid crystal may be installed so that during the first reflection of the cholesteric liquid crystal, circularly polarized light in a direction of incident light is largely reflected. Thus, a light amount on the normal optical path can be increased while ghost light is reduced.

Image sensors and Charge Coupled Devices (CCDs) that can be used for the image plane IM generally have high surface reflectance. In this configuration, the light reflected on the image plane IM transmits through the linear polarizer E again and is converted into circularly polarized light by the second quarter waveplate D. The light emitted from the second quarter waveplate D is then reflected on the half-mirror C, becomes circularly polarized light in the opposite direction, and transmits through the second quarter waveplate D again. At this time, the circularly polarized light is converted by the second quarter waveplate D into linearly polarized light polarized in a direction perpendicular to that of the light that has just transmitted through the linear polarizer E. Since the direction of this linearly polarized light is orthogonal to the transmission axis of the linear polarizer E, most of the light is absorbed by the linear polarizer E. Thus, in this configuration, most of the light that is reflected on the image plane IM, the half-mirror C, and the image plane IM in this order is cut off, ghosts and flares relating to the image plane IM are less conspicuous. In order to obtain such a reflection reducing effect, no optical low-pass filter using birefringence may be located between the image plane IM and the linear polarizer E. This is because the optical low-pass filter causes the polarization state to shift from the desired polarization state.

In this configuration, a third quarter waveplate (not illustrated) may be disposed just after (e.g., next to and on the image side) of the linear polarizer E. In this case, an angle between the absorption axis of the linear polarizer E and the slow axis of the third quarter waveplate may be 45° or 135° (when viewed from the optical axis direction). This configuration can further suppress light reflected by the image plane IM and reflection of the lens surface between the third quarter waveplate and the image plane IM.

In addition, in this configuration, a linear polarizer (not illustrated) may be disposed between the polarization-selective transmissive reflective element A and the object. At this time, the polarization-selective transmissive reflective element A and the linear polarizer are placed so that their transmission axes coincide with each other. This configuration can reduce ghosts caused by light that has been reflected by the polarization-selective transmissive reflective element A and reflected by the lens surface between the polarization-selective transmissive reflective element A and the object. In addition, this configuration can largely absorb polarized light in the reflection axis direction of the polarization-selective transmissive reflective element A, and significantly reduce the single-path ghost. In addition, absorbing ultraviolet rays and the like can improve the environmental resistance of the polarization-selective transmissive reflective element A.

In this configuration, a quarter waveplate may be placed between the polarization-selective transmissive reflective element A and the object (in a case where the above linear polarizer is disposed, it is disposed between the linear polarizer and the object). At this time, the quarter waveplate and the polarization-selective transmissive reflective element A are arranged so that the fast axis or slow axis of the quarter waveplate forms an angle of 45° with the transmission axis of the polarization-selective transmissive reflective element A. Thus, even if the light incident from the object side is linearly polarized, pseudo depolarization is performed and imaging is available regardless of its polarization direction. A depolarizing element may be placed instead of the quarter waveplate. For example, product name “Cosmoshine SRF” by Toyobo Co., Ltd. can be used as the depolarizing element. Cosmoshine SRF is a film with a large birefringence of about 10,000 nm, and this film can prevent color unevenness caused by the wavelength characteristic and angle characteristic of the waveplate compared to the case where a quarter waveplate is used.

### Configuration 2 Utilizing Polarization

Referring now to FIG. 2, a description will be given of a configuration utilizing polarization. FIG. 2 is a schematic diagram of an optical path of an optical system according to each example. The optical system according to each example includes two transmissive reflective surfaces. Here, the transmissive reflective surface placed on the object side of the optical system according to each example includes a half-mirror (HM): C. The transmissive reflective surface disposed on the display element side of the optical system according to each example includes a polarization-selective transmissive reflective element (PBS): A. A first quarter waveplate (QWP1): B is disposed between the polarization-selective transmissive reflective element PBS and the half-mirror HM. A linear polarizer (POL): E and a second quarter waveplate (QWP2): D are arranged between the half-mirror HM and the object plane. The configuration of each polarizing element and the suitable arrangement of the optical axis azimuth are similar to those of the configuration 1 utilizing the polarization.

A description will now be given of the optical path selection and action in the configuration utilizing the polarization. Light incident on the optical system from the object side becomes linearly polarized light by the linear polarizer E, becomes circularly polarized light by the second quarter waveplate D, and enters the half-mirror C. A part of the light that has reached the half-mirror C is reflected, becomes circularly polarized light in the opposite direction, and returns to the second quarter waveplate D.

The light that reaches and is reflected by the half-mirror C becomes circularly polarized light in the opposite direction to the incident direction. This light is converted by the second quarter waveplate D into linearly polarized light polarized in a direction perpendicular to the direction when it transmitted through the linear polarizer E, enters the linear polarizer E, and is absorbed by the linear polarizer E.

The light that has transmitted through the half-mirror C is converted by the first quarter waveplate B into linearly polarized light polarized in the same direction as that of the light that has just transmitted through the linear polarizer E. This linearly polarized light is reflected by the polarization-selective transmissive reflective element A and returns to the first quarter waveplate B. The light is then converted into circularly polarized light by the first quarter waveplate B, and a part of it is reflected by the half-mirror C. The light reflected by the half-mirror C again enters the first quarter waveplate B and is converted into linearly polarized light whose polarization direction is perpendicular to the direction when it was reflected by the polarization-selective transmissive reflective element A. This linearly polarized light transmits through the polarization-selective transmissive reflective element A and is guided to the image plane IM.

Due to the above action, only the light that transmits through the half-mirror C, is reflected on the polarization-selective transmissive reflective element PBS, is reflected on the half-mirror C, and transmits through the polarization-selective transmissive reflective element PBS is guided to the image plane IM.

Due to this arrangement, a linear polarizer A′ may be placed between the polarization-selective transmissive reflective element A and the image plane IM. In this case, the transmission axes of the linear polarizer A′ and the polarization-selective transmissive reflective element A are made to match. This configuration can absorb light that is reflected on the image plane IM, is reflected on the polarization-selective transmissive reflective element A, enters the image plane IM again, and becomes ghosts and flares. In addition, this configuration can largely absorb light that has leaked from the reflection axis direction of the polarization-selective transmissive reflective element A, and significantly reduce the single-path ghost.

This configuration may place a quarter waveplate between the linear polarizer E and the object. At this time, the quarter waveplate and the linear polarizer E are arranged so that the fast axis or slow axis of the quarter waveplate forms an angle of 45° with the transmission axis of the linear polarizer E. In this way, even if the light incident from the object side is linearly polarized light, imaging is available regardless of its polarization direction. A depolarizing element may be placed instead of the quarter waveplate. An example of a depolarizing element can use “Cosmoshine SRF” manufactured by Toyobo Co., Ltd.

In the above description of the two configurations, terms such as orthogonal (perpendicular), parallel, and 45° do not have to be strictly 90°, 0°, and 45°. However, these angles are to be within ±5° from the desired angles, or may be within ±2° from the desired angles, or may be within ±1° from the desired angles.

Both of the above two configurations may use two quarter waveplates QWP having the same structure. There is no problem if the quarter waveplate QWP is ideal (i.e., it gives a phase of exactly quarter wavelength for all wavelengths and all ray incidence angles within the use range). However, in reality, such a quarter waveplate QWP does not exist, and the phase given to light differs depending on the wavelength of the transmitting light, etc. In the above two configurations, the phases given by the first quarter waveplate QWP1 and the second quarter waveplate QWP2 are cancelled out while the light transmits through the two quarter waveplates QWP, and the desired light is emitted toward the image plane side. That is, the light reflected once by each of the first transmissive reflective surface and the second transmissive reflective surface is emitted to the image side, and the light that has never been reflected is absorbed by the polarizer. At this time, in a case where the characteristics of the first quarter waveplate QWP1 and the second quarter waveplate QWP2 are different from each other, unintended light is emitted toward the image plane by the difference, ghosts and flares occur and degrade the image quality.

In the above two types of configurations, the linear polarizer E may be an absorption type polarizer rather than a reflection type. This is because the absorption type polarizer is less likely to cause ghosts and flares caused by reflections. For the linear polarizer E, the transmittance of the absorption axis may be about 0.5% or less on average in the use wavelength range, or 0.15% or less, or 0.05% or less. This configuration can effectively suppress ghost light that would reach the image plane without being reflected by the reflective surface. In particular, in a case where the use wavelength range is wide, it is difficult to maintain the transmittance of the absorption axis of the polarizer low, but a plurality of polarizers may be used in layers to obtain the desired characteristic. The linear polarizer E can use, for example, “ACE-125U” or “VHC-12UL2S” manufactured by Nippon Kayaku Co., Ltd., or “XP42HE” manufactured by Edmund Optics Japan Co., Ltd. in the visible range. For example, by stacking “ACE-125U” and “SHC-115U” manufactured by Nippon Kayaku Co., Ltd., a linear polarizer can be obtained with extremely low transmittance of the absorption axis. By stacking a plurality of polarizers in this way, resistance to deterioration over time can be improved.

Assume that the above two types of configurations are used in combination with an image sensor including an optical low-pass filter. At this time, a relative angle between the transmission axis of the polarizer closest to the image plane and the fast axis of the birefringent plate closest to the object among the birefringent plates of the optical low-pass filter may be 45° or 135°. This configuration can provide a low-pass effect similar to that of a normal optical system (e.g., having no polarization dependency unlike a general dioptric optical system). Alternatively, a quarter waveplate may be disposed on the image side of the polarizer closest to the image plane. In that case, the transmission axis of the polarizer closest to the image plane and the fast axis of the quarter waveplate may be set to 45° or 135°. This configuration emits circularly polarized light toward the image sensor, and thereby can provide a low-pass effect similar to that of a normal optical system. Alternatively, the emitted light may be made pseudo-randomly polarized by placing a plastic molded lens with large birefringence on the image side of the polarizer closest to the image plane, and a low-pass effect similar to that of a normal optical system can be obtained.

In the above two types of configurations, each of the polarization-selective transmissive reflective element, the quarter waveplate, and the linear polarizer may be circular, rectangular, or polygonal. Shapes that can be laid out on a flat surface without any margins, such as rectangles and regular hexagons, may be suitable in terms of manufacturing costs because each element can be used without waste. Among these optical elements, those made mainly of polymer materials are available at low cost. In a case where such elements are used, they may be bonded to glass or resin, for example, as described above, to secure sufficient surface accuracy. This form can eliminate material loss by bonding them in a large size and by cutting out an amount for a rectangle from it. As described above, the azimuth between the elements is important in the above two types of configurations. The rectangular element can easily guarantee the outer shape of the part and the orientation of the element (e.g., fast axis, slow axis, transmission axis, absorption axis, transmission axis, and reflection axis) for each part, and simplify or omit adjustment of the azimuth.

In the optical system according to each example, the lens may be made of a resin material or a glass material. However, a lens placed between the first and second transmissive reflective surfaces may have low birefringence.

The optical system according to each example includes, in order from the object side to the image side, a first refractive lens L1, a first transmissive reflective surface HM1, a quarter waveplate QWP, and a second transmissive reflective surface HM2. During focusing, the first transmissive reflective surface HM1 moves in the optical axis direction. During focusing, the first refractive lens L1 does not move, or moves so as to change a distance in the optical axis direction between the first refractive lens L1 and the first transmissive reflective surface HM1. The first refractive lens L1 is separated from each of the first transmissive reflective surface HM1 and the second transmissive reflective surface HM2.

Alternatively, the optical system according to each example includes, in this order from the object side to the image side, the first refractive lens L1, the first transmissive reflective surface HM1, the quarter waveplate QWP, the second transmissive reflective surface HM2, and the second refractive lens L2. During focusing, the first transmissive reflective surface HM1 moves in the optical axis direction. During focusing, the second refractive lens L2 does not move, or a distance in the optical axis direction between the second refractive lens L2 and the first transmissive reflective surface HM1 changes. The second refractive lens L2 is separated from each of the first transmissive reflective surface HM1 and the second transmissive reflective surface HM2.

The optical system according to each example may include a third refractive lens that is disposed on the object side of the first transmissive reflective surface HM1, separated from the first transmissive reflective surface HM1, and configured to move integrally with the first transmissive reflective surface HM1 during focusing. The optical system according to each example may include a fourth refractive lens that is disposed outside an area between the first transmissive reflective surface HM1 and the second transmissive reflective surface HM2, and moves in the optical axis direction during focusing.

The optical system according to each example will be described in detail below.

### Example 1

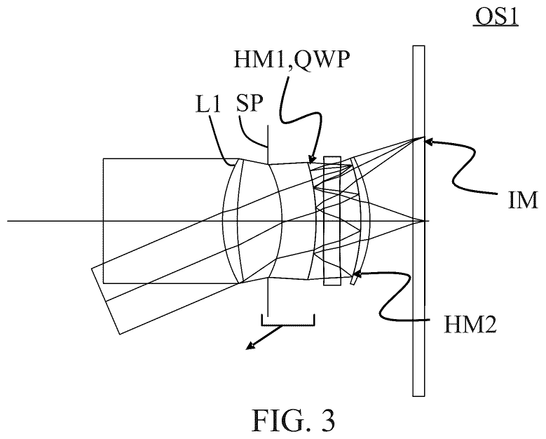

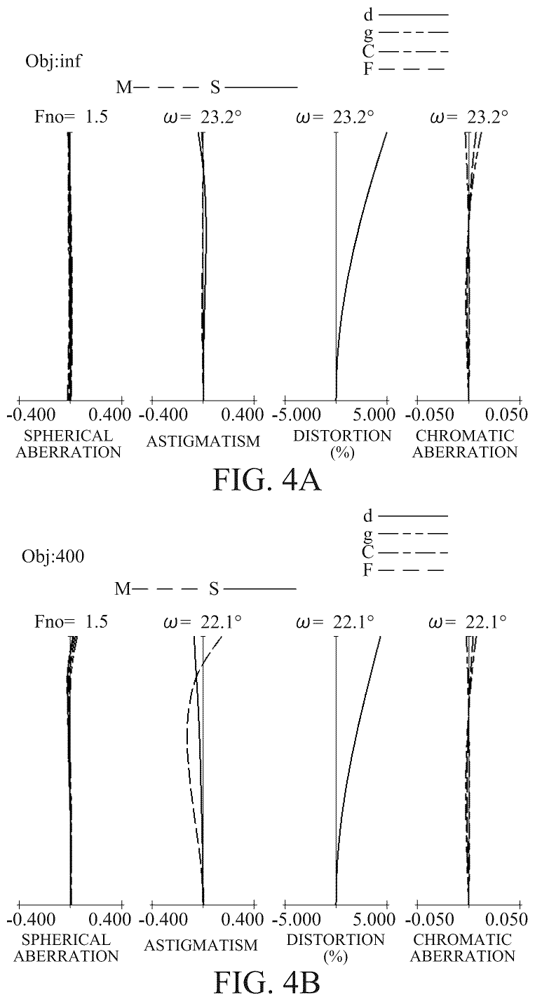

Referring now to FIGS. 3, 4A, and 4B, a description will be given of an optical system OS1 according to Example 1. FIG. 3 is a sectional view of the optical system OS1. The optical system OS1 includes, in order from the object side to the image plane IM side, a plurality of lenses (lens units), and a sensor protecting glass. In addition, a quarter waveplate QWP is disposed on the image side of the first transmissive reflective surface HM1.

FIG. 4A is an aberration diagram of the optical system OS1 in an in-focus state (on an object) at infinity, and FIG. 4B is an aberration diagram of the optical system OS1 in an in-focus state (on an object) at a close distance. In a spherical aberration diagram, Fno represents an F-number. The spherical aberration diagram illustrates spherical aberration amounts for the d-line (wavelength 587.6 nm), g-line (wavelength 435.8 nm), C-line (wavelength 656.3 nm), and F-line (wavelength 486.1 nm). In an astigmatism diagram, S indicates an astigmatism amount on a sagittal image plane, and M indicates an astigmatism amount on a meridional image plane. A distortion diagram illustrates a distortion amount for the d-line. A chromatic aberration diagram illustrates a chromatic aberration amount for the g-line, C-line, and F-line. ω is a half angle of view (°). obj represents a focused position (distance from the image plane IM to the in-focus surface) (unit: mm). The above definitions are similarly applicable to the subsequent aberration diagrams.

During focusing, the optical system OS1 integrally moves the aperture stop SP and a lens unit including the first transmissive reflective surface HM1 in the optical axis direction. In FIG. 1, bottom arrows indicate an lens unit to be moved and a moving direction during focusing from infinity to a close distance. In FIG. 3, an arrow points toward the object side, indicating that the lens is moved toward the object side during focusing from infinity to a close distance. This is similarly applied to the subsequent optical path diagrams.

In the optical system OS1, the lens closest to the object corresponds to the first refractive lens L1.

### Example 2

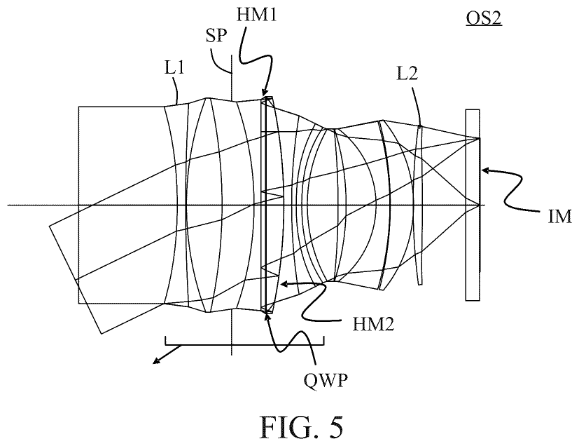

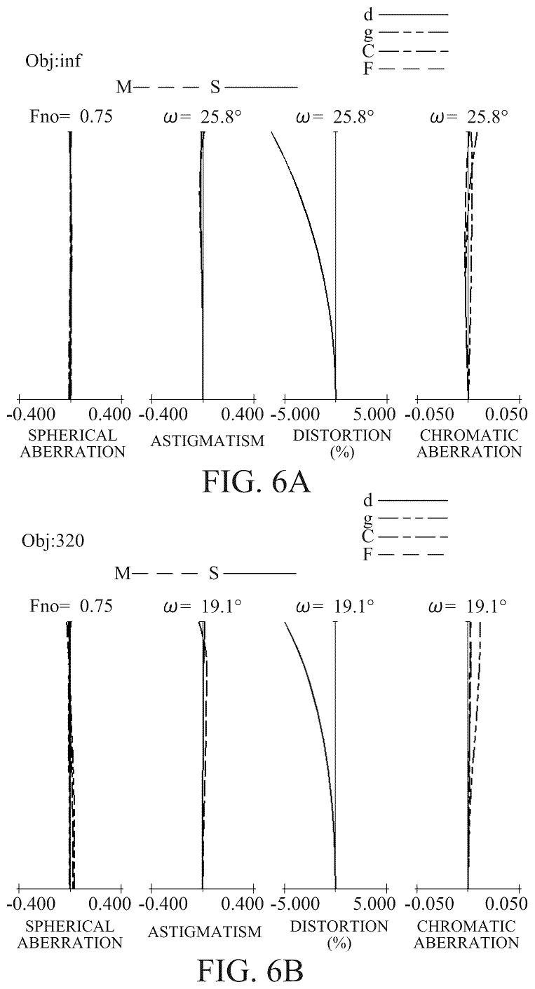

Referring now to FIGS. 5, 6A, and 6B, a description will be given of an optical system OS2 according to Example 2. FIG. 5 is a sectional view of the optical system OS2. FIG. 6A is an aberration diagram of the optical system OS2 in an in-focus state at infinity, and FIG. 6B is an aberration diagram of the optical system OS2 in an in-focus state at a close distance.

The optical system OS2 includes, in order from the object side to the image plane IM side, a plurality of lenses (lens units), and a sensor protecting glass. In addition, a quarter waveplate QWP is disposed on the image side of the first transmissive reflective surface HM1, sandwiching a sheet of flat glass. This configuration can easily improve the surface precision of the reflective surface. In this example, the quarter waveplate QWP is incorporated into the optical path diagram and numerical values as a flat plate with a thickness of 0.1 mm, but this has almost no influence on the aberration, and the presence or absence of this thickness does not affect the essence of each example, so the thickness of the quarter waveplate QWP is omitted in Example 1. Hereafter, the thickness of the quarter waveplate QWP, the transmissive reflective surface, etc. may be omitted. During focusing, the optical system OS2 integrally moves a lens unit (including the aperture stop SP) on the object side of a meniscus lens having the convex surface facing the object side in the optical axis direction.

In the optical system OS2, for example, the lens closest to the object corresponds to the first refractive lens L1, the third refractive lens, and the fourth refractive lens, and the lens closest to the image plane corresponds to the second refractive lens L2.

### Example 3

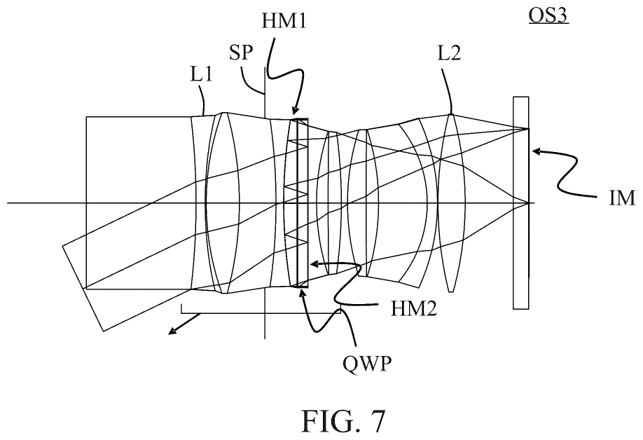

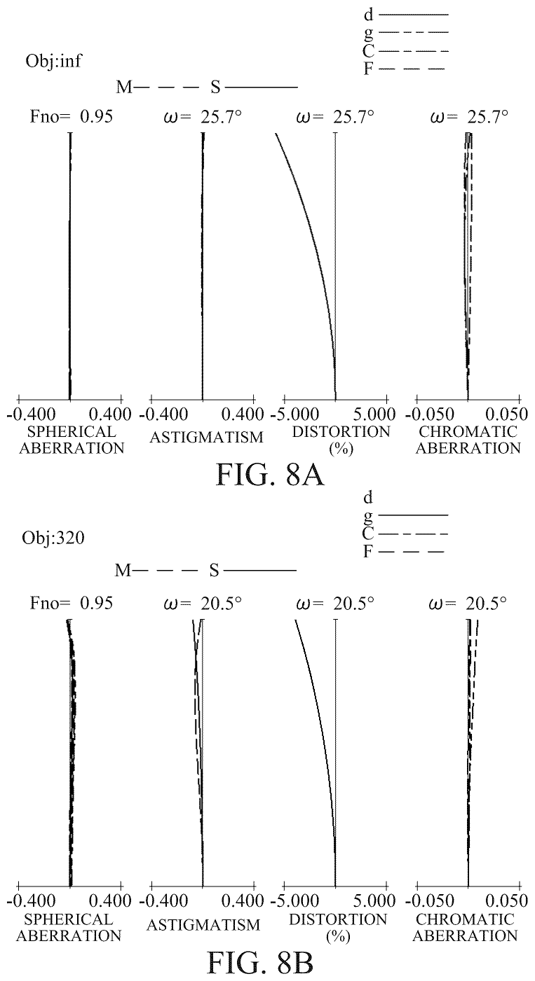

Referring now to FIGS. 7, 8A, and 8B, a description will be given of an optical system OS3 according to Example 3. FIG. 7 is a sectional view of the optical system OS3. FIG. 8A illustrates an aberration diagram of the optical system OS3 in an in-focus state at infinity, and FIG. 8B illustrates an aberration diagram of the optical system OS3 in an in-focus state at a close distance.

The optical system OS3 includes, in order from the object side to the image plane IM side, a plurality of lenses (lens units), and a sensor protecting glass. In addition, a quarter waveplate QWP is disposed on the image side of the first transmissive reflective surface HM1 via a convex lens. During focusing, the optical system OS3 integrally moves seven lens units (including the flat plate and not including the quarter waveplate QWP) from the object side and the aperture stop SP in the optical axis direction.

In the optical system OS3, for example, the lens closest to the object corresponds to the first refractive lens L1, the third refractive lens, and the fourth refractive lens, and the lens closest to the image plane corresponds to the second refractive lens L2.

### Example 4

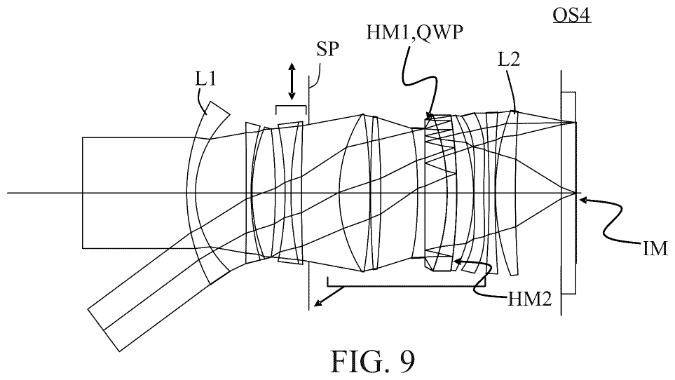

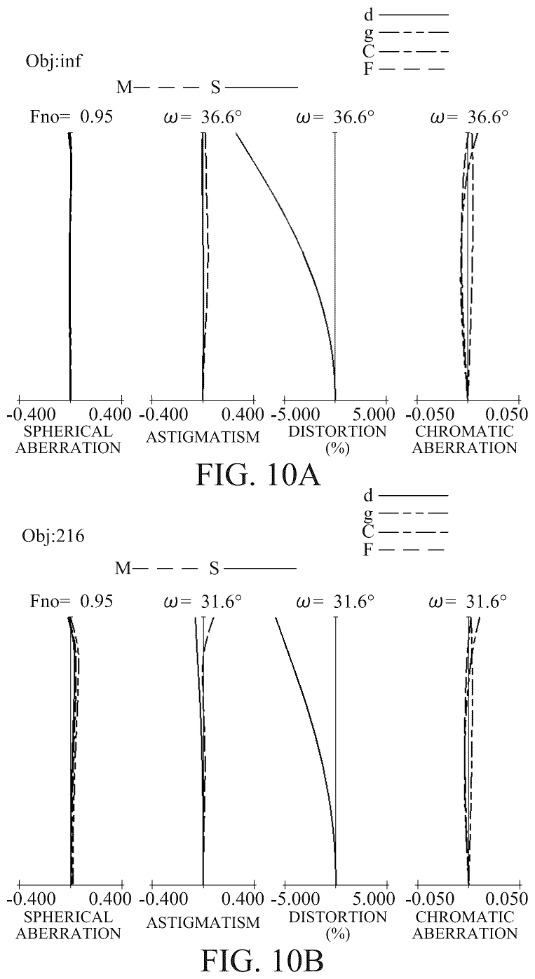

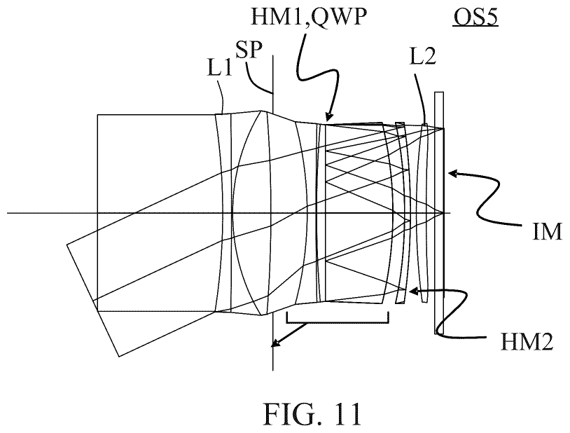

Referring now to FIGS. 9, 10A, and 10B, a description will be given of an optical system OS4 according to Example 4. FIG. 9 is a sectional view of the optical system OS4. FIG. 10A is an aberration diagram of the optical system OS4 in an in-focus state at infinity, and FIG. 10B is an aberration diagram of the optical system OS4 in an in-focus state at a close distance.

The optical system OS4 includes, in order from the object side to the image plane IM side, a plurality of lenses (lens units), and a sensor protecting glass. In addition, a quarter waveplate QWP is disposed on the image side of the first transmissive reflective surface HM1. During focusing, the optical system OS4 integrally moves seven lens units disposed just after (e.g., next to) and on the image side of the aperture stop SP in the optical axis direction. In addition, image stabilization can be performed by moving the fourth and fifth cemented lenses (image stabilizing unit) counted from the object side in a direction perpendicular to the optical axis.

In the optical system OS4, for example, the lens closest to the object corresponds to the first refractive lens L1, the lens just after the aperture stop SP corresponds to the third and fourth refractive lenses, and the lens closest to the image plane corresponds to the second refractive lens L2.

### Example 5

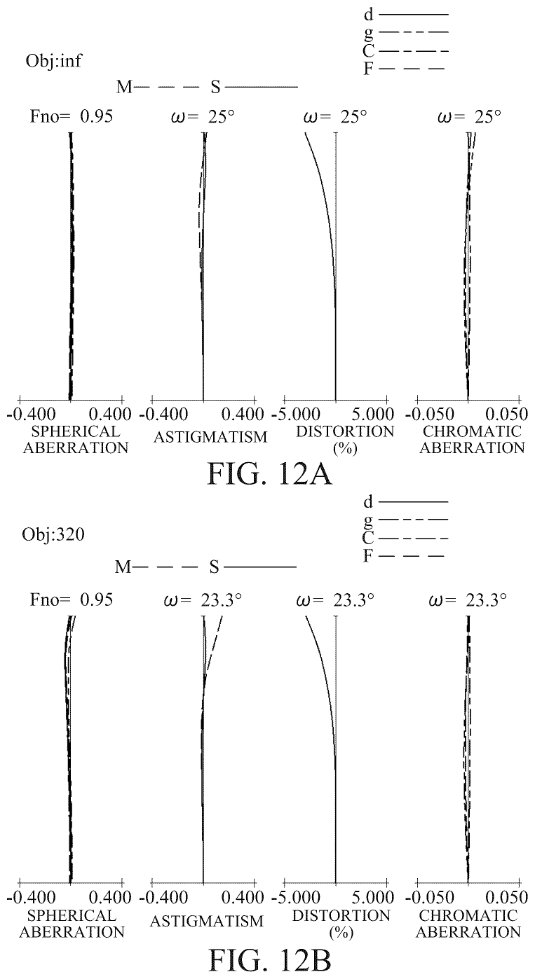

Referring now to FIGS. 11, 12A, and 12B, a description will be given of an optical system OS5 according to Example 5. FIG. 11 is a sectional view of the optical system OS5. FIG. 12A is an aberration diagram of the optical system OS5 in an in-focus state at infinity, and FIG. 12B is an aberration diagram of the optical system OS5 in an in-focus state at a close distance.

The optical system OS5 includes, in order from the object side to the image plane IM side, a plurality of lenses (lens units), and a sensor protecting glass. In addition, a quarter waveplate QWP is disposed on the image side of the first transmissive reflective surface HM1. During focusing, the optical system OS5 integrally moves three lens units disposed just after (e.g., next to) and on the image side of the aperture stop SP in the optical axis direction.

In the optical system OS5, for example, the lens closest to the object corresponds to the first refractive lens L1, the lens just after the aperture stop SP correspond to the third and fourth refractive lenses, and the lens closest to the image plane corresponds to the second refractive lens L2.

### Example 6

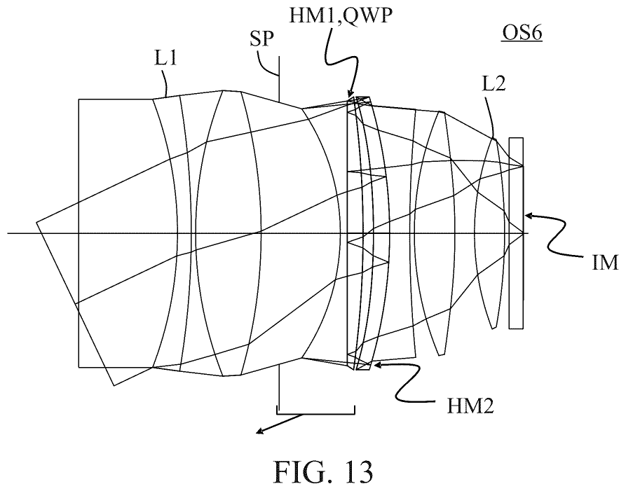

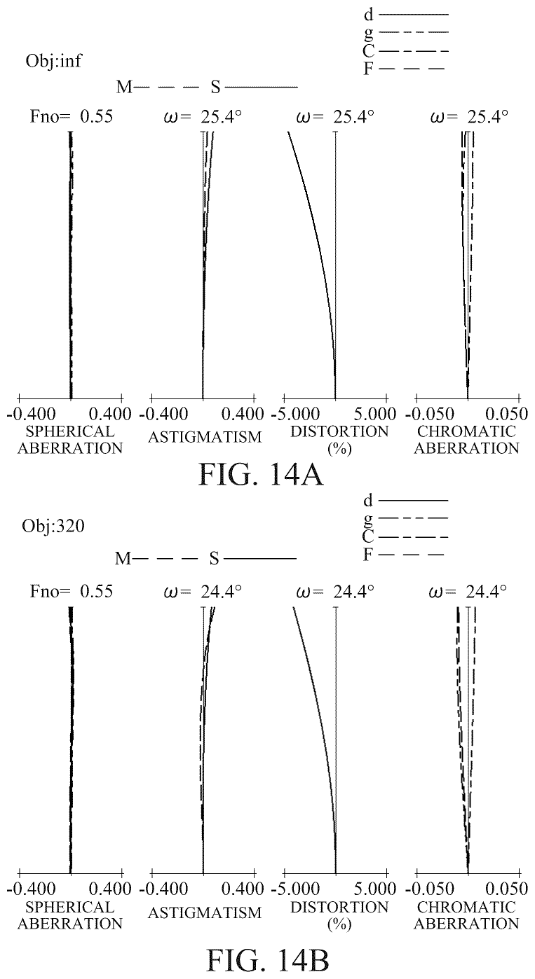

Referring now to FIGS. 13, 14A, and 14B, a description will be given of an optical system OS6 according to Example 6. FIG. 13 is a sectional view of the optical system OS6. FIG. 14A is an aberration diagram of the optical system OS6 in an in-focus state at infinity, and FIG. 14B is an aberration diagram of the optical system OS6 in an in-focus state at a close distance.

The optical system OS6 includes, in order from the object side to the image plane IM side, a plurality of lenses (lens units), and a sensor protecting glass. A quarter waveplate QWP is disposed on the image side of the first transmissive reflective surface HM1. During focusing, the optical system OS6 integrally moves the aperture stop SP and two lenses disposed just after (next to) and on the image side of the aperture stop SP in the optical axis direction.

In the optical system OS6, for example, the lens closest to the object corresponds to the first refractive lens L1, and the lens closest to the image plane corresponds to the second refractive lens L2.

### Example 7

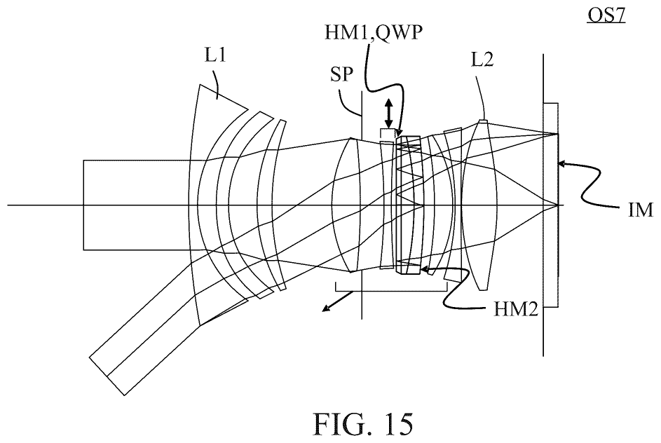

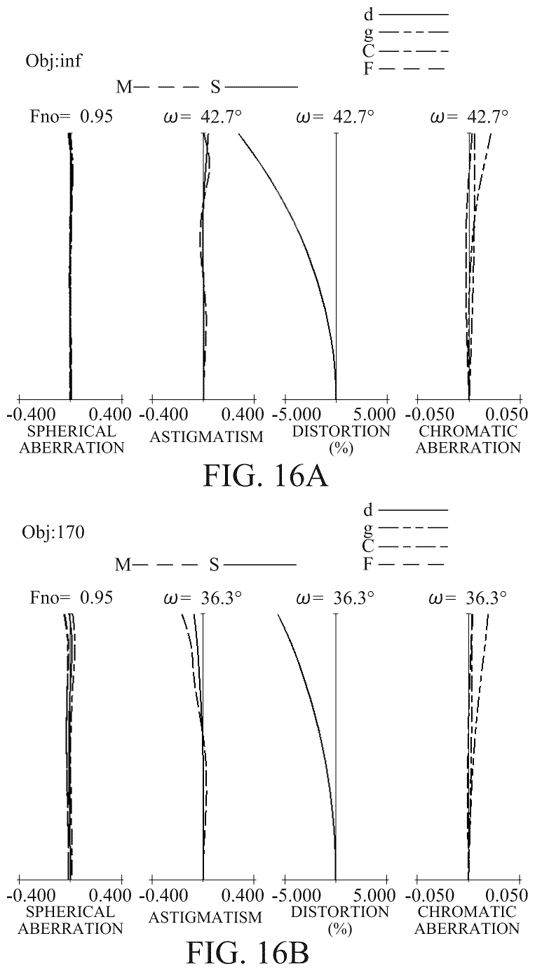

Referring now to FIGS. 15, 16A, and 16B, a description will be given of an optical system OS7 according to Example 7. FIG. 15 is a sectional view of the optical system OS7. FIG. 16A is an aberration diagram of the optical system OS7 in an in-focus state at infinity, and FIG. 16B is an aberration diagram of the optical system OS7 in an in-focus state at a close distance.

The optical system OS7 includes, in order from the object side to the image plane IM side, a plurality of lenses (lens units), and a sensor protecting glass. In addition, a quarter waveplate QWP is disposed on the image side of the first transmissive reflective surface HM1. During focusing, the optical system OS7 integrally moves the aperture stop SP, a lens disposed just after (e.g., next to) and on the object side of the aperture stop SP, and five lenses (including a flat plate) disposed next to and on the image side of the aperture stop SP in the optical axis direction. Image stabilization can be performed by moving a lens (image stabilizing unit) disposed just after (e.g., next to) and on the image side of the aperture stop SP in a direction orthogonal to the optical axis.

In the optical system OS7, for example, the lens closest to the object corresponds to the first refractive lens L1, the lens disposed just after (e.g., next to) and on the object side of the aperture stop SP corresponds to the third and fourth refractive lenses, and the lens closest to the image plane corresponds to the second refractive lens L2.

### Example 8

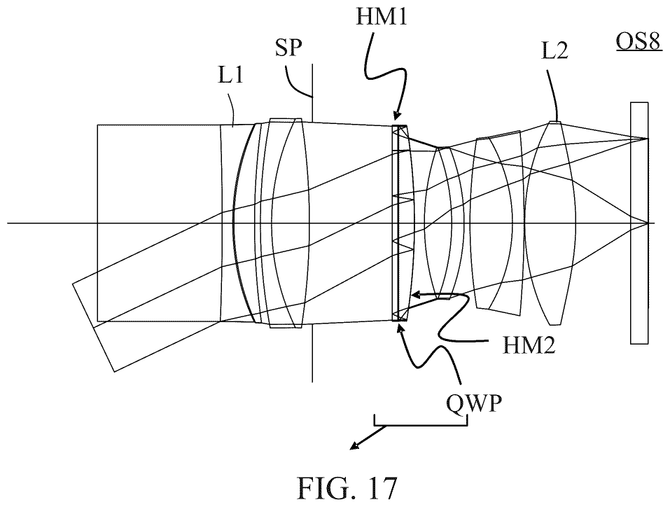

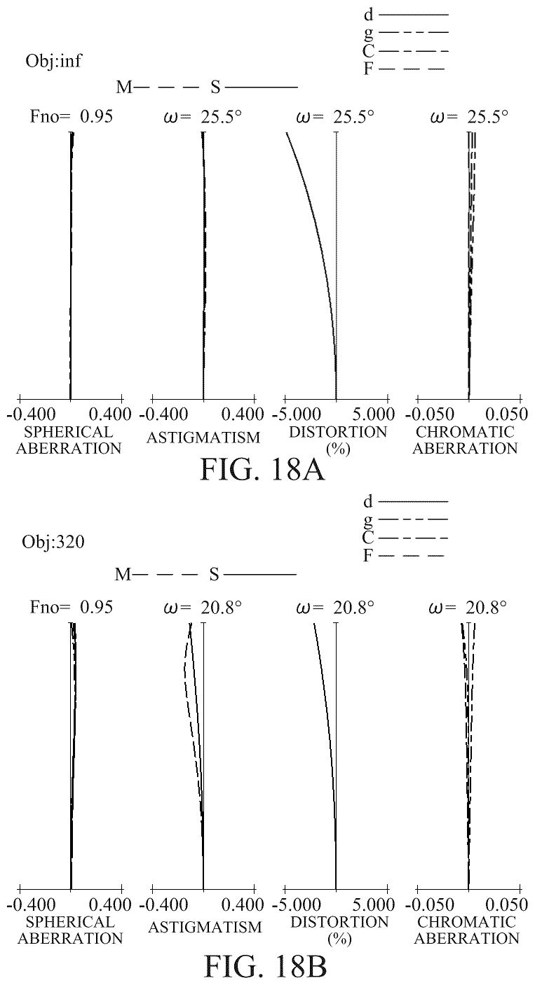

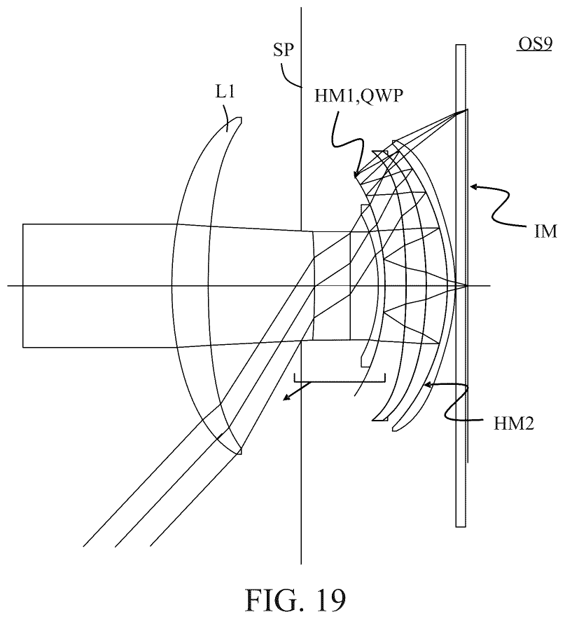

Referring now to FIGS. 17, 18A, and 18B, a description will be given of an optical system OS8 according to Example 8. FIG. 18A illustrates an aberration diagram of the optical system OS8 in the in-focus state at infinity, and FIG. 18B illustrates an aberration diagram of the optical system OS8 in an in-focus state at a close distance.

The optical system OS8 includes, in order from the object side to the image plane IM side, a plurality of lenses (lens units), and a sensor protecting glass. During focusing, the optical system OS8 integrally moves four lenses (including a flat plate and not including a quarter waveplate) disposed just after (e.g., next to) and on the image side of the aperture stop SP in the optical axis direction. In addition, image stabilization can be performed by moving a cemented lens (image stabilizing unit) disposed just before (e.g., next to) and on the object side of the aperture stop SP in a direction orthogonal to the optical axis.

In the optical system OS8, for example, the lens closest to the object corresponds to the first refractive lens L1, the lens disposed just after (e.g., next to) the second transmissive reflective surface HM2 corresponds to the fourth refractive lens, and the lens closest to the image plane corresponds to the second refractive lens L2.

### Example 9

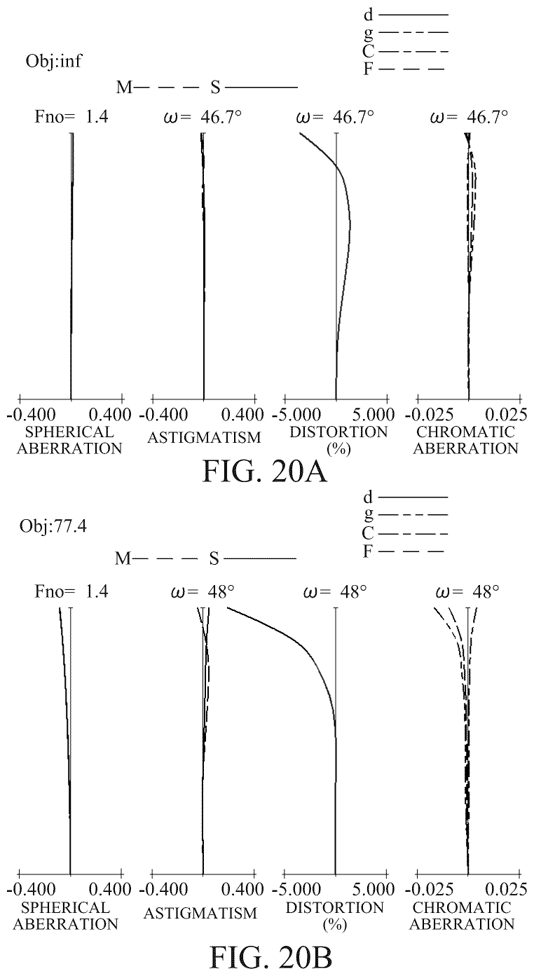

Referring now to FIGS. 19, 20A, and 20B, a description will be given of an optical system OS9 according to Example 9. FIG. 19 is a sectional view of the optical system OS9. FIG. 20A is an aberration diagram of the optical system OS9 in an in-focus state at infinity, and FIG. 20B is an aberration diagram of the optical system OS9 in an in-focus state at a close distance.

The optical system OS9 includes, in order from the object side to the image plane IM side, a plurality of lenses (lens units), and a sensor protecting glass. During focusing, the optical system OS9 integrally moves the aperture stop SP and two lenses disposed just after (e.g., next to) and on the image side of the aperture stop SP in the optical axis direction.

In optical system OS9, for example, the lens closest to the object corresponds to first refractive lens L1, and the lens just after the aperture stop SP corresponds to the third and fourth refractive lenses.

### Example 10

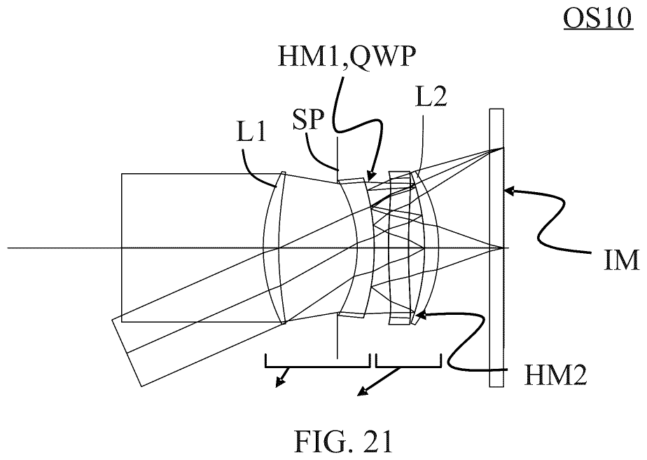

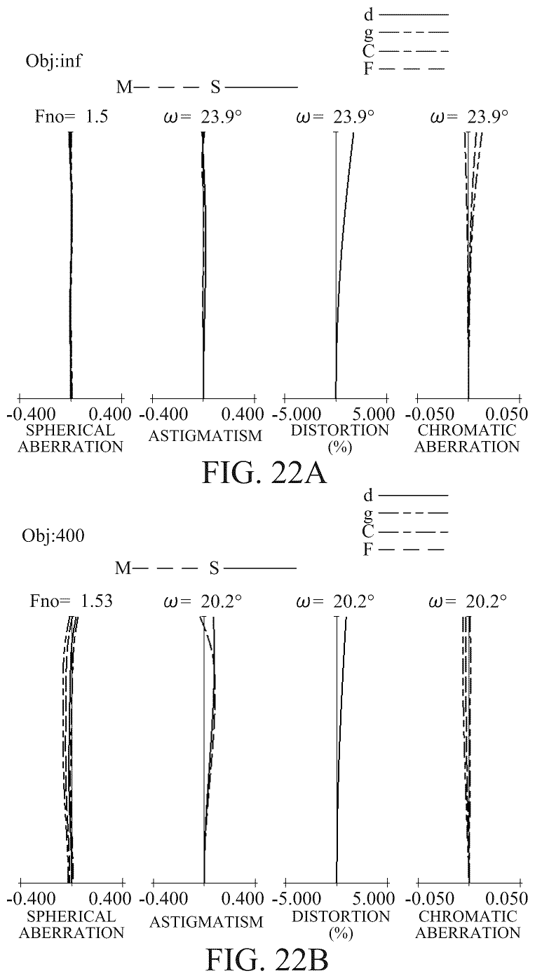

Referring now to FIGS. 21, 22A, and 22B, a description will be given of an optical system OS10 according to Example 10. FIG. 21 is a sectional view of the optical system OS10. FIG. 22A is an aberration diagram of the optical system OS10 in an in-focus state at infinity, and FIG. 22B is an aberration diagram of the optical system OS10 in an in-focus state at a close distance.

The optical system OS10 includes, in order from the object side to the image plane IM side, a plurality of lenses (lens units), and a sensor protecting glass. During focusing, the optical system OS10 integrally moves the aperture stop SP, and lenses disposed just after (e.g., next to and on the image side of) and just before (e.g., next to and on the object side of) the aperture stop SP in the optical axis direction, and also moves two lenses on the image side of it as an integrated floating unit in the optical axis direction by a different moving amount.

In the optical system OS10, for example, the lens closest to the object corresponds to the first refractive lens L1, the third refractive lens, and the fourth refractive lens, and the lens closest to the image plane corresponds to the second refractive lens L2.

### Example 11

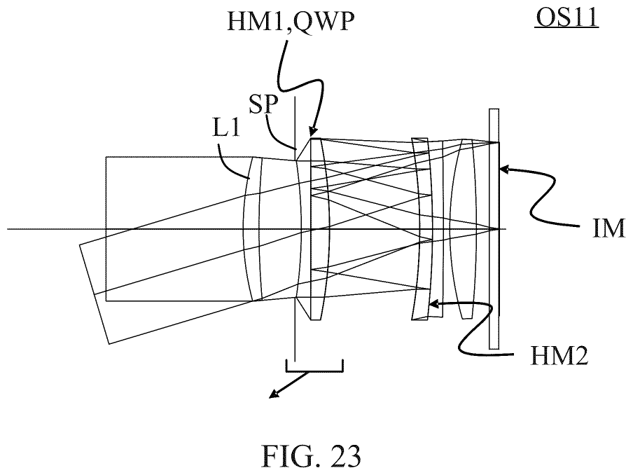

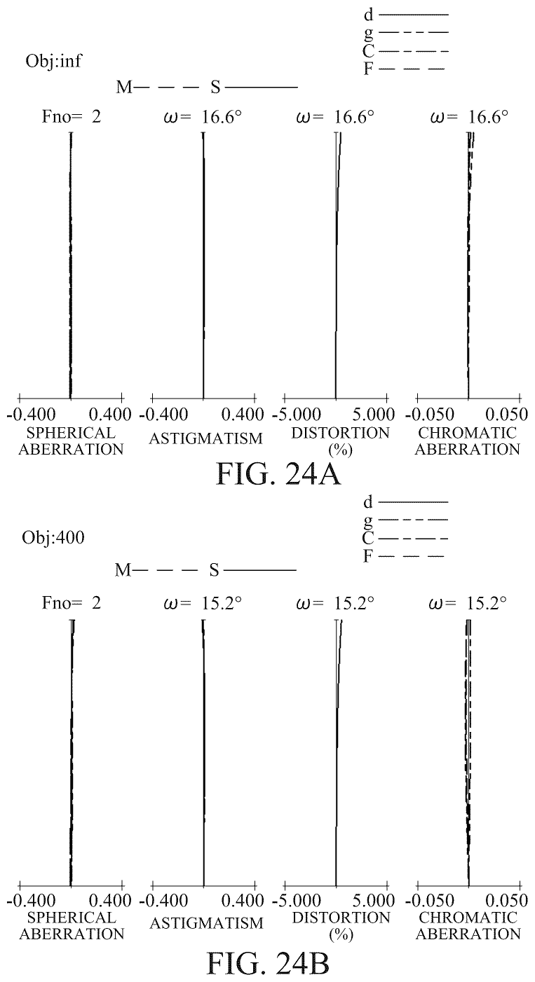

Referring now to FIGS. 23, 24A, and 24B, a description will be given of an optical system OS11 according to Example 11. FIG. 23 is a sectional view of the optical system OS11. FIG. 24A illustrates an aberration diagram of the optical system OS11 in an in-focus state at infinity, and FIG. 24B illustrates an aberration diagram of the optical system OS11 in an in-focus state at a close distance.

The optical system OS11 includes, in order from the object side to the image plane IM side, a plurality of lenses (lens units), and a sensor protecting glass. During focusing, the optical system OS11 integrally moves the aperture stop SP and two lenses disposed just after (e.g., next to) and on the image side of the aperture stop SP in the optical axis direction.

In the optical system OS11, for example, the lens closest to the object corresponds to the first refractive lens L1, and the lens just after the aperture stop SP corresponds to the fourth refractive lens.

### Example 12

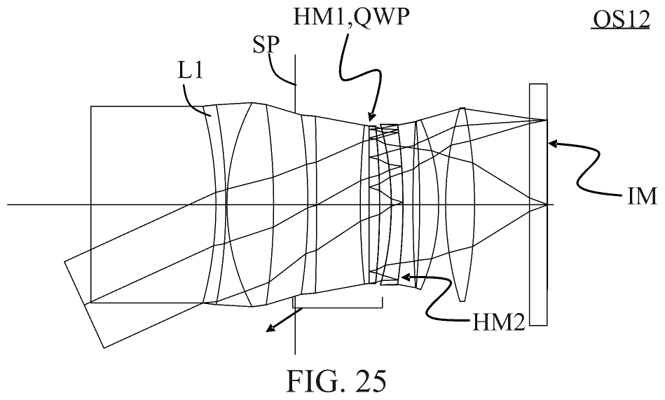

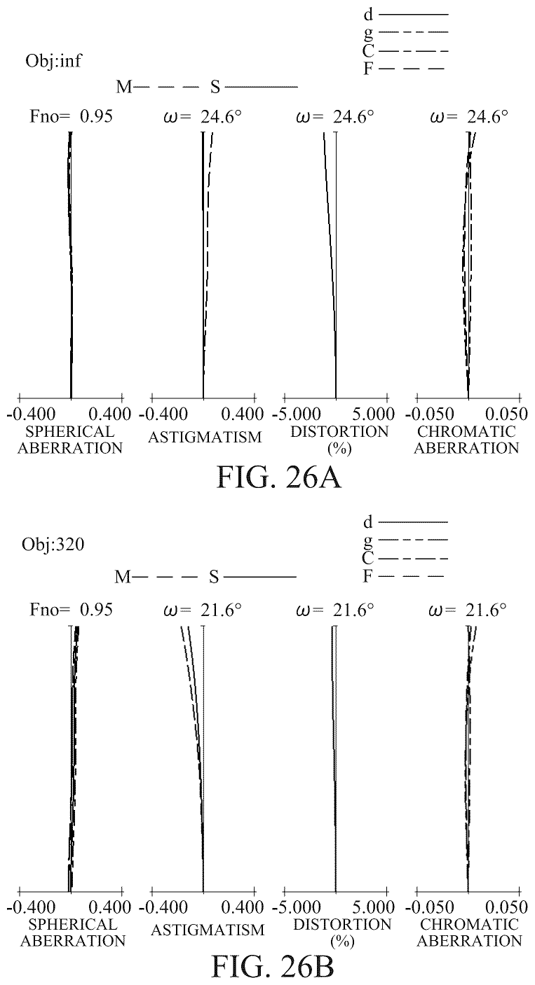

Referring now to FIGS. 25, 26A, and 26B, a description will be given of an optical system OS12 according to Example 12. FIG. 25 is a sectional view of the optical system OS12. FIG. 26 Ais an aberration diagram of the optical system OS12 in an in-focus state at infinity, and FIG. 26B is an aberration diagram of the optical system OS12 in an in-focus state at a close distance.

The optical system OS12 includes, in order from the object side to the image plane IM side, a plurality of lenses (lens units), and a sensor protecting glass. During focusing, the optical system OS12 integrally moves the aperture stop SP and three lenses just after and on the image side of the aperture stop SP in the optical axis direction.

In the optical system OS12, for example, the lens closest to the object corresponds to the first refractive lens L1, and the lens just after the aperture stop SP corresponds to the third and fourth refractive lenses.

### Example 13

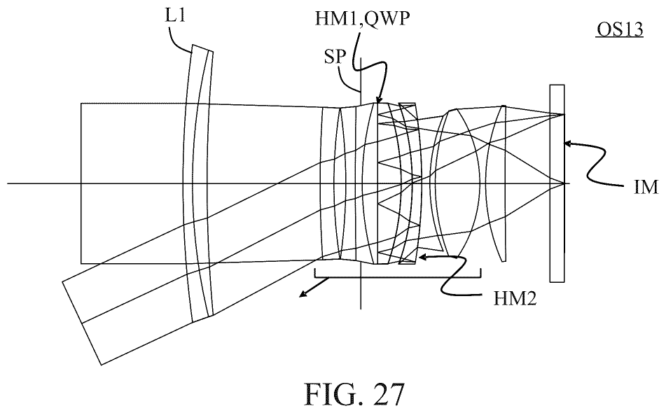

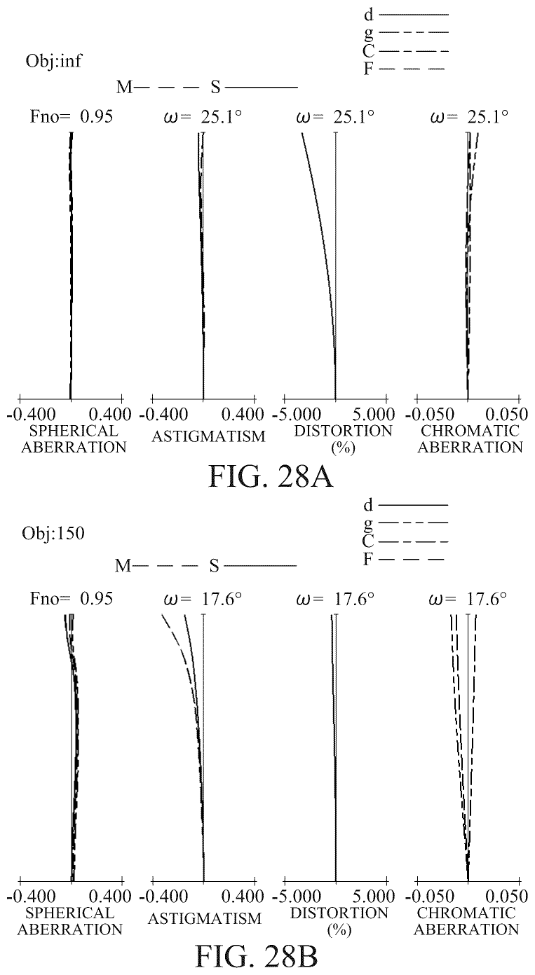

Referring now to FIGS. 27, 28A, and 28B, a description will be given of an optical system OS13 according to Example 13. FIG. 27 is a sectional view of the optical system OS13. FIG. 28 Ais an aberration diagram of the optical system OS13 in an in-focus state at infinity, and FIG. 28B is an aberration diagram of the optical system OS13 in an in-focus state at a close distance.

The optical system OS13 includes, in order from the object side to the image plane IM side, a plurality of lenses (lens units), and a sensor protecting glass. During focusing, the optical system OS13 does not move a total of three lenses, i.e., two lenses closest to the object and one lens closest to the image plane, but integrally moves the remaining lens units and the aperture stop SP in the optical axis direction.

In the optical system OS13, for example, the lens closest to the object corresponds to the first refractive lens L1, and the lens just before the aperture stop SP corresponds to the third and fourth refractive lenses.

### Example 14

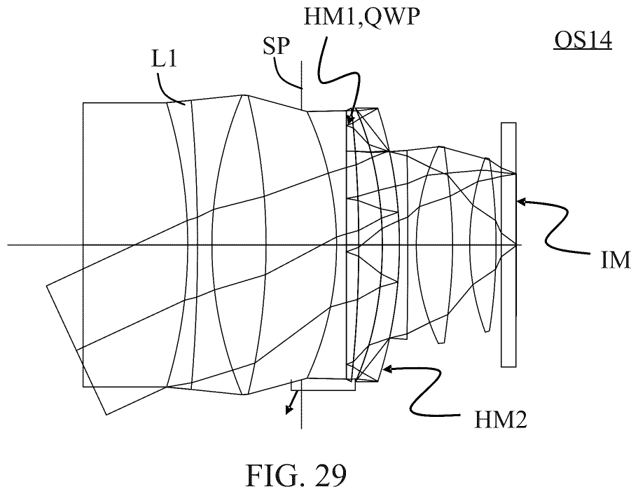

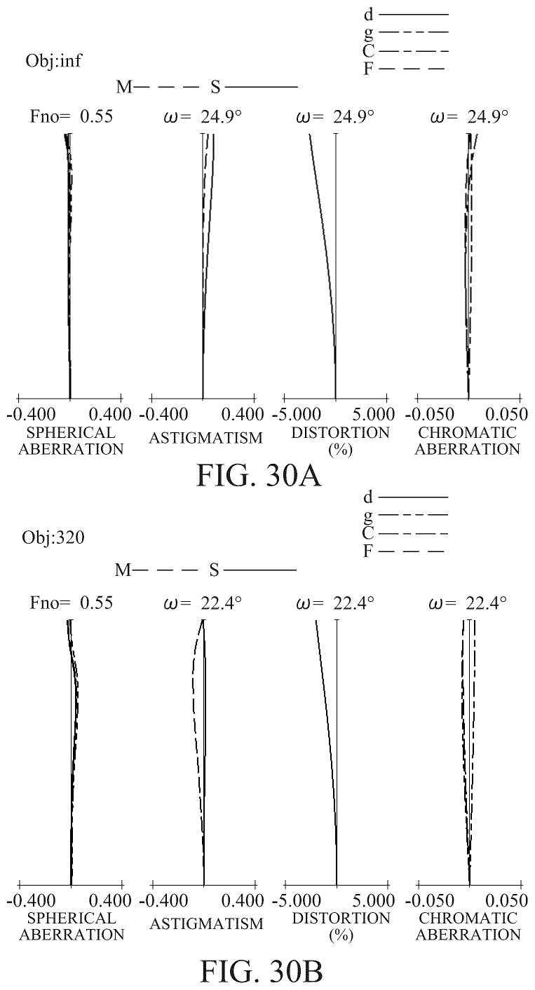

Referring now to FIGS. 29, 30A, and 30B, a description will be given of an optical system OS14 according to Example 14. FIG. 29 is a sectional view of the optical system OS14. FIG. 30 Ais an aberration diagram of the optical system OS14 in an in-focus state at infinity, and FIG. 30B is an aberration diagram of the optical system OS14 in an in-focus state at a close distance.

The optical system OS14 includes, in order from the object side to the image plane IM side, a plurality of lenses (lens units), and a sensor protecting glass. During focusing, the optical system OS14 integrally moves the aperture stop SP, and two lenses disposed just after and on the image side of the aperture stop SP in the optical axis direction.

In the optical system OS14, for example, the lens closest to the object corresponds to the first refractive lens L1, and the lens just after the aperture stop SP corresponds to the fourth refractive lens.

### Example 15

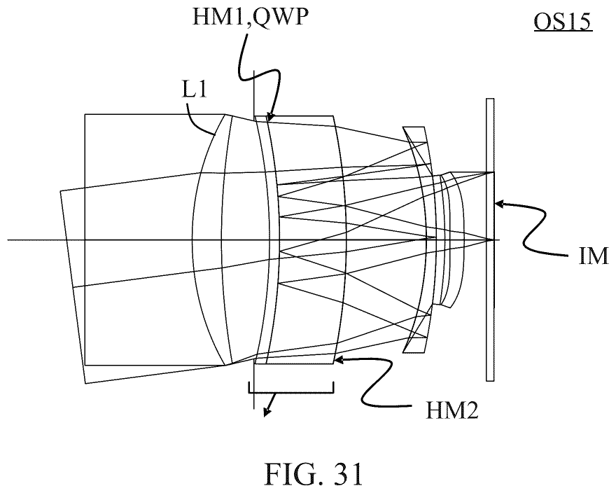

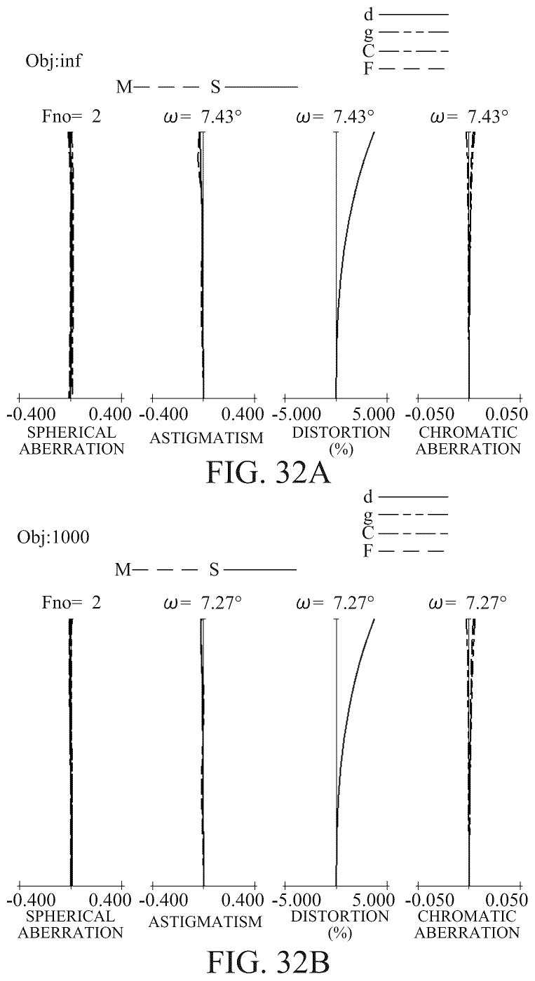

Referring now to FIGS. 31, 32A, and 32B, a description will be given of an optical system OS15 according to Example 15. FIG. 31 is a sectional view of the optical system OS15. FIG. 32 Ais an aberration diagram of the optical system OS15 in an in-focus state at infinity, and FIG. 32B is an aberration diagram of the optical system OS15 in an in-focus state at a close distance.

The optical system OS15 includes, in order from the object side to the image plane IM side, a plurality of lenses (lens units), and a sensor protecting glass. During focusing, the optical system OS15 integrally moves the aperture stop SP, and two lenses disposed just after and on the image side of the aperture stop SP in the optical axis direction.

In the optical system OS15, for example, the lens closest to the object corresponds to the first refractive lens L1, and the lens just after the aperture stop SP corresponds to the fourth refractive lens.

### Example 16

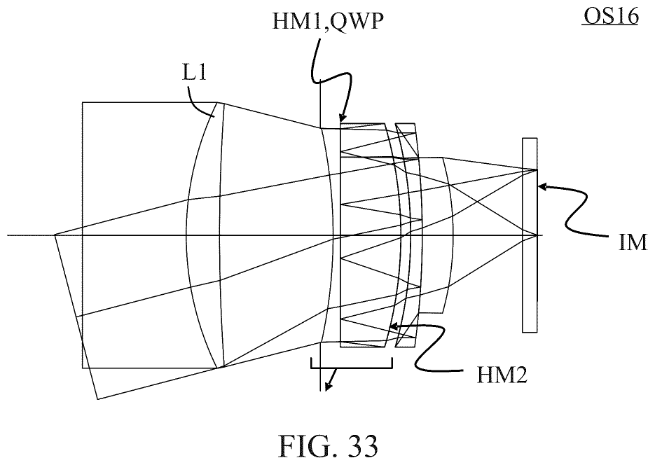

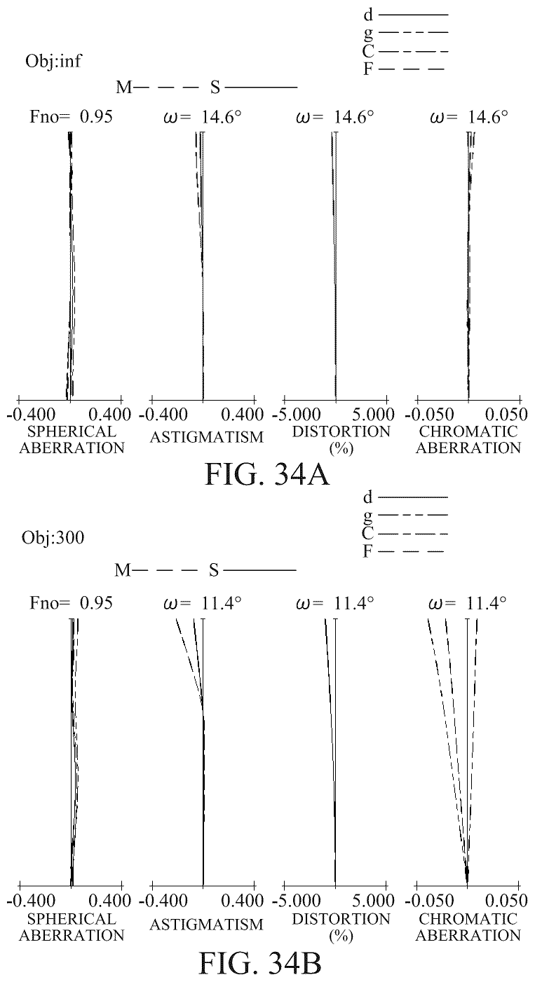

Referring now to FIGS. 33, 34A, and 34B, a description will be given of an optical system OS16 according to Example 16. FIG. 33 is a sectional view of the optical system OS16. FIG. 34A is an aberration diagram of the optical system OS16 in an in-focus state at infinity, and FIG. 34B is an aberration diagram of the optical system OS16 in an in-focus state at a close distance.

The optical system OS16 includes, in order from the object side to the image plane IM side, a plurality of lenses (lens units), and a sensor protecting glass. During focusing, the optical system OS16 integrally moves the aperture stop SP, and three lenses disposed just after and on the image side of the aperture stop SP in the optical axis direction.

In the optical system OS16, for example, the lens closest to the object corresponds to the first refractive lens, and the lens just after the aperture stop SP corresponds to the fourth refractive lens.

### Example 17

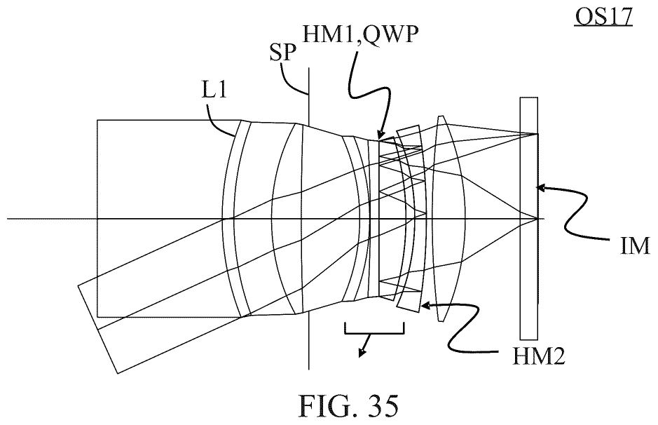

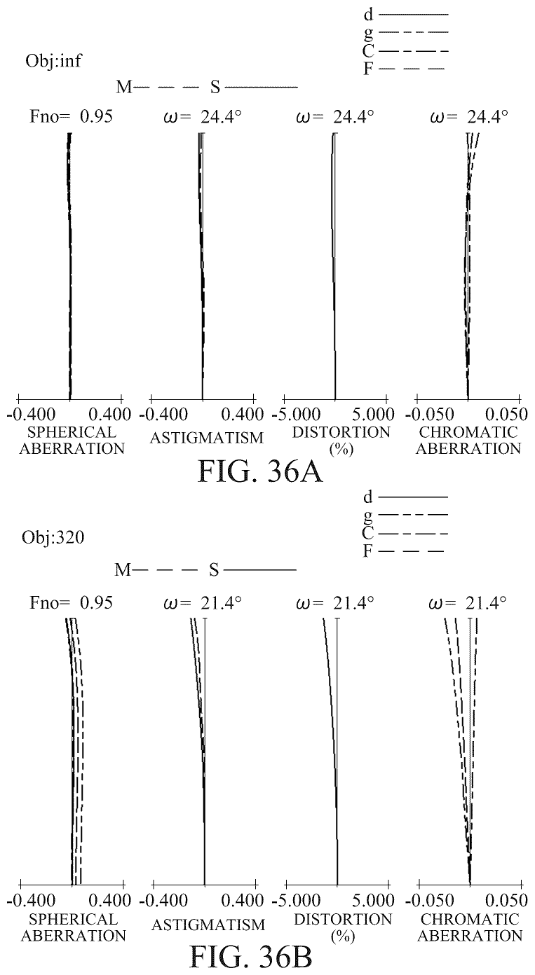

Referring now to FIGS. 35, 36A, and 36B, a description will be given of an optical system OS17 according to Example 17. FIG. 35 is a sectional view of the optical system OS17. FIG. 36 Ais an aberration diagram of the optical system OS17 in an in-focus state at infinity, and FIG. 36B is an aberration diagram of the optical system OS17 in an in-focus state at a close distance.

The optical system OS17 includes, in order from the object side to the image plane IM side, a plurality of lenses (lens units), and a sensor protecting glass. During focusing, the optical system OS17 integrally moves three lenses disposed just after and on the image side the aperture stop SP in the optical axis direction.

In the optical system OS17, the power of the optical system acting on single-path light that reaches the image plane as it is without being reflected by either the first transmissive reflective surface HM1 or the second transmissive reflective surface HM2 is intensified. The single-path light may not reach the image plane, and may be absorbed by a polarizer. However, since the characteristic of the polarizer is not ideal, it is inevitable that the single-path light reaches the image plane to some extent. This configuration can prevent ghosts caused by the single-path light from spreading across the entire image.

In the optical system OS17, for example, the lens closest to the object corresponds to the first refractive lens L1, and the lens just after the aperture stop SP corresponds to the third and fourth refractive lenses.

### Example 18

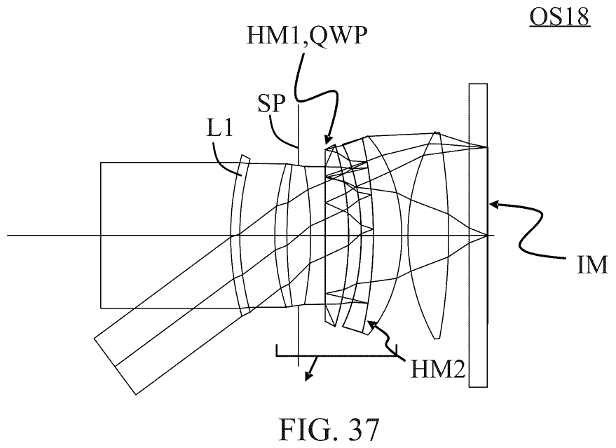

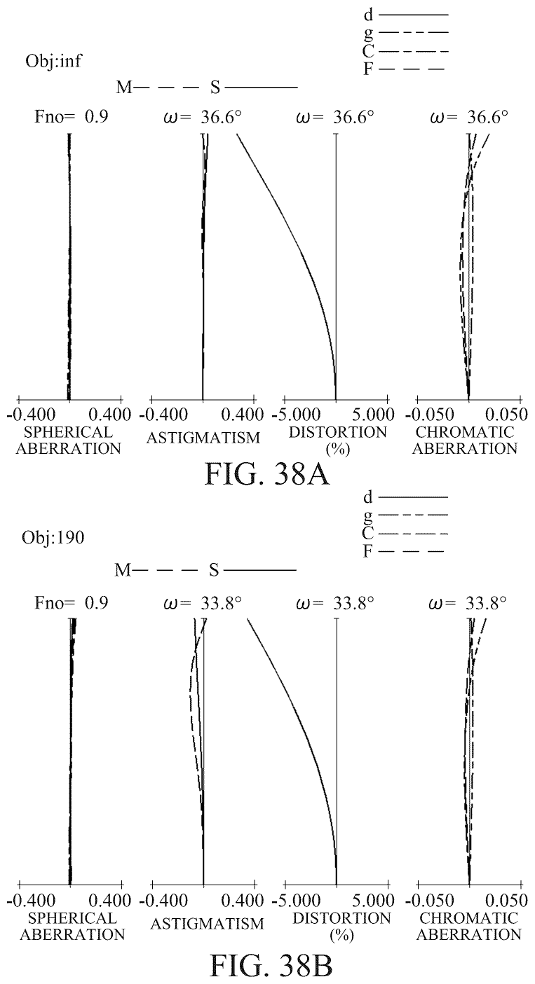

Referring now to FIGS. 37, 38A, and 38B, a description will be given of an optical system OS18 according to Example 18. FIG. 37 is a sectional view of the optical system OS18. FIG. 38 Ais an aberration diagram of the optical system OS18 in an in-focus state at infinity, and FIG. 38B is an aberration diagram of the optical system OS18 in an in-focus state at a close distance.

The optical system OS18 includes, in order from the object side to the image plane IM side, a plurality of lenses (lens units), and a sensor protecting glass. During focusing, the optical system OS18 does not move a total of two lenses, i.e., the lens closest to the object and the lens closest to the image plane, but integrally moves the remaining lens unit and the aperture stop SP in the optical axis direction.

In the optical system OS18, for example, the lens closest to the object corresponds to the first refractive lens L1, and the lens disposed just before the aperture stop SP corresponds to the third and fourth refractive lenses.

### Example 19

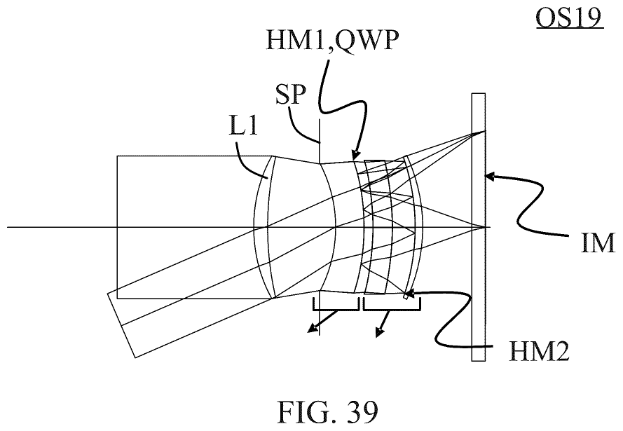

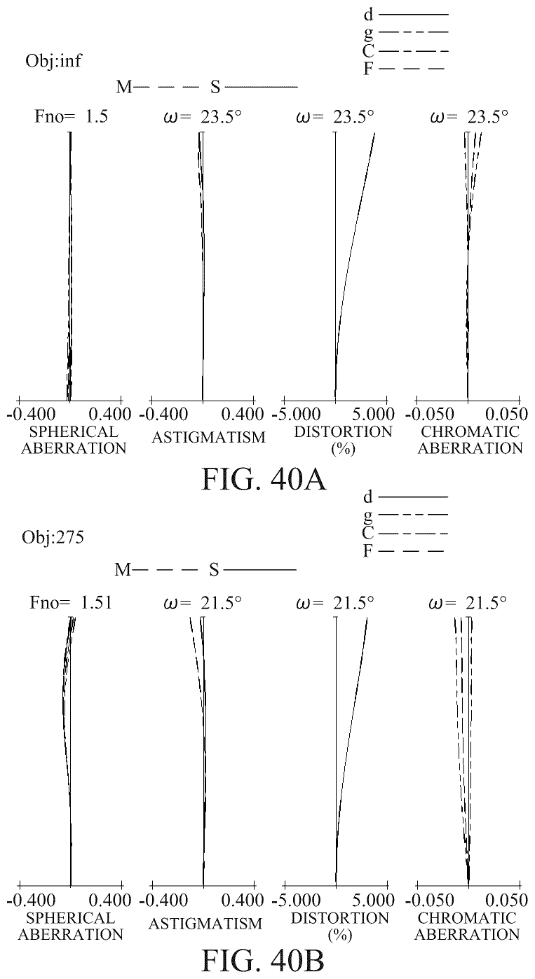

Referring now to FIGS. 39, 40A, and 40B, a description will be given of an optical system OS19 according to Example 19. FIG. 39 is a sectional view of the optical system OS19. FIG. 40 Ais an aberration diagram of the optical system OS19 in an in-focus state at infinity, and FIG. 40B is an aberration diagram of the optical system OS19 in an in-focus state at a close distance.

The optical system OS19 includes, in order from the object side to the image plane IM side, a plurality of lenses (lens units), and a sensor protecting glass. During focusing, optical system OS19 integrally moves the aperture stop SP, and a lens disposed just after and on the image side of the aperture stop SP in the optical axis direction, and also moves two lenses closest to the image plane by a different moving amount in the optical axis direction as an integrated floating unit.

In optical system OS19, for example, the lens closest to the object corresponds to the first refractive lens L1, and the lens just after the aperture stop SP corresponds to the fourth refractive lens.

### Example 20

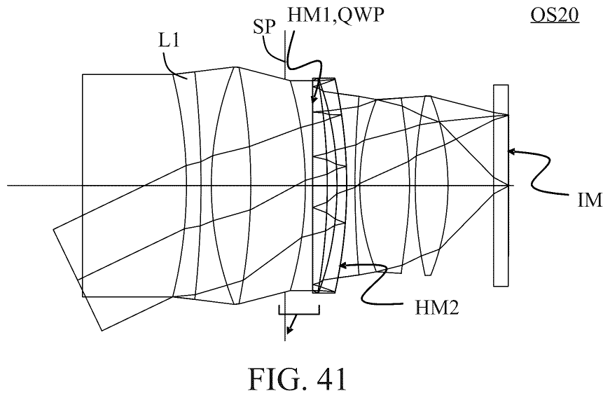

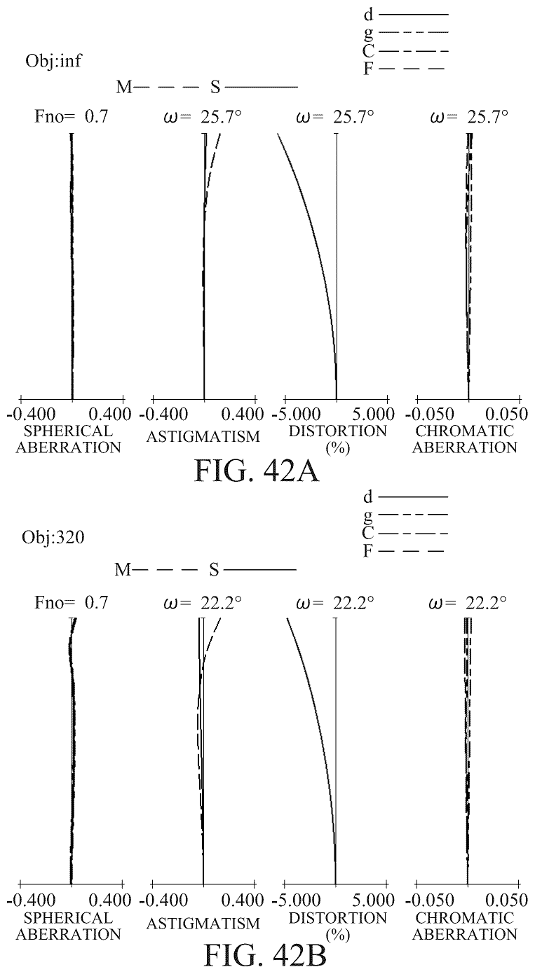

Referring now to FIGS. 41, 42A, and 42B, a description will be given of an optical system OS20 according to Example 20. FIG. 41 is a sectional view of the optical system OS20. FIG. 42A is an aberration diagram of the optical system OS20 in an in-focus state at infinity, and FIG. 42B is an aberration diagram of the optical system OS20 in an in-focus state at a close distance.

The optical system OS20 includes, in order from the object side to the image plane IM side, a plurality of lenses (lens units), and a sensor protecting glass. During focusing, the optical system OS20 integrally moves the aperture stop SP, and two lenses disposed just after and on the image side of the aperture stop SP in the optical axis direction.

In the optical system OS20, for example, the lens closest to the object corresponds to the first refractive lens L1, and the lens disposed just after the aperture stop SP corresponds to the fourth refractive lens.

### Example 21

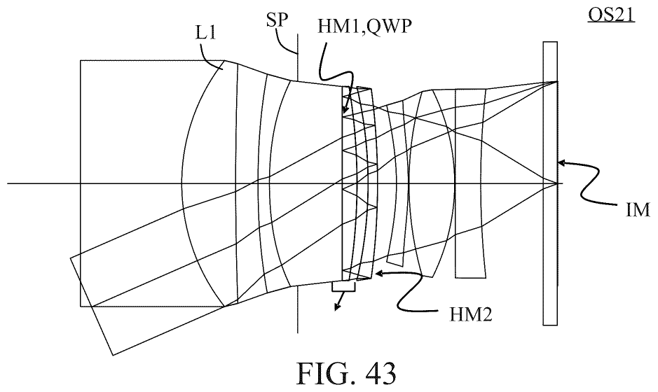

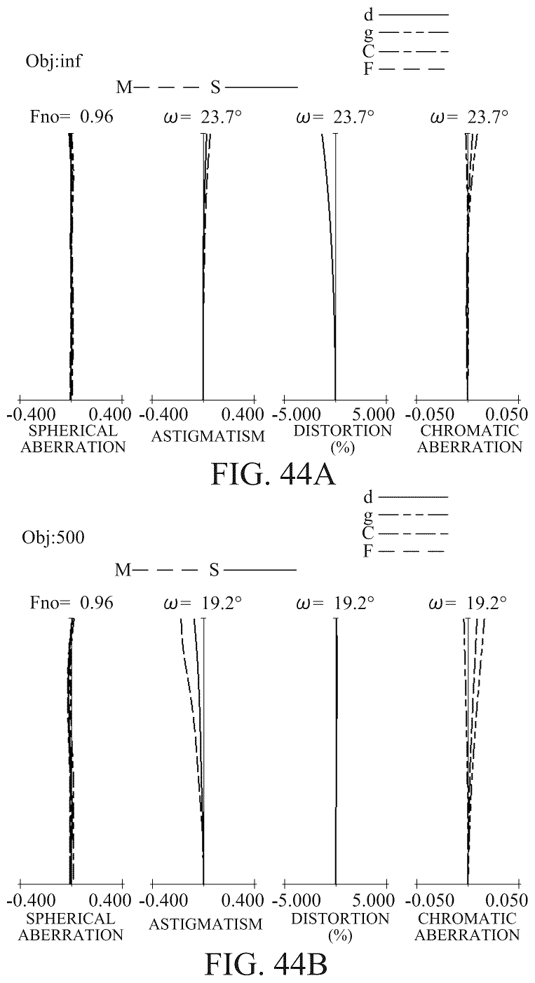

Referring now to FIGS. 43, 44A, and 44B, a description will be given of an optical system OS21 according to Example 21. FIG. 43 is a sectional view of the optical system OS21. FIG. 44 Ais an aberration diagram of the optical system OS21 in an in-focus state at infinity, and FIG. 44B is an aberration diagram of the optical system OS21 in an in-focus state at a close distance.

The optical system OS21 includes, in order from the object side to the image plane IM side, a plurality of lenses (lens units), and a sensor protecting glass. During focusing, the optical system OS21 moves one lens disposed just after and on the image side of the aperture stop SP in the optical axis direction.

In the optical system OS21, for example, the lens closest to the object corresponds to the first refractive lens L1.

### Example 22

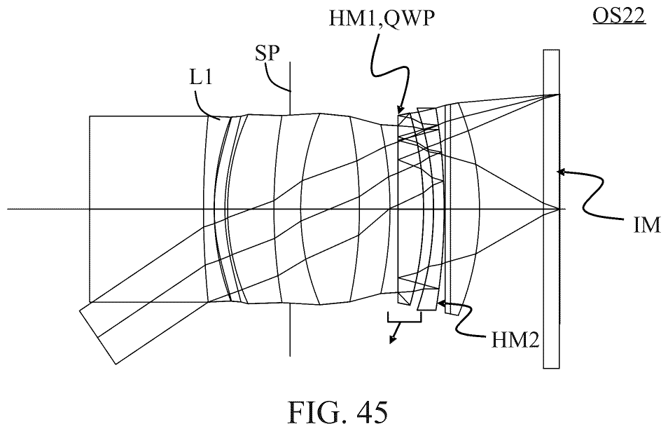

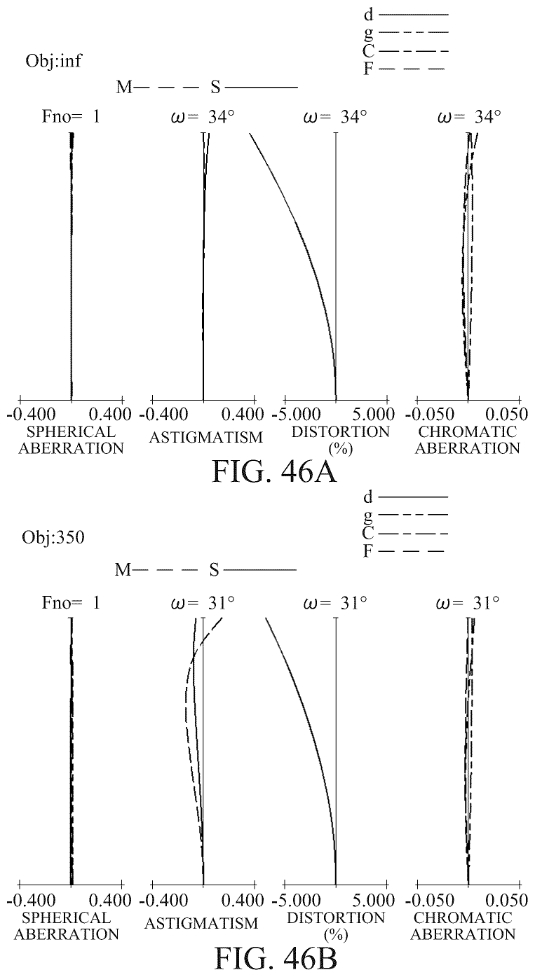

Referring now to FIGS. 45, 46A, and 46B, a description will now be given of an optical system OS22 according to Example 22. FIG. 45 is a sectional view of the optical system OS22. FIG. 46A illustrates an aberration diagram of the optical system OS22 in an in-focus state at infinity, and FIG. 46B illustrates an aberration diagram of the optical system OS22 in an in-focus state at a close distance.

The optical system OS22 includes, in order from the object side to the image plane IM side, a plurality of lenses (lens units), and a sensor protecting glass. During focusing, the optical system OS22 moves two cemented lenses, the fifth and sixth lenses from the object side, in the optical axis direction.

In the optical system OS22, for example, the lens closest to the object corresponds to the first refractive lens L1, and the lens just after the aperture stop SP corresponds to the fourth refractive lens.

### Example 23

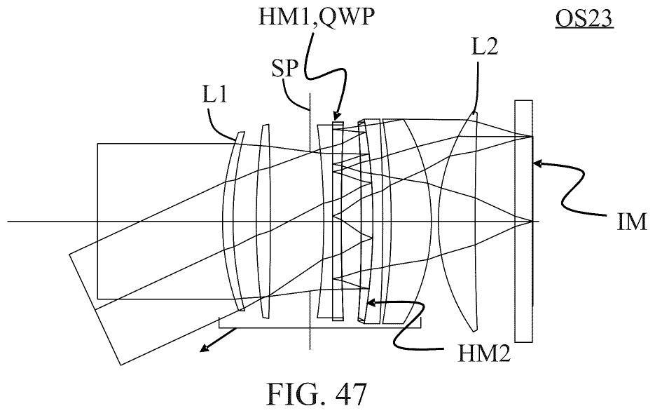

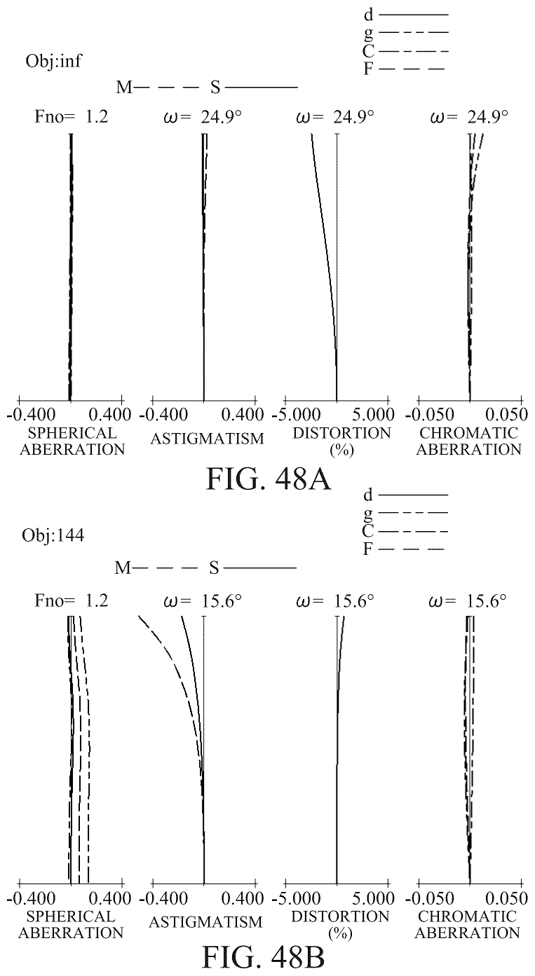

Referring now to FIGS. 47, 48A, and 48B, a description will be given of an optical system OS23 according to Example 23. FIG. 47 illustrates a sectional view of the optical system OS23. FIG. 48A illustrates an aberration diagram of the optical system OS23 in an in-focus state at infinity, and FIG. 48B illustrates an aberration diagram of the optical system OS23 in an in-focus state at a close distance.

The optical system OS23 includes, in order from the object side to the image plane IM side, a plurality of lenses (lens units), and a sensor protecting glass. During focusing, the optical system OS23 integrally moves the aperture stop SP and lens units other than the lens closest to the image plane in the optical axis direction.

In the optical system OS23, for example, the lens closest to the object corresponds to the first refractive lens L1, the third refractive lens, and the fourth refractive lens, and the lens closest to the image plane corresponds to the second refractive lens L2.

### Example 24

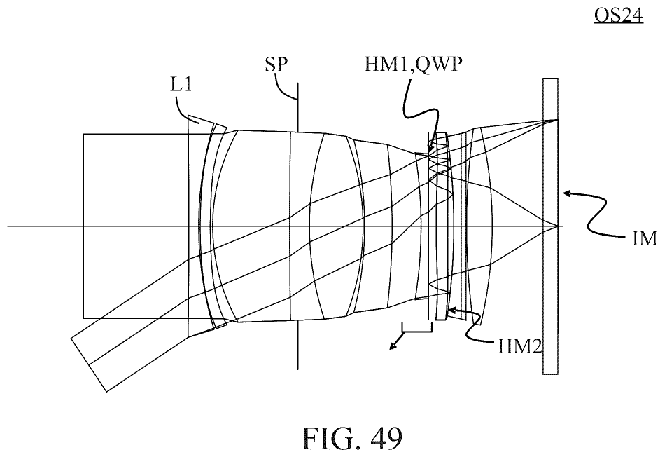

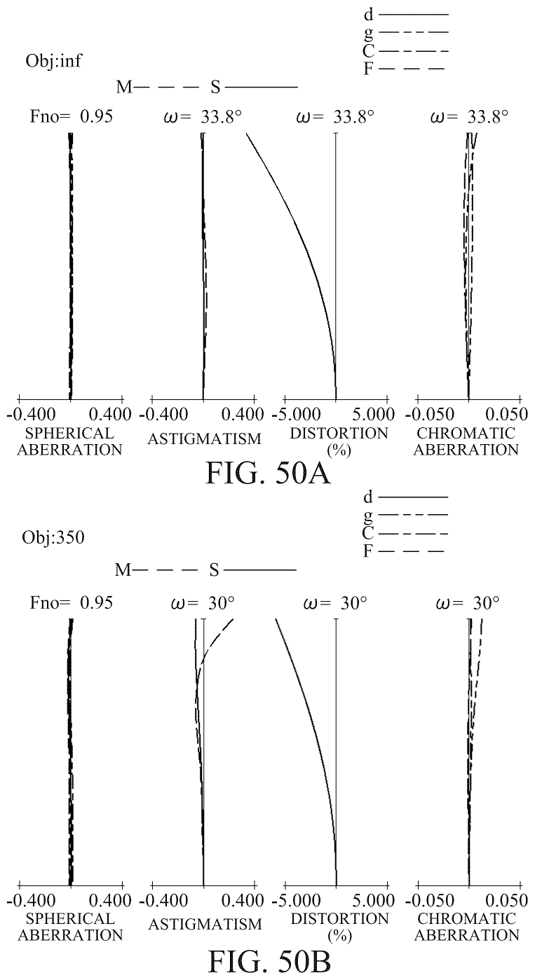

Referring now to FIGS. 49, 50A, and 50B, a description will be given of an optical system OS24 according to Example 24. FIG. 49 illustrates a sectional view of the optical system OS24. FIG. 50A illustrates an aberration diagram of the optical system OS24 in an in-focus state at infinity, and FIG. 50B illustrates an aberration diagram of the optical system OS24 in an in-focus state at a close distance.

The optical system OS24 includes, in order from the object side to the image plane IM side, a plurality of lenses (lens units), and a sensor protecting glass. During focusing, the optical system OS24 moves the sixth lens counted from the object side in the optical axis direction.

In the optical system OS24, for example, the lens closest to the object corresponds to the first refractive lens L1, and the lens having the first transmissive reflective surface HM1 corresponds to the fourth refractive lens.

### Example 25

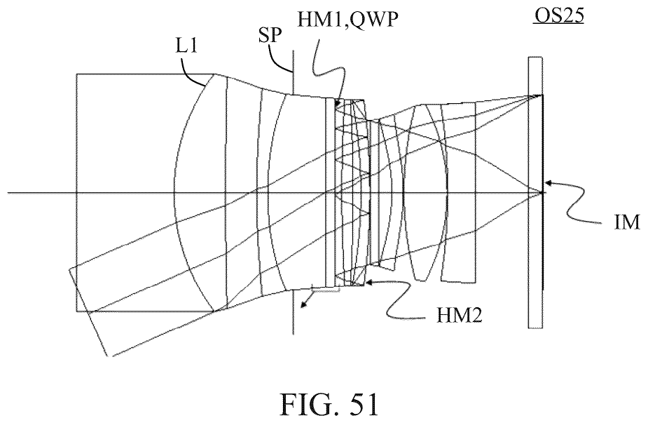

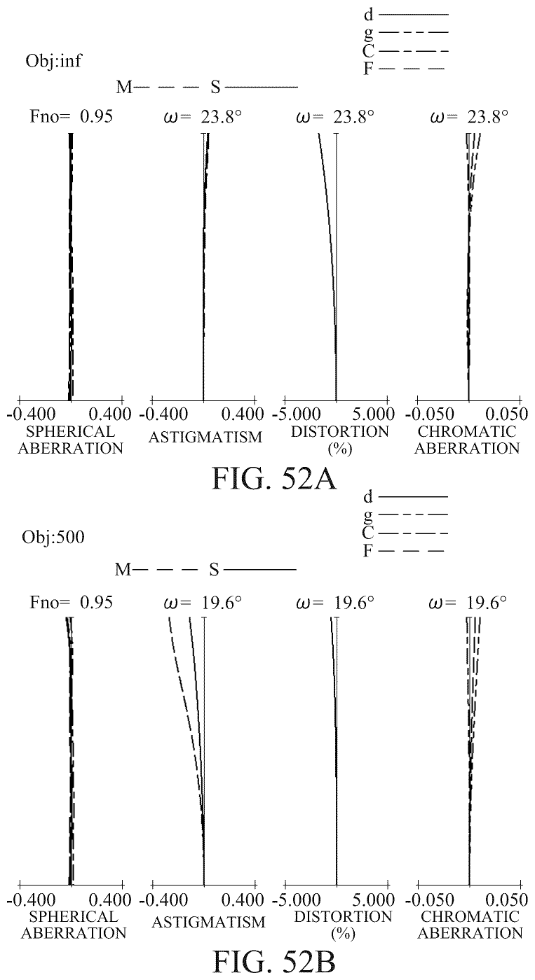

Referring now to FIGS. 51, 52A, and 52B, a description will be given of an optical system OS25 according to Example 25. FIG. 51 illustrates a sectional view of the optical system OS25. FIG. 52A is an aberration diagram of the optical system OS25 in an in-focus state at infinity, and FIG. 52B is an aberration diagram of the optical system OS25 in an in-focus state at a close distance.

The optical system OS25 includes, in order from the object side to the image plane IM side, a plurality of lenses (lens units), and a sensor protecting glass. During focusing, the optical system OS25 moves a flat plate disposed just after and on the image side of the aperture stop SP in the optical axis direction.

In the optical system OS25, for example, the lens closest to the object corresponds to the first refractive lens L1.

### Example 26

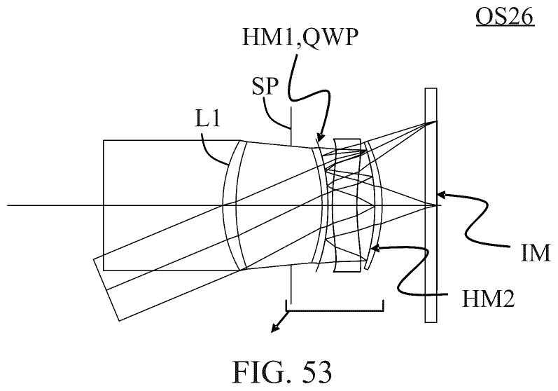

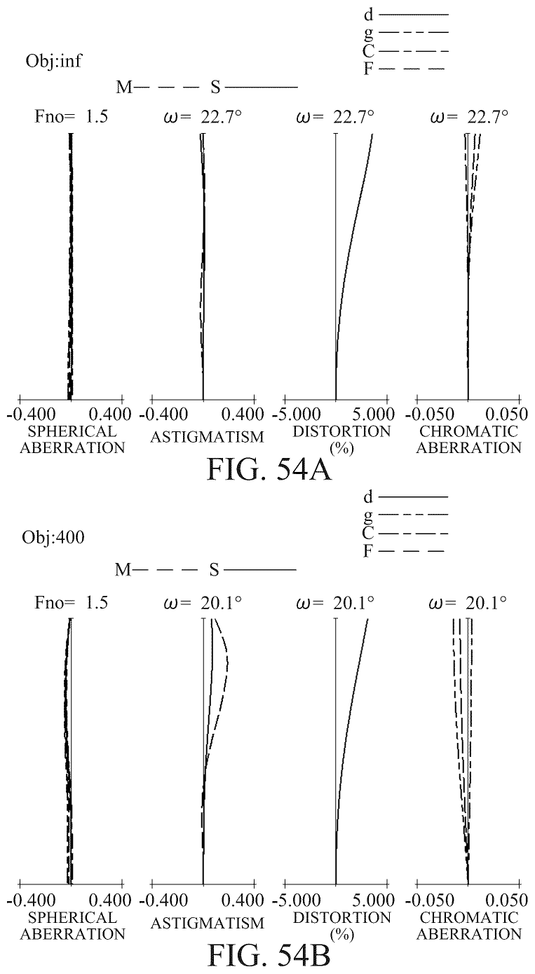

Referring now to FIGS. 53, 54A, and FIG. 54B, a description will be given of an optical system OS26 according to Example 26. FIG. 53 is a sectional view of the optical system OS26. FIG. 54A is an aberration diagram of the optical system OS26 in an in-focus state at infinity, and FIG. 54B is an aberration diagram of the optical system OS26 in an in-focus state at a close distance.

The optical system OS26 includes, in order from the object side to the image plane IM side, a plurality of lenses (a plurality of lens units) and a sensor protective glass. During focusing, the optical system OS26 integrally moves the aperture stop SP and three lenses other than the lens closest to the object.

In the optical system OS26, for example, the lens closest to the object corresponds to the first refractive lens L1, and the lens just after the aperture stop SP corresponds to the fourth refractive lens.

A description will now be given of numerical examples 1 to 26 corresponding to Examples 1 to 26, respectively. In surface data of each numerical example, a surface number i represents an i-th surface counted from the pupil plane side. r represents a radius of curvature of the i-th surface, and d (mm) represents a lens thickness or air distance between i-th and (i+1)-th surfaces. nd represents a refractive index of the material of the i-th optical element for the d-line, and vd represents the Abbe number based on the d-line of the optical member. The Abbe number vd of a certain material is expressed as follows:

$$vd = ( Nd - 1 ) / ( NF - NC )$$

where Nd, NF, and NC are refractive indices for the d-line (587.6 nm), F-line (486.1 nm), and C-line (656.3 nm) in the Fraunhofer lines, respectively. SP represents an aperture stop.

An asterisk “*” next to a surface number means that the surface has an aspheric shape. The aspheric shape is expressed as follows:

$$x ( h ) = \frac{( \frac{{h}^{2}}{r} )}{1 + \sqrt{\{ 1 - ( 1 + k ) {( \frac{h}{r} )}^{2} \}}} + {A}_{2} {h}^{2} + {A}_{4} {h}^{4} + {A}_{6} {h}^{6} + {A}_{8} {h}^{8} + {A}_{10} {h}^{10} + …$$

where x is a displacement amount at a position of height h from a surface vertex in the optical axis direction, R is a paraxial radius of curvature, k is a conic constant, and Ai: (i=2, 4, 6, 8 . . . ) are aspheric coefficients of each order. “e±XX” in each aspheric coefficient means “×10^{±XX}.”

In each numerical example, all of d, focal length (mm), F-number (Fno), and half angle of view (°) are values in a case where the optical system according to each example is in an in-focus state on an object at infinity. A “back focus (BF)” is a distance on the optical axis from a final lens surface (a lens surface closest to the image plane) to a paraxial image plane expressed in air-equivalent length. An “overall lens length” is a distance on the optical axis from the foremost lens surface (the lens surface closest to the object) of the optical system to the final surface plus the back focus. A “lens unit” includes one or more lenses.

NUMERICAL EXAMPLE 1
UNIT: mm
SURFACE DATA

| Surface No. | r | d | nd | νd |
|---|---|---|---|---|
| 1* | 33.264 | 3.80 | 1.51633 | 64.1 |
| 2* | 67.341 | 7.87 | | |
| 3 (SP) | ∞ | 3.61 | | |
| 4* | −60.314 | 8.76 | 1.54658 | 55.9 |
| 5* | −56.658 | 2.00 | | |
| 6* | −178.356 | 4.14 | 1.54658 | 55.9 |
| 7* | −278.259 | 5.36 | | |
| 8* | −49.931 | −5.36 | | |
| 9* | −278.259 | −4.14 | 1.54658 | 55.9 |
| 10* | −178.356 | −2.00 | | |
| 11* | −56.658 | 2.00 | | |
| 12* | −178.356 | 4.14 | 1.54658 | 55.9 |
| 13* | −278.259 | 5.36 | | |
| 14* | −49.931 | 2.35 | 1.54658 | 55.9 |
| 15* | 19.782 | 11.00 | | |
| 16 | ∞ | 3.00 | 1.51633 | 64.1 |
| 17 | ∞ | 0.10 | | |
| Image Plane | ∞ | | | |

ASPHERIC DATA
1st Surface
K = 0.00000e+00 A 4 = 1.75368e−06 A 6 = −2.08107e−09
2nd Surface
K = 0.00000e+00 A 4 = −1.06144e−06 A 6 = −1.12963e−08
4th Surface
K = 0.00000e+00 A 2 = −5.47088e−03 A 4 = −1.57901e−05 A 6 = 2.13974e−08 A 8 =
7.49429e−12
5th Surface
K = 0.00000e+00 A 4 = −3.35715e−06 A 6 = 5.58849e−09 A 8 = −1.34412e−11 A10 =
1.23184e−14 A12 = −8.60860e−21
6th Surface
K = 0.00000e+00 A 4 = 2.67533e−05 A 6 = −6.60403e−08 A 8 = 8.83817e−11 A10 = −3.54229e−13
A12 = 2.37426e−16
7th Surface
K = 0.00000e+00 A 4 = 2.21090e−05 A 6 = −4.76083e−08 A 8 = 9.17449e−11 A10 = −3.35061e−13
8th Surface
K = 0.00000e+00 A 4 = −8.37494e−07 A 6 = 9.41948e−10 A 8 = 8.14789e−12 A10 = −1.12477e−13
A12 = 3.58736e−16
9th Surface
K = 0.00000e+00 A 4 = 2.21090e−05 A 6 = −4.76083e−08 A 8 = 9.17449e−11 A10 = −3.35061e−13
10th Surface
K = 0.00000e+00 A 4 = 2.67533e−05 A 6 = −6.60403e−08 A 8 = 8.83817e−11 A10 = −3.54229e−13
A12 = 2.37426e−16
11th Surface
K = 0.00000e+00 A 4 = −3.35715e−06 A 6 = 5.58849e−09 A 8 = −1.34412e−11 A10 =
1.23184e−14 A12 = −8.60860e−21
12th Surface
K = 0.00000e+00 A 4 = 2.67533e−05 A 6 = −6.60403e−08 A 8 = 8.83817e−11 A10 = −3.54229e−13
A12 = 2.37426e−16
13th Surface
K = 0.00000e+00 A 4 = 2.21090e−05 A 6 = −4.76083e−08 A 8 = 9.17449e−11 A10 = −3.35061e−13
14th Surface
K = 0.00000e+00 A 4 = −8.37494e−07 A 6 = 9.41948e−10 A 8 = 8.14789e−12 A10 = −1.12477e−13
A12 = 3.58736e−16
15th Surface
K = 0.00000e+00 A 2 = −4.12994e−02 A 4 = −1.43658e−05 A 6 = −9.85889e−09 A 8 = −1.01161e−10

VARIOUS DATA

| | |
|---|---|
| Focal Length | 48.00 |
| Fno | 1.50 |
| Half Angle of View | 24.26 |
| Image Height | 21.64 |
| BF | 0.10 |
| d17 | 0.10 |

NUMERICAL EXAMPLE 2
UNIT: mm
SURFACE DATA

| Surface No. | r | d | nd | νd |
|---|---|---|---|---|
| 1* | −92.915 | 1.80 | 1.85400 | 40.4 |
| 2* | 275.875 | 0.20 | | |
| 3 | 66.286 | 7.72 | 1.70482 | 29.8 |
| 4 | −107.417 | 2.08 | | |
| 5 (SP) | ∞ | 4.87 | | |
| 6 | −67.525 | 1.50 | 1.93012 | 34.8 |
| 7 | ∞ | 1.00 | 1.51633 | 64.1 |
| 8 | ∞ | 0.10 | 1.51633 | 64.1 |
| 9 | ∞ | 3.86 | 1.90686 | 34.6 |
| 10 | −110.546 | −3.86 | | |
| 11 | ∞ | −0.10 | 1.51633 | 64.1 |
| 12 | ∞ | −1.00 | 1.51633 | 64.1 |
| 13 | ∞ | 1.00 | | |
| 14 | ∞ | 0.10 | 1.51633 | 64.1 |
| 15 | ∞ | 3.86 | 1.90686 | 34.6 |
| 16 | −110.546 | 1.69 | 1.96278 | 27.0 |
| 17 | 116.994 | 1.00 | | |
| 18* | 54.224 | 1.20 | 1.82754 | 38.6 |
| 19* | 45.694 | 1.20 | | |
| 20 | 33.649 | 6.69 | 1.49703 | 81.6 |
| 21 | −154.042 | 1.74 | | |
| 22 | −55.180 | 6.50 | 1.58935 | 64.1 |
| 23 | −20.730 | 3.00 | 1.80508 | 46.8 |
| 24 | −64.377 | 0.10 | | |
| 25 | −70.837 | 5.04 | 1.49701 | 81.6 |
| 26 | −29.198 | −0.10 | | |
| 27 | 131.017 | 2.02 | 1.61588 | 65.3 |
| 28* | −250.495 | 9.40 | | |
| 29 | ∞ | 3.00 | 1.51633 | 64.1 |
| 30 | ∞ | 0.10 | | |
| Image Plane | ∞ | | | |

ASPHERIC DATA
1st Surface
K = 0.00000e+00 A 4 = −4.06466e−06 A 6 = 1.03932e−08 A 8 = −1.67472e−11 A10 = 1.02529e−14
2nd Surface
K = 0.00000e+00 A 4 = −3.12852e−06 A 6 = 1.11218e−08 A 8 = −2.12628e−11 A10 =
1.94691e−14 A12 = −6.84758e−18
18th Surface
K = 0.00000e+00 A 4 = 2.10433e−05 A 6 = −2.77702e−08
19th Surface
K = 0.00000e+00 A 4 = 2.40984e−05 A 6 = −2.49256e−08
28th Surface
K = 0.00000e+00 A 4 = 7.07409e−06 A 6 = −7.48712e−09 A 8 = 2.28141e−11
A10 = −3.65416e−14

VARIOUS DATA

| | |
|---|---|
| Focal Length | 32.00 |
| Fno | 0.75 |
| Half Angle of View | 24.37 |
| Image Height | 14.50 |
| BF | 0.10 |
| d30 | 0.10 |

NUMERICAL EXAMPLE 3
UNIT: mm
SURFACE DATA

| Surface No. | r | d | nd | νd |
|---|---|---|---|---|
| 1* | −161.627 | 1.80 | 1.85400 | 40.4 |
| 2* | 82.516 | 0.20 | | |
| 3 | 51.999 | 6.47 | 1.73854 | 38.7 |
| 4 | −66.398 | 4.96 | | |
| 5 (SP) | ∞ | 2.19 | | |
| 6 | −115.094 | 1.50 | 1.72916 | 54.7 |
| 7 | 100.330 | 2.62 | 1.49092 | 67.6 |
| 8 | ∞ | 0.10 | 1.51633 | 50.0 |
| 9 | ∞ | 2.00 | 1.51633 | 64.1 |
| 10 | ∞ | −2.00 | | |
| 11 | ∞ | −0.10 | 1.51633 | 50.0 |
| 12 | ∞ | −2.62 | 1.49092 | 67.6 |
| 13 | 100.330 | 2.62 | | |
| 14 | ∞ | 0.10 | 1.51633 | 50.0 |
| 15 | ∞ | 2.00 | 1.51633 | 64.1 |
| 16 | ∞ | 1.70 | 1.84297 | 43.7 |
| 17 | 44.276 | 2.26 | | |
| 18 | 809.825 | 2.59 | 1.72916 | 54.7 |
| 19 | −101.774 | 1.20 | | |
| 20 | 47.329 | 3.62 | 1.52211 | 77.5 |
| 21 | 941.218 | 2.45 | | |
| 22 | −47.172 | 9.50 | 1.53844 | 75.1 |
| 23 | −23.955 | 2.00 | 1.90571 | 37.6 |
| 24 | −39.180 | 0.10 | | |
| 25 | 71.664 | 5.31 | 1.59522 | 67.7 |
| 26 | −64.902 | 9.40 | | |
| 27 | ∞ | 3.00 | 1.51633 | 64.1 |
| 28 | ∞ | 0.10 | | |
| Image Plane | ∞ | | | |

ASPHERIC DATA
1st Surface
K = 0.00000e+00 A 4 = −1.82053e−06 A 6 = 1.07157e−09
2nd Surface
K = 0.00000e+00 A 4 = 1.11630e−06 A 6 = 2.22067e−09

VARIOUS DATA

| | |
|---|---|
| Focal Length | 32.00 |
| Fno | 0.95 |
| Half Angle of View | 24.38 |
| Image Height | 14.50 |
| BF | 0.10 |
| d28 | 0.10 |

NUMERICAL EXAMPLE 4
UNIT: mm
SURFACE DATA

| Surface No. | r | d | nd | νd |
|---|---|---|---|---|
| 1 | 38.604 | 1.80 | 1.59522 | 67.7 |
| 2 | 21.733 | 10.42 | | |
| 3 | −2098.480 | 1.00 | 1.73273 | 54.3 |
| 4 | 51.623 | 0.20 | | |
| 5 | 36.753 | 4.79 | 1.55917 | 44.3 |
| 6 | −101.671 | 2.00 | | |
| 7 | −69.648 | 1.20 | 1.59522 | 67.7 |
| 8 | 66.757 | 2.17 | 1.69895 | 30.1 |
| 9 | 426.308 | 1.50 | | |
| 10 (SP) | ∞ | 6.23 | | |
| 11 | 30.285 | 6.34 | 1.49700 | 81.5 |
| 12 | −105.796 | 0.10 | | |
| 13 | 230.558 | 2.11 | 1.49700 | 81.5 |
| 14 | −161.563 | 7.56 | | |
| 15* | −101.727 | 1.50 | 1.85035 | 35.9 |
| 16 | ∞ | 4.56 | 1.49700 | 81.5 |
| 17 | −44.954 | 1.97 | 1.85407 | 36.5 |
| 18 | −105.745 | −1.97 | | |
| 19 | −44.954 | −4.56 | 1.49700 | 81.5 |
| 20 | ∞ | 4.56 | | |
| 21 | −44.954 | 1.97 | 1.85407 | 36.5 |
| 22 | −105.745 | 0.00 | | |
| 23 | −105.745 | 3.45 | 1.87153 | 42.0 |
| 24 | −36.678 | 0.10 | | |
| 25* | 121.884 | 2.00 | 1.85087 | 43.0 |
| 26* | 78.991 | 1.11 | | |
| 27 | −210.514 | 1.20 | 1.84666 | 23.8 |
| 28 | 252.666 | 0.10 | | |
| 29 | 47.461 | 4.09 | 2.00330 | 28.3 |
| 30 | 260.763 | 9.40 | | |
| 31 | ∞ | 0.00 | | |
| 32 | ∞ | 0.00 | | |
| 33 | ∞ | 3.00 | 1.51633 | 64.1 |
| 34 | ∞ | 0.11 | | |
| Image Plane | ∞ | | | |

ASPHERIC DATA
15th Surface
K = 0.00000e+00 A 4 = −8.84207e−06 A 6 = −1.26449e−08
25th Surface
K = 0.00000e+00 A 4 = −6.31962e−05 A 6 = 2.28241e−08
26th Surface
K = 0.00000e+00 A 4 = −6.21297e−05 A 6 = 4.62364e−08

VARIOUS DATA

| | |
|---|---|
| Focal Length | 21.65 |
| Fno | 0.95 |
| Half Angle of View | 33.81 |
| Image Height | 14.50 |
| BF | 0.11 |
| d34 | 0.11 |

NUMERICAL EXAMPLE 5
UNIT: mm
SURFACE DATA

| Surface No. | r | d | nd | νd |
|---|---|---|---|---|
| 1 | −109.185 | 1.50 | 1.67510 | 32.4 |
| 2 | −1210.137 | 0.20 | | |
| 3* | 34.632 | 6.56 | 1.63323 | 50.6 |
| 4* | −186.241 | 0.30 | | |
| 5 (SP) | ∞ | 5.89 | | |
| 6 | −60.428 | 1.50 | 1.63270 | 47.5 |
| 7 | 761.621 | 0.10 | | |
| 8 | 181.467 | 1.50 | 1.49758 | 82.4 |
| 9 | ∞ | 11.55 | 1.49402 | 82.0 |
| 10 | −65.604 | 2.00 | | |
| 11* | −86.397 | 1.00 | 2.00330 | 28.3 |
| 12 | −110.085 | −1.00 | | |
| 13* | −86.397 | −2.00 | | |
| 14 | −65.604 | −11.55 | 1.49402 | 82.0 |
| 15 | ∞ | 11.55 | | |
| 16 | −65.604 | 2.00 | | |
| 17* | −86.397 | 1.00 | 2.00330 | 28.3 |
| 18 | −110.085 | 1.00 | | |
| 19 | 115.140 | 1.71 | 1.63640 | 63.1 |
| 20* | 3508.933 | 1.44 | | |
| 21 | ∞ | 1.50 | 1.51633 | 64.1 |
| 22 | ∞ | 0.10 | | |
| Image Plane | ∞ | | | |

ASPHERIC DATA
3rd Surface
K = 0.00000e+00 A 4 = 1.63267e−07 A 6 = 2.93219e−09
4th Surface
K = 0.00000e+00 A 4 = 1.17377e−06 A 6 = 8.47197e−10 A 8 = −1.15699e−12
A10 = −4.32516e−15
11th Surface
K = 0.00000e+00 A 4 = −2.19247e−06 A 6 = −2.62246e−09 A 8 = 2.21713e−12
A10 = −2.22878e−14 A12 = 1.58408e−17
13th Surface
K = 0.00000e+00 A 4 = −2.19247e−06 A 6 = −2.62246e−09 A 8 = 2.21713e−12
A10 = −2.22878e−14 A12 = 1.58408e−17
17th Surface
K = 0.00000e+00 A 4 = −2.19247e−06 A 6 = −2.62246e−09 A 8 = 2.21713e−12
A10 = −2.22878e−14 A12 = 1.58408e−17
20th Surface
K = 0.00000e+00 A 4 = 2.63824e−05 A 6 = −1.06717e−07

VARIOUS DATA

| | |
|---|---|
| Focal Length | 32.00 |
| Fno | 0.95 |
| Half Angle of View | 24.38 |
| Image Height | 14.50 |
| BF | 0.10 |
| d22 | 0.10 |

NUMERICAL EXAMPLE 6
UNIT: mm
SURFACE DATA

| Surface No. | r | d | nd | νd |
|---|---|---|---|---|
| 1 | −81.190 | 3.00 | 1.56404 | 71.6 |
| 2 | −178.691 | 0.94 | | |
| 3 | 84.160 | 14.20 | 1.54726 | 46.3 |
| 4 | −109.712 | 3.90 | | |
| 5 (SP) | ∞ | 13.27 | | |
| 6 | −47.777 | 1.50 | 1.60342 | 38.0 |
| 7 | ∞ | 3.43 | 1.88300 | 40.8 |
| 8 | −214.922 | 2.26 | | |
| 9* | −144.806 | 3.50 | 1.59522 | 67.7 |
| 10 | −101.352 | −3.50 | | |
| 11* | −144.806 | −2.26 | | |
| 12 | −214.922 | −3.43 | 1.88300 | 40.8 |
| 13 | ∞ | 3.43 | | |
| 14 | −214.922 | 2.26 | | |
| 15* | −144.806 | 3.50 | 1.59522 | 67.7 |
| 16 | −101.352 | 4.35 | 1.81057 | 25.1 |
| 17 | 279.559 | 1.00 | | |
| 18 | 68.860 | 8.79 | 1.72916 | 54.7 |
| 19* | −135.440 | 4.25 | | |
| 20 | 58.135 | 6.52 | 1.50599 | 80.0 |
| 21 | −114.882 | 1.00 | | |
| 22 | ∞ | 3.00 | 1.51633 | 64.1 |
| 23 | ∞ | 0.10 | | |
| Image Plane | ∞ | | | |

ASPHERIC DATA
9th Surface
K = 0.00000e+00 A 4 = −8.77810e−07 A 6 = 1.97233e−11 A 8 = −1.93497e−13 A10 =
2.59713e−16 A12 = −1.33641e−19
11th Surface
K = 0.00000e+00 A 4 = −8.77810e−07 A 6 = 1.97233e−11 A 8 = −1.93497e−13 A10 =
2.59713e−16 A12 = −1.33641e−19
15th Surface
K = 0.00000e+00 A 4 = −8.77810e−07 A 6 = 1.97233e−11 A 8 = −1.93497e−13 A10 =
2.59713e−16 A12 = −1.33641e−19
19th Surface
K = 0.00000e+00 A 4 = 1.32990e−07 A 6 = 1.09167e−09 A 8 = −5.37842e−13 A10 =
2.07993e−16

VARIOUS DATA

| | |
|---|---|
| Focal Length | 32.00 |
| Fno | 0.55 |
| Half Angle of View | 24.38 |
| Image Height | 14.50 |
| BF | 0.10 |
| d23 | 0.10 |

NUMERICAL EXAMPLE 7
UNIT: mm
SURFACE DATA

| Surface No. | r | d | nd | νd |
|---|---|---|---|---|
| 1 | 132.020 | 1.80 | 1.52841 | 76.5 |
| 2 | 23.495 | 3.81 | | |
| 3* | 34.705 | 2.50 | 1.54658 | 55.9 |
| 4* | 24.842 | 5.79 | | |
| 5 | 33.997 | 3.04 | 1.84666 | 23.8 |
| 6 | 51.145 | 12.17 | | |
| 7 | 27.031 | 5.79 | 1.48749 | 70.4 |
| 8 | −127.810 | 0.30 | | |
| 9 (SP) | ∞ | 4.51 | | |
| 10* | −97.461 | 1.50 | 1.72916 | 54.7 |
| 11 | 183.806 | 1.00 | | |
| 12 | ∞ | 1.00 | 1.51633 | 64.1 |
| 13 | ∞ | 2.62 | 1.48749 | 70.2 |
| 14 | −62.885 | 2.00 | 1.85025 | 30.1 |
| 15* | −100.173 | −2.00 | | |
| 16 | −62.885 | −2.62 | 1.48749 | 70.2 |
| 17 | ∞ | −1.00 | 1.51633 | 64.1 |
| 18 | ∞ | 1.00 | | |
| 19 | ∞ | 2.62 | 1.48749 | 70.2 |
| 20 | −62.885 | 2.00 | 1.85025 | 30.1 |
| 21* | −100.173 | 2.15 | | |
| 22 | −71.168 | 3.71 | 1.49700 | 81.5 |
| 23 | −26.476 | 0.50 | | |
| 24 | −49.336 | 1.20 | 1.84666 | 23.8 |
| 25 | 1246.886 | 0.10 | | |
| 26* | 44.977 | 7.21 | 1.85400 | 40.4 |
| 27* | −51.137 | 9.40 | | |
| 28 | ∞ | 3.00 | 1.51633 | 64.1 |
| 29 | ∞ | 0.10 | | |
| Image Plane | ∞ | | | |

ASPHERIC DATA
3rd Surface
K = 0.00000e+00 A 4 = 2.80058e−05 A 6 = −1.86749e−08 A 8 = 5.41443e−12
A10 = 5.11302e−14
4th Surface
K = 0.00000e+00 A 4 = 2.71319e−05 A 6 = −2.40373e−08
10th Surface
K = 0.00000e+00 A 4 = 1.80747e−06 A 6 = 5.34299e−10
15th Surface
K = 0.00000e+00 A 4 = 2.89798e−06 A 6 = 4.44896e−09 A 8 = 2.67425e−12
21st Surface
K = 0.00000e+00 A 4 = 2.89798e−06 A 6 = 4.44896e−09 A 8 = 2.67425e−12
26th Surface
K = 0.00000e+00 A 4 = −2.06753e−06 A 6 = 7.40511e−09 A 8 = 2.47090e−11
27th Surface
K = 0.00000e+00 A 4 = 1.08328e−05 A 6 = −2.04810e−08 A 8 = 1.01300e−10
A10 = −9.40040e−14

VARIOUS DATA

| | |
|---|---|
| Focal Length | 17.38 |
| Fno | 0.95 |
| Half Angle of View | 39.84 |
| Image Height | 14.50 |
| BF | 0.10 |
| d29 | 0.10 |

NUMERICAL EXAMPLE 8
UNIT: mm
SURFACE DATA

| Surface No. | r | d | nd | νd |
|---|---|---|---|---|
| 1* | −409.789 | 1.80 | 1.85400 | 40.4 |
| 2* | 42.180 | 0.20 | | |
| 3 | 40.979 | 3.54 | 1.84666 | 23.8 |
| 4 | 122.998 | 1.00 | | |
| 5 | 96.345 | 1.92 | 2.00100 | 29.1 |
| 6 | 41.243 | 6.48 | 1.81600 | 46.6 |
| 7 | −118.059 | 0.50 | | |
| 8 (SP) | ∞ | 13.69 | | |
| 9 | ∞ | 1.00 | 1.51633 | 64.1 |
| 10 | ∞ | 0.10 | 1.51633 | 40.0 |
| 11 | ∞ | 2.72 | 1.82115 | 24.1 |
| 12 | −105.501 | −2.72 | | |
| 13 | ∞ | −0.10 | 1.51633 | 40.0 |
| 14 | ∞ | −1.00 | 1.51633 | 64.1 |
| 15 | ∞ | 1.00 | | |
| 16 | ∞ | 0.10 | 1.51633 | 40.0 |
| 17 | ∞ | 2.72 | 1.82115 | 24.1 |
| 18 | −105.501 | 1.70 | 1.92119 | 24.0 |
| 19* | 39.788 | 4.68 | | |
| 20 | −36.572 | 2.13 | 1.84666 | 23.8 |
| 21 | −35.086 | 1.00 | | |
| 22 | 91.120 | 7.28 | 1.49700 | 81.6 |
| 23 | −28.563 | 2.00 | 1.87070 | 40.7 |
| 24 | −173.578 | 0.10 | | |
| 25* | 39.262 | 8.74 | 1.58913 | 61.1 |
| 26* | −44.520 | 9.40 | | |
| 27 | ∞ | 3.00 | 1.51633 | 64.1 |
| 28 | ∞ | 0.10 | | |
| Image Plane | ∞ | | | |

ASPHERIC DATA
1st Surface
K = 0.00000e+00 A 4 = 4.43125e−08 A 6 = 8.19697e−10
2nd Surface
K = 0.00000e+00 A 4 = 1.51907e−06 A 6 = 1.25991e−09
19th Surface
K = 0.00000e+00 A 4 = −5.63465e−07 A 6 = −1.32044e−09
A 8 = −6.59630e−12 A10 = −3.66076e−15
25th Surface
K = 0.00000e+00 A 4 = 5.89089e−08 A 6 = 7.14844e−09
26th Surface
K = 0.00000e+00 A 4 = 9.86729e−06 A 6 = −5.58092e−09
A 8 = 3.90470e−11 A10 = −5.62801e−14

VARIOUS DATA

| | |
|---|---|
| Focal Length | 32.00 |
| Fno | 0.95 |
| Half Angle of View | 24.38 |
| Image Height | 14.50 |
| BF | 0.10 |
| d28 | 0.10 |

NUMERICAL EXAMPLE 9
UNIT: mm
SURFACE DATA

| Surface No. | r | d | nd | νd |
|---|---|---|---|---|
| 1* | 8.184 | 1.64 | 1.54658 | 55.9 |
| 2* | 33.051 | 4.17 | | |
| 3 (SP) | ∞ | 0.60 | | |
| 4* | −43.951 | 1.60 | 1.54658 | 55.9 |
| 5* | 564.166 | 1.26 | | |
| 6* | −7.524 | 0.30 | 1.54658 | 55.9 |
| 7* | −10.919 | 0.95 | | |
| 8* | −26.449 | 0.90 | 1.54658 | 55.9 |
| 9* | −15.162 | 0.95 | | |
| 10* | −9.626 | −0.95 | | |
| 11* | −15.162 | −0.90 | 1.54658 | 55.9 |
| 12* | −26.449 | −0.95 | | |
| 13* | −10.919 | 0.95 | | |
| 14* | −26.449 | 0.90 | 1.54658 | 55.9 |
| 15* | −15.162 | 0.95 | | |
| 16* | −9.626 | 0.35 | 1.54658 | 55.9 |
| 17* | −6.872 | 0.03 | | |
| 18 | ∞ | 0.43 | 1.51633 | 64.1 |
| 19 | ∞ | 0.10 | | |
| Image Plane | ∞ | | | |

ASPHERIC DATA
1st Surface
K = 0.00000e+00 A 2 = −2.92248e−02 A 4 = −1.66006e−04
A 6 = 1.48542e−06 A 8 = −3.34281e−08 A10 = 2.02751e−10
A12 = 1.57208e−12
2nd Surface
K = 0.00000e+00 A 4 = 7.63633e−05 A 6 = 5.33636e−06
A 8 = −1.52003e−07 A10 = 3.33154e−09 A12 = −2.42253e−11
4th Surface
K = 0.00000e+00 A 4 = −3.88719e−04 A 6 = −1.52411e−05
A 8 = 2.17573e−06 A10 = −1.53277e−07
5th Surface
K = 0.00000e+00 A 4 = −2.17211e−04 A 6 = 1.28090e−05
A 8 = −8.94365e−07
6th Surface
K = 0.00000e+00 A 4 = −5.58108e−04 A 6 = 1.87674e−05
A 8 = −1.36199e−06
7th Surface
K = 0.00000e+00 A 4 = −3.42153e−04 A 6 = 6.88122e−06
A 8 = −2.36999e−07 A10 = −8.92100e−10 A12 = 2.97739e−13
8th Surface
K = 0.00000e+00 A 4 = 5.15689e−05 A 6 = −1.88653e−05
A 8 = 3.12701e−07 A10 = −1.02106e−08 A12 = 5.08818e−11
9th Surface
K = 0.00000e+00 A 4 = 1.00441e−04 A 6 = −2.22495e−05
A 8 = 4.90051e−07 A10 = −9.61925e−09
10th Surface
K = 0.00000e+00 A 4 = −4.29042e−05 A 6 = 3.45895e−06
A 8 = −2.86769e−08 A10 = −2.33169e−09 A12 = 2.61879e−11
A14 = −1.75383e−14 A16 = −2.25865e−16
11th Surface
K = 0.00000e+00 A 4 = 1.00441e−04 A 6 = −2.22495e−05
A 8 = 4.90051e−07 A10 = −9.61925e−09
12th Surface
K = 0.00000e+00 A 4 = 5.15689e−05 A 6 = −1.88653e−05
A 8 = 3.12701e−07 A10 = −1.02106e−08 A12 = 5.08818e−11
13th Surface
K = 0.00000e+00 A 4 = −3.42153e−04 A 6 = 6.88122e−06
A 8 = −2.36999e−07 A10 = −8.92100e−10 A12 = 2.97739e−13
14th Surface
K = 0.00000e+00 A 4 = 5.15689e−05 A 6 = −1.88653e−05
A 8 = 3.12701e−07 A10 = −1.02106e−08 A12 = 5.08818e−11
15th Surface
K = 0.00000e+00 A 4 = 1.00441e−04 A 6 = −2.22495e−05
A 8 = 4.90051e−07 A10 = −9.61925e−09
16th Surface
K = 0.00000e+00 A 4 = −4.29042e−05 A 6 = 3.45895e−06
A 8 = −2.86769e−08 A10 = −2.33169e−09 A12 = 2.61879e−11
A14 = −1.75383e−14 A16 = −2.25865e−16
17th Surface
K = 0.00000e+00 A 2 = 7.65763e−03 A 4 = 1.70301e−03
A 6 = −2.74630e−05 A 8 = 2.26084e−07

VARIOUS DATA

| | |
|---|---|
| Focal Length | 7.74 |
| Fno | 1.40 |
| Half Angle of View | 45.66 |
| Image Height | 7.92 |
| BF | 0.10 |
| d19 | 0.10 |

NUMERICAL EXAMPLE 10
UNIT: mm
SURFACE DATA

| Surface No. | r | d | nd | νd |
|---|---|---|---|---|
| 1* | 34.495 | 3.34 | 1.51633 | 64.1 |
| 2* | 75.497 | (Variable) | | |
| 3 (SP) | ∞ | 4.31 | | |
| 4* | −69.221 | 3.66 | 1.54658 | 55.9 |
| 5* | −51.980 | (Variable) | | |
| 6* | 117.370 | 4.32 | 1.54658 | 55.9 |
| 7* | 166.054 | 3.48 | | |
| 8* | 111.755 | −3.48 | | |
| 9* | 166.054 | −4.32 | 1.54658 | 55.9 |
| 10* | 117.370 | (Variable) | | |
| 11* | −51.980 | (Variable) | | |
| 12* | 117.370 | 4.32 | 1.54658 | 55.9 |
| 13* | 166.054 | 3.48 | | |
| 14* | 111.755 | 3.04 | 1.54658 | 55.9 |
| 15* | 34.800 | (Variable) | | |
| 16 | ∞ | 3.00 | 1.51633 | 64.1 |
| 17 | ∞ | 0.10 | | |
| Image Plane | ∞ | | | |

ASPHERIC DATA
1st Surface
K = 0.00000e+00 A 4 = −1.74929e−06 A 6 = −8.62843e−10
2nd Surface
K = 0.00000e+00 A 4 = −4.07821e−06 A 6 = −7.23767e−10
4th Surface
K = 0.00000e+00 A 2 = −1.22787e−02 A 4 = −1.83823e−06
A 6 = 2.70135e−08 A 8 = −5.09885e−11
5th Surface
K = 0.00000e+00 A 4 = −2.15470e−06 A 6 = 4.98429e−09
A 8 = −3.38806e−11 A10 = 1.31569e−13 A12 = −2.13965e−16
6th Surface
K = 0.00000e+00 A 4 = −1.56713e−07 A 6 = −6.36987e−08
A 8 = 8.88377e−11 A10 = −2.64136e−13 A12 = 2.14791e−16
7th Surface
K = 0.00000e+00 A 4 = 3.08711e−06 A 6 = −4.36485e−08
A 8 = 1.39724e−11 A10 = 2.33549e−15
8th Surface
K = 0.00000e+00 A 2 = −1.54062e−02 A 4 = −1.12202e−06
A 6 = 1.18269e−10 A 8 = 5.81600e−12 A10 = −5.88663e−15
A12 = 1.86539e−18
9th Surface
K = 0.00000e+00 A 4 = 3.08711e−06 A 6 = −4.36485e−08
A 8 = 1.39724e−11 A10 = 2.33549e−15
10th Surface
K = 0.00000e+00 A 4 = −1.56713e−07 A 6 = −6.36987e−08
A 8 = 8.88377e−11 A10 = −2.64136e−13 A12 = 2.14791e−16
11th Surface
K = 0.00000e+00 A 4 = −2.15470e−06 A 6 = 4.98429e−09
A 8 = −3.38806e−11 A10 = 1.31569e−13 A12 = −2.13965e−16
12th Surface
K = 0.00000e+00 A 4 = −1.56713e−07 A 6 = −6.36987e−08
A 8 = 8.88377e−11 A10 = −2.64136e−13 A12 = 2.14791e−16
13th Surface
K = 0.00000e+00 A 4 = 3.08711e−06 A 6 = −4.36485e−08
A 8 = 1.39724e−11 A10 = 2.33549e−15
14th Surface
K = 0.00000e+00 A 2 = −1.54062e−02 A 4 = −1.12202e−06
A 6 = 1.18269e−10 A 8 = 5.81600e−12 A10 = −5.88663e−15
A12 = 1.86539e−18
15th Surface
K = 0.00000e+00 A 2 = −3.00572e−02 A 4 = −1.07875e−05
A 6 = −1.07802e−08 A 8 = 4.04651e−13

VARIOUS DATA

| | |
|---|---|
| Focal Length | 48.00 |
| Fno | 1.50 |
| Half Angle of View | 24.26 |
| Image Height | 21.64 |
| BF | 0.10 |

| Object Distance | INF | 480 | 400 |
|---|---|---|---|
| d2 | 12.67 | 12.67 | 12.67 |
| d5 | 3.08 | 2.37 | 2.00 |
| d10 | −3.08 | −2.37 | −2.00 |
| d11 | 3.08 | 2.37 | 2.00 |
| d15 | 11.00 | 20.26 | 23.79 |
| d17 | 0.10 | −6.12 | −8.05 |

NUMERICAL EXAMPLE 11
UNIT: mm
SURFACE DATA

| Surface No. | r | d | nd | νd |
|---|---|---|---|---|
| 1 | 43.050 | 2.48 | 1.49700 | 81.5 |
| 2 | 122.119 | 5.62 | | |
| 3 (SP) | ∞ | 0.99 | | |
| 4 | −72.690 | 1.50 | 1.51680 | 64.2 |
| 5 | −2719.444 | 2.91 | 1.49700 | 81.5 |
| 6 | −71.844 | 14.08 | | |
| 7* | −84.641 | 2.00 | 1.77250 | 49.5 |
| 8 | −127.982 | −2.00 | | |
| 9* | −85.016 | −14.08 | | |
| 10 | −71.844 | −2.91 | 1.49700 | 81.5 |
| 11 | −2719.444 | 2.91 | | |
| 12 | −71.844 | 14.08 | | |
| 13* | −84.641 | 2.00 | 1.77250 | 49.5 |
| 14 | −127.982 | 1.70 | 1.80518 | 25.4 |
| 15 | −755.115 | 1.00 | | |
| 16 | 50.885 | 4.16 | 1.49700 | 81.5 |
| 17 | −142.624 | 2.00 | | |
| 18 | ∞ | 1.50 | 1.51633 | 64.1 |
| 19 | ∞ | 0.10 | | |
| Image Plane | ∞ | | | |

ASPHERIC DATA
7th Surface
K = 0.00000e+00 A 4 = −1.27170e−06 A 6 = 1.09638e−09
A 8 = −1.59118e−11 A10 = 6.69227e−14 A12 = −1.11236e−16
9th Surface
K = 0.00000e+00 A 4 = −1.27170e−06 A 6 = 1.09638e−09
A 8 = −1.59118e−11 A10 = 6.69227e−14 A12 = −1.11236e−16
13th Surface
K = 0.00000e+00 A 4 = −1.27170e−06 A 6 = 1.09638e−09
A 8 = −1.59118e−11 A10 = 6.69227e−14 A12 = −1.11236e−16

VARIOUS DATA

| | |
|---|---|
| Focal Length | 45.00 |
| Fno | 2.00 |
| Half Angle of View | 16.72 |
| Image Height | 13.52 |
| BF | 0.10 |
| d19 | 0.10 |

NUMERICAL EXAMPLE 12
UNIT: mm
SURFACE DATA

| Surface No. | r | d | nd | νd |
|---|---|---|---|---|
| 1 | −64.414 | 1.70 | 1.80400 | 46.6 |
| 2 | −89.821 | 0.20 | | |
| 3 | 37.669 | 7.98 | 1.51823 | 58.9 |
| 4 | −115.201 | 3.69 | | |
| 5 (SP) | ∞ | 2.18 | | |
| 6 | −105.027 | 1.50 | 1.83481 | 42.7 |
| 7 | −577.086 | 7.48 | | |
| 8 | 132.568 | 1.50 | 1.49700 | 81.5 |
| 9 | ∞ | 1.81 | 1.83481 | 42.7 |
| 10 | −134.855 | 2.00 | | |
| 11* | −54.249 | 2.00 | 1.85400 | 40.4 |
| 12 | −102.974 | −2.00 | | |
| 13* | −54.249 | −2.00 | | |
| 14 | −134.855 | −1.81 | 1.83481 | 42.7 |
| 15 | ∞ | 1.81 | | |
| 16 | −135.405 | 2.00 | | |
| 17* | −54.249 | 2.00 | 1.85400 | 40.4 |
| 18 | −102.974 | 1.70 | 2.00330 | 28.3 |
| 19 | 220.682 | 1.16 | | |
| 20 | −170.532 | 3.24 | 1.49700 | 81.5 |
| 21 | −36.082 | 1.20 | | |
| 22 | 57.215 | 4.96 | 1.80420 | 46.5 |
| 23 | −81.669 | 9.40 | | |
| 24 | ∞ | 3.00 | 1.51633 | 64.1 |
| 25 | ∞ | 0.10 | | |
| Image Plane | ∞ | | | |

ASPHERIC DATA
11th Surface
K = 0.00000e+00 A 4 = −2.98007e−06 A 6 = 5.44403e−09
A 8 = −5.81960e−11 A10 = 2.52878e−13 A12 = −4.19387e−16
13th Surface
K = 0.00000e+00 A 4 = −2.98007e−06 A 6 = 5.44403e−09
A 8 = −5.81960e−11 A10 = 2.52878e−13 A12 = −4.19387e−16
17th Surface
K = 0.00000e+00 A 4 = −2.98007e−06 A 6 = 5.44403e−09
A 8 = −5.81960e−11 A10 = 2.52878e−13 A12 = 4.19387e−16

VARIOUS DATA

| | |
|---|---|
| Focal Length | 32.00 |
| Fno | 0.95 |
| Half Angle of View | 24.38 |
| Image Height | 14.50 |
| BF | 0.10 |
| d25 | 0.10 |

NUMERICAL EXAMPLE 13
UNIT: mm
SURFACE DATA

| Surface No. | r | d | nd | νd |
|---|---|---|---|---|
| 1 | 212.715 | 2.00 | 1.49700 | 81.5 |
| 2 | 117.564 | 3.05 | 1.68948 | 31.0 |
| 3 | 296.551 | 23.72 | | |
| 4 | 242.548 | 2.89 | 1.84666 | 23.8 |
| 5 | 101.330 | 2.49 | | |
| 6 | −110.931 | 2.00 | 1.91082 | 35.2 |
| 7 | 913.868 | 1.15 | | |
| 8 (SP) | ∞ | 0.30 | | |
| 9 | 60.164 | 3.22 | 1.80518 | 25.5 |
| 10 | ∞ | 4.95 | 1.48749 | 70.2 |
| 11 | −52.664 | 2.31 | | |
| 12* | −56.420 | 2.00 | 1.85400 | 40.4 |
| 13 | −101.670 | −2.00 | | |
| 14* | −56.420 | −2.31 | | |
| 15 | −52.664 | −4.95 | 1.48749 | 70.2 |
| 16 | ∞ | 4.95 | | |
| 17 | −52.664 | 2.31 | | |
| 18* | −56.420 | 2.00 | 1.85400 | 40.4 |
| 19 | −101.670 | 1.70 | 1.77250 | 49.6 |
| 20 | 37.111 | 1.12 | | |
| 21 | 42.372 | 9.37 | 1.51680 | 64.2 |
| 22* | −27.818 | 1.20 | | |
| 23 | 40.818 | 4.10 | 1.49700 | 81.5 |
| 24 | 1004.153 | 9.40 | | |
| 25 | ∞ | 3.00 | 1.51633 | 64.1 |
| 26 | ∞ | 0.10 | | |
| Image Plane | ∞ | | | |

ASPHERIC DATA
12th Surface
K = 0.00000e+00 A 4 = −2.56220e−06 A 6 = −1.16511e−09
A 8 = −8.21450e−12 A10 = 2.52195e−14 A12 = −4.26110e−17
14th Surface
K = 0.00000e+00 A 4 = −2.56220e−06 A 6 = −1.16511e−09
A 8 = −8.21450e−12 A10 = 2.52195e−14 A12 = −4.26110e−17
18th Surface
K = 0.00000e+00 A 4 = −2.56220e−06 A 6 = −1.16511e−09
A 8 = −8.21450e−12 A10 = 2.52195e−14 A12 = −4.26110e−17
22nd Surface
K = 0.00000e+00 A 4 = 2.04785e−06 A 6 = −8.15703e−09

VARIOUS DATA

| | |
|---|---|
| Focal Length | 32.00 |
| Fno | 0.95 |
| Half Angle of View | 24.38 |
| Image Height | 14.50 |
| BF | 0.10 |
| d26 | 0.10 |

NUMERICAL EXAMPLE 14
UNIT: mm
SURFACE DATA

| Surface No. | r | d | nd | νd |
|---|---|---|---|---|
| 1 | −100.067 | 2.00 | 1.48749 | 70.2 |
| 2 | −340.582 | 2.93 | | |
| 3 | 79.292 | 11.08 | 1.54072 | 47.2 |
| 4 | −128.708 | 7.22 | | |
| 5 (SP) | ∞ | 7.19 | | |
| 6 | −64.631 | 2.00 | 1.60342 | 38.0 |
| 7 | ∞ | 2.53 | 1.83481 | 42.7 |
| 8 | −260.842 | 4.82 | | |
| 9* | −82.704 | 3.50 | 1.53996 | 59.5 |
| 10 | −90.589 | −3.50 | | |
| 11* | −82.704 | −4.82 | | |
| 12 | −260.842 | −2.53 | 1.83481 | 42.7 |
| 13 | ∞ | 2.53 | | |
| 14 | −260.842 | 4.82 | | |
| 15* | −82.704 | 3.50 | 1.53996 | 59.5 |
| 16 | −90.589 | 1.72 | 1.84666 | 23.8 |
| 17 | −1015.139 | 1.72 | | |
| 18 | 47.324 | 7.42 | 1.64000 | 60.2 |
| 19* | −96.561 | 3.49 | | |
| 20 | 51.514 | 5.39 | 1.55352 | 71.7 |
| 21 | −114.495 | 1.06 | | |
| 22 | ∞ | 3.00 | 1.51633 | 64.1 |
| 23 | ∞ | 0.10 | | |
| Image Plane | ∞ | | | |

ASPHERIC DATA
9th Surface
K = 0.00000e+00 A 4 = −8.31478e−07 A 6 = −2.74307e−10
A 8 = 1.58841e−13 A10 = 2.42540e−17 A12 = −1.36738e−19
11th Surface
K = 0.00000e+00 A 4 = −8.31478e−07 A 6 = −2.74307e−10
A 8 = 1.58841e−13 A10 = 2.42540e−17 A12 = −1.36738e−19
15th Surface
K = 0.00000e+00 A 4 = −8.31478e−07 A 6 = −2.74307e−10
A 8 = 1.58841e−13 A10 = 2.42540e−17 A12 = −1.36738e−19
19th Surface
K = 0.00000e+00 A 4 = 2.54086e−06 A 6 = −5.50287e−10
A 8 = 1.66150e−12 A10 = 7.92260e−18

VARIOUS DATA

| | |
|---|---|
| Focal Length | 32.00 |
| Fno | 0.55 |
| Half Angle of View | 24.38 |
| Image Height | 14.50 |
| BF | 0.10 |
| d23 | 0.10 |

NUMERICAL EXAMPLE 15
UNIT: mm
SURFACE DATA

| Surface No. | r | d | nd | νd |
|---|---|---|---|---|
| 1 | 52.287 | 5.84 | 1.58573 | 59.7 |
| 2* | 135.265 | 6.51 | | |
| 3 (SP) | ∞ | 3.11 | | |
| 4 | −106.453 | 2.00 | 1.53775 | 74.7 |
| 5 | −114.505 | 13.32 | 1.56732 | 42.8 |
| 6 | −117.115 | 15.96 | | |
| 7* | −59.265 | 2.00 | 1.51742 | 52.2 |
| 8 | −104.966 | −2.00 | | |
| 9* | −59.265 | −15.96 | | |
| 10 | −117.043 | −13.32 | 1.56732 | 42.8 |
| 11 | −114.430 | 13.32 | | |
| 12 | −117.043 | 15.96 | | |
| 13* | −59.265 | 2.00 | 1.51742 | 52.2 |
| 14 | −104.966 | 1.70 | 1.51742 | 52.4 |
| 15 | −85.497 | 1.00 | | |
| 16* | 526.394 | 2.84 | 1.85400 | 40.4 |
| 17* | −148.323 | 4.44 | | |
| 18 | ∞ | 1.50 | 1.51633 | 64.1 |
| 19 | ∞ | 0.10 | | |
| Image Plane | ∞ | | | |

ASPHERIC DATA
1st Surface
K = 0.00000e+00 A 4 = 3.18032e−07 A 6 = 2.80240e−10
A 8 = −6.47939e−14 A10 = 3.10952e−16
2nd Surface
K = 0.00000e+00 A 4 = −1.64643e−07 A 6 = −1.26010e−10
7th Surface
K = 0.00000e+00 A 4 = −7.44307e−07 A 6 = −5.79334e−10
A 8 = 2.09678e−14 A10 = −7.96117e−16 A12 = 2.86214e−19
9th Surface
K = 0.00000e+00 A 4 = −7.44307e−07 A 6 = −5.79334e−10
A 8 = 2.09678e−14 A10 = −7.96117e−16 A12 = 2.86214e−19
13th Surface
K = 0.00000e+00 A 4 = −7.44307e−07 A 6 = −5.79334e−10
A 8 = 2.09678e−14 A10 = −7.96117e−16 A12 = 2.86214e−19
16th Surface
K = 0.00000e+00 A 4 = −4.65984e−05 A 6 = −1.36407e−07
17th Surface
K = 0.00000e+00 A 4 = −5.41008e−05 A 6 = −5.41946e−08

VARIOUS DATA

| | |
|---|---|
| Focal Length | 100.00 |
| Fno | 2.00 |
| Half Angle of View | 7.70 |
| Image Height | 13.52 |
| BF | 0.10 |
| d19 | 0.10 |

NUMERICAL EXAMPLE 16
UNIT: mm
SURFACE DATA

| Surface No. | r | d | nd | νd |
|---|---|---|---|---|
| 1 | 62.002 | 6.87 | 1.61997 | 63.9 |
| 2 | 374.246 | 20.78 | | |
| 3 (SP) | ∞ | 2.62 | | |
| 4 | −101.769 | 1.50 | 1.88300 | 40.8 |
| 5 | ∞ | 12.45 | 1.65160 | 58.5 |
| 6 | −80.971 | 2.00 | | |
| 7* | −92.486 | 2.41 | 1.85400 | 40.4 |
| 8 | −169.778 | −2.41 | | |
| 9* | −92.486 | −2.00 | | |
| 10 | −80.971 | −12.45 | 1.65160 | 58.5 |
| 11 | ∞ | 12.45 | | |
| 12 | −80.971 | 2.00 | | |
| 13* | −92.486 | 2.41 | 1.85400 | 40.4 |
| 14 | −169.778 | 6.36 | 1.49700 | 81.5 |
| 15 | −59.903 | 14.27 | | |
| 16 | ∞ | 3.00 | 1.51633 | 64.1 |
| 17 | ∞ | 0.10 | | |
| Image Plane | ∞ | | | |

ASPHERIC DATA
7th Surface
K = 0.00000e+00 A 4 = −8.49441e−07 A 6 = 4.42583e−10
A 8 = −2.29922e−12 A10 = 3.41916e−15 A12 = −2.00408e−18
9th Surface
K = 0.00000e+00 A 4 = −8.49441e−07 A 6 = 4.42583e−10
A 8 = −2.29922e−12 A10 = 3.41916e−15 A12 = −2.00408e−18
13th Surface
K = 0.00000e+00 A 4 = −8.49441e−07 A 6 = 4.42583e−10
A 8 = −2.29922e−12 A10 = 3.41916e−15 A12 = −2.00408e−18

VARIOUS DATA

| | |
|---|---|
| Focal Length | 52.00 |
| Fno | 0.95 |
| Half Angle of View | 14.58 |
| Image Height | 13.52 |
| BF | 0.10 |
| d17 | 0.10 |

NUMERICAL EXAMPLE 17
UNIT: mm
SURFACE DATA

| Surface No. | r | d | nd | νd |
|---|---|---|---|---|
| 1 | 45.051 | 2.00 | 2.00100 | 29.1 |
| 2 | 46.817 | 6.45 | | |
| 3* | 35.316 | 5.10 | 1.51633 | 64.1 |
| 4 | 448.833 | 1.29 | | |
| 5 (SP) | ∞ | 8.73 | | |
| 6 | −34.039 | 1.71 | 1.49700 | 81.5 |
| 7 | −37.495 | 0.10 | | |
| 8 | −222.409 | 1.50 | 2.00100 | 29.1 |
| 9 | ∞ | 4.62 | 1.48749 | 70.2 |
| 10 | −46.732 | 1.50 | | |
| 11* | −40.684 | 2.00 | 1.85400 | 40.4 |
| 12 | −98.403 | −2.00 | | |
| 13* | −40.684 | −1.50 | | |
| 14 | −46.732 | −4.62 | 1.48749 | 70.2 |
| 15 | ∞ | 4.62 | | |
| 16 | −46.732 | 1.50 | | |
| 17* | −40.684 | 2.00 | 1.85400 | 40.4 |
| 18 | −98.404 | 1.00 | | |
| 19 | 144.816 | 5.66 | 1.88300 | 40.8 |
| 20 | −42.677 | 9.40 | | |
| 21 | ∞ | 3.00 | 1.51633 | 64.1 |
| 22 | ∞ | 0.10 | | |
| Image Plane | ∞ | | | |

ASPHERIC DATA
3rd Surface
K = 0.00000e+00 A 4 = 1.01631e−06 A 6 = −2.30048e−09
A 8 = 2.71764e−11 A10 = −5.99857e−14 A12 = 7.06294e−17
11th Surface
K = 0.00000e+00 A 4 = −4.23437e−06 A 6 = 4.07555e−09
A 8 = −6.70601e−11 A10 = 2.79579e−13 A12 = −4.68393e−16
13th Surface
K = 0.00000e+00 A 4 = −4.23437e−06 A 6 = 4.07555e−09
A 8 = −6.70601e−11 A10 = 2.79579e−13 A12 = −4.68393e−16
17th Surface
K = 0.00000e+00 A 4 = −4.23437e−06 A 6 = 4.07555e−09
A 8 = −6.70601e−11 A10 = 2.79579e−13 A12 = −4.68393e−16

VARIOUS DATA

| | |
|---|---|
| Focal Length | 32.00 |
| Fno | 0.95 |
| Half Angle of View | 24.38 |
| Image Height | 14.50 |
| BF | 0.10 |
| d22 | 0.10 |

NUMERICAL EXAMPLE 18
UNIT: mm
SURFACE DATA

| Surface No. | r | d | nd | νd |
|---|---|---|---|---|
| 1 | 48.707 | 1.50 | 1.84666 | 23.8 |
| 2* | 46.185 | 5.77 | | |
| 3 | 38.164 | 2.00 | 1.78470 | 26.3 |
| 4 | 79.648 | 1.86 | | |
| 5 (SP) | ∞ | 2.07 | | |
| 6 | −62.601 | 2.37 | 1.59522 | 67.7 |
| 7 | ∞ | 3.87 | 1.52841 | 76.5 |
| 8 | −51.351 | 2.07 | | |
| 9* | −44.034 | 2.00 | 1.95375 | 32.3 |
| 10 | −71.635 | −2.00 | | |
| 11* | −44.034 | −2.07 | | |
| 12 | −51.351 | −3.87 | 1.52841 | 76.5 |
| 13 | ∞ | 3.87 | | |
| 14 | −51.351 | 2.07 | | |
| 15* | −44.034 | 2.00 | 1.95375 | 32.3 |
| 16 | −71.635 | 4.69 | 1.72916 | 54.7 |
| 17* | −29.692 | 1.00 | | |
| 18 | 35.258 | 6.70 | 1.49700 | 81.5 |
| 19 | −97.953 | 3.39 | | |
| 20 | ∞ | 3.00 | 1.51633 | 64.1 |
| 21 | ∞ | 0.10 | | |
| Image Plane | ∞ | | | |

ASPHERIC DATA
2nd Surface
K = 0.00000e+00 A 4 = −1.80322e−06 A 6 = −4.85921e−09
9th Surface
K = 0.00000e+00 A 4 = −5.53212e−06 A 6 = −1.00677e−08
A 8 = 2.07899e−12 A10 = −6.64077e−14 A12 = −8.05438e−17
11th Surface
K = 0.00000e+00 A 4 = −5.53212e−06 A 6 = −1.00677e−08
A 8 = 2.07899e−12 A10 = −6.64077e−14 A12 = −8.05438e−17
15th Surface
K = 0.00000e+00 A 4 = −5.53212e−06 A 6 = −1.00677e−08
A 8 = 2.07899e−12 A10 = −6.64077e−14 A12 = −8.05438e−17
17th Surface
K = 0.00000e+00 A 4 = −3.18242e−06 A 6 = −2.57579e−08
A 8 = 7.82406e−11 A10 = −2.38554e−13

VARIOUS DATA

| | |
|---|---|
| Focal Length | 21.65 |
| Fno | 0.90 |
| Half Angle of View | 33.82 |
| Image Height | 14.50 |
| BF | 0.10 |
| d21 | 0.10 |

NUMERICAL EXAMPLE 19
UNIT: mm
SURFACE DATA

| Surface No. | r | d | nd | νd |
|---|---|---|---|---|
| 1* | 34.741 | 3.12 | 1.51633 | 64.1 |
| 2* | 70.145 | (Variable) | | |
| 3 (SP) | ∞ | 3.67 | | |
| 4* | −87.357 | 6.37 | 1.54658 | 55.9 |
| 5* | −50.934 | (Variable) | | |
| 6* | −51.069 | 4.35 | 1.54658 | 55.9 |
| 7* | −55.512 | 5.11 | | |
| 8* | −48.144 | −5.11 | | |
| 9* | −55.512 | −4.35 | 1.54658 | 55.9 |
| 10* | −51.069 | (Variable) | | |
| 11* | −50.934 | (Variable) | | |
| 12* | −51.069 | 4.35 | 1.54658 | 55.9 |
| 13* | −55.512 | 5.11 | | |
| 14* | −48.144 | 1.70 | 1.54658 | 55.9 |
| 15* | 22.265 | (Variable) | | |
| 16 | ∞ | 3.00 | 1.51633 | 64.1 |
| 17 | ∞ | 0.10 | | |
| Image Plane | ∞ | | | |

ASPHERIC DATA
1st Surface
K = 0.00000e+00 A 4 = 2.05760e−06 A 6 = −1.20695e−09
A 8 = 1.87087e−11 A10 = −3.04451e−14 A12 = −3.38066e−18
2nd Surface
K = 0.00000e+00 A 4 = 8.53439e−07 A 6 = −3.77007e−09
A 8 = 1.13209e−11 A10 = −4.09934e−14 A12 = 2.20382e−17
4th Surface
K = 0.00000e+00 A 2 = −9.94614e−03 A 4 = −1.13659e−05
A 6 = 1.70344e−08 A 8 = 1.55013e−11 A10 = 1.01486e−14
5th Surface
K = 0.00000e+00 A 4 = −1.98602e−06 A 6 = 1.24590e−09
A 8 = 7.15980e−12 A10 = −7.27344e−14
6th Surface
K = 0.00000e+00 A 4 = 1.74651e−05 A 6 = −3.72923e−08
A 8 = −5.19580e−11 A10 = 7.83608e−14 A12 = −7.61217e−16
7th Surface
K = 0.00000e+00 A 4 = 1.25192e−05 A 6 = −2.18272e−08
A 8 = 2.39426e−11 A10 = −1.99465e−13
8th Surface
K = 0.00000e+00 A 4 = −1.52761e−07 A 6 = 1.51824e−10
A 8 = −4.67105e−13 A10 = −1.43466e−14 A12 = 6.59523e−17
9th Surface
K = 0.00000e+00 A 4 = 1.25192e−05 A 6 = −2.18272e−08
A 8 = 2.39426e−11 A10 = −1.99465e−13
10th Surface
K = 0.00000e+00 A 4 = 1.74651e−05 A 6 = −3.72923e−08
A 8 = −5.19580e−11 A10 = 7.83608e−14 A12 = −7.61217e−16
11th Surface
K = 0.00000e+00 A 4 = −1.98602e−06 A 6 = 1.24590e−09
A 8 = 7.15980e−12 A10 = −7.27344e−14
12th Surface
K = 0.00000e+00 A 4 = 1.74651e−05 A 6 = −3.72923e−08
A 8 = −5.19580e−11 A10 = 7.83608e−14 A12 = −7.61217e−16
13th Surface
K = 0.00000e+00 A 4 = 1.25192e−05 A 6 = −2.18272e−08
A 8 = 2.39426e−11 A10 = −1.99465e−13
14th Surface
K = 0.00000e+00 A 4 = −1.52761e−07 A 6 = 1.51824e−10
A 8 = −4.67105e−13 A10 = −1.43466e−14 A12 = 6.59523e−17
15th Surface
K = 0.00000e+00 A 2 = −3.67253e−02 A 4 = −6.47218e−06
A 6 = −1.64802e−08 A 8 = −4.65932e−11

VARIOUS DATA

| | |
|---|---|
| Focal Length | 47.99 |
| Fno | 1.50 |
| Half Angle of View | 24.26 |
| Image Height | 21.64 |
| BF | 0.10 |

| Object Distance | INF | 480 | 275 |
|---|---|---|---|
| d2 | 11.58 | 9.08 | 6.48 |
| d5 | 2.00 | 2.83 | 3.39 |
| d10 | −2.00 | −2.83 | −3.39 |
| d11 | 2.00 | 2.83 | 3.39 |
| d15 | 11.00 | 12.67 | 14.70 |
| d17 | 0.10 | −4.96 | −9.09 |

NUMERICAL EXAMPLE 20
UNIT: mm
SURFACE DATA

| Surface No. | r | d | nd | νd |
|---|---|---|---|---|
| 1 | −95.586 | 3.00 | 1.91082 | 35.2 |
| 2 | −213.920 | 2.23 | | |
| 3 | 66.966 | 8.02 | 1.61293 | 37.0 |
| 4 | −123.603 | 7.39 | | |
| 5 (SP) | ∞ | 4.18 | | |
| 6 | −76.270 | 1.00 | 1.79950 | 42.3 |
| 7 | ∞ | 3.02 | 1.78800 | 47.5 |
| 8 | −126.465 | 2.00 | | |
| 9* | −69.935 | 2.00 | 1.85400 | 40.4 |
| 10 | −101.262 | 0.00 | | |
| 11 | −101.262 | 0.00 | | |
| 12 | −101.262 | −2.00 | 1.85400 | 40.4 |
| 13* | −69.935 | −2.00 | | |
| 14 | −126.465 | −3.02 | 1.78800 | 47.5 |
| 15 | ∞ | 3.02 | | |
| 16 | −126.421 | 2.00 | | |
| 17* | −69.935 | 2.00 | 1.85400 | 40.4 |
| 18 | −101.262 | 0.00 | | |
| 19 | −101.262 | 1.70 | 1.91082 | 35.2 |
| 20 | 182.675 | 1.00 | | |
| 21 | 46.813 | 10.35 | 1.49700 | 81.6 |
| 22* | −73.680 | 1.20 | | |
| 23 | 79.825 | 6.53 | 1.49700 | 81.5 |
| 24 | −49.719 | 9.40 | | |
| 25 | ∞ | 3.00 | 1.51633 | 64.1 |
| 26 | ∞ | 0.10 | | |
| Image Plane | ∞ | | | |

ASPHERIC DATA
9th Surface
K = 0.00000e+00 A 4 = −1.02932e−06 A 6 = 1.71899e−10
A 8 = −1.82378e−12 A10 = 4.42535e−15 A12 = −4.22552e−18
13th Surface
K = 0.00000e+00 A 4 = −1.02932e−06 A 6 = 1.71899e−10
A 8 = −1.82378e−12 A10 = 4.42535e−15 A12 = −4.22552e−18
17th Surface
K = 0.00000e+00 A 4 = −1.02932e−06 A 6 = 1.71899e−10
A 8 = −1.82378e−12 A10 = 4.42535e−15 A12 = −4.22552e−18
22nd Surface
K = 0.00000e+00 A 4 = 4.77769e−06 A 6 = 3.78844e−09

VARIOUS DATA

| | |
|---|---|
| Focal Length | 32.00 |
| Fno | 0.70 |
| Half Angle of View | 24.38 |
| Image Height | 14.50 |
| BF | 0.10 |
| d26 | 0.10 |

NUMERICAL EXAMPLE 21
UNIT: mm
SURFACE DATA

| Surface No. | r | d | nd | νd |
|---|---|---|---|---|
| 1 | 41.943 | 11.40 | 1.48749 | 70.2 |
| 2 | 716.633 | 4.73 | | |
| 3* | 201.736 | 2.40 | 1.77250 | 49.5 |
| 4* | 72.349 | 5.98 | | |
| 5 (SP) | ∞ | 9.41 | | |
| 6 | ∞ | 3.12 | 1.51742 | 52.4 |
| 7 | −125.229 | 2.34 | | |
| 8 | −89.374 | 2.00 | 1.88300 | 40.8 |
| 9 | −151.660 | −2.00 | | |
| 10 | −89.374 | −2.34 | | |
| 11 | −125.229 | −3.12 | 1.51742 | 52.4 |
| 12 | ∞ | 3.12 | | |
| 13 | −125.229 | 2.34 | | |
| 14 | −89.374 | 2.00 | 1.88300 | 40.8 |
| 15 | −151.660 | 4.00 | | |
| 16* | −51.495 | 2.50 | 1.54400 | 56.0 |
| 17* | −65.237 | 0.15 | | |
| 18 | 69.697 | 9.65 | 1.48749 | 70.2 |
| 19 | −44.228 | 0.11 | | |
| 20 | 2922.340 | 5.40 | 1.90525 | 35.0 |
| 21 | 182.622 | 13.20 | | |
| 22 | ∞ | 3.00 | 1.51633 | 64.1 |
| 23 | ∞ | 0.10 | | |
| Image Plane | ∞ | | | |

ASPHERIC DATA
3rd Surface
K = 0.00000e+00 A 4 = 5.29083e−06 A 6 = −9.38486e−09
A 8 = 8.37198e−12 A10 = −3.53430e−15
4th Surface
K = 0.00000e+00 A 4−7.53551e−06 A 6 = −8.80710e−09
A 8 = 8.79233e−12 A10 = −3.43617e−15
16th Surface
K = 0.00000e+00 A 4 = 1.27331e−05 A 6 = −1.42063e−08
17th Surface
K = 0.00000e+00 A 4 = 1.65139e−05 A 6 = −1.03897e−08
A 8 = −5.14026e−12 A10 = 8.65167e−15

VARIOUS DATA

| | |
|---|---|
| Focal Length | 50.00 |
| Fno | 0.96 |
| Half Angle of View | 23.40 |
| Image Height | 21.64 |
| BF | 0.10 |
| d23 | 0.10 |

NUMERICAL EXAMPLE 22
UNIT: mm
SURFACE DATA

| Surface No. | r | d | nd | νd |
|---|---|---|---|---|
| 1 | 173.495 | 2.00 | 1.88300 | 40.8 |
| 2 | 49.123 | 0.03 | | |
| 3* | 37.190 | 2.00 | 1.54000 | 56.0 |
| 4* | 41.815 | 0.50 | | |
| 5 | 43.296 | 8.70 | 1.64769 | 33.8 |
| 6 | 103.465 | 3.02 | | |
| 7 (SP) | ∞ | 2.00 | | |
| 8 | 46.811 | 11.04 | 1.49700 | 81.5 |
| 9 | −84.883 | 5.74 | | |
| 10 | −74.092 | 1.50 | 1.65160 | 58.5 |
| 11 | ∞ | 4.81 | 1.51633 | 64.1 |
| 12 | −65.199 | 1.87 | | |
| 13* | −63.950 | 2.00 | 1.85400 | 40.4 |
| 14* | −114.321 | −2.00 | | |
| 15* | −63.950 | −1.87 | | |
| 16 | −65.199 | −4.81 | 1.51633 | 64.1 |
| 17 | ∞ | 4.81 | | |
| 18 | −65.199 | 1.87 | | |
| 19* | −63.950 | 2.00 | 1.85400 | 40.4 |
| 20* | −114.321 | 0.20 | | |
| 21 | ∞ | 1.00 | 1.51633 | 64.1 |
| 22 | ∞ | 5.44 | 1.48749 | 70.2 |
| 23 | −52.217 | 12.00 | | |
| 24 | ∞ | 3.00 | 1.51633 | 64.1 |
| 25 | ∞ | 0.10 | | |
| Image Plane | ∞ | | | |

ASPHERIC DATA
3rd Surface
K = 0.00000e+00 A 4 = −6.28932e−06 A 6 = −1.79799e−08
A 8 = −1.23977e−11 A10 = 3.86980e−14
4th Surface
K = 0.00000e+00 A 4 = −3.97301e−06 A 6 = −1.70340e−08
A 8 = −1.09235e−11 A10 = 4.30624e−14
13th Surface
K = 0.00000e+00 A 4 = −1.56151e−06 A 6 = 3.94324e−11
A 8 = 3.89519e−12 A10 = −1.21217e−14 A12 = 1.18319e−17
14th Surface
K = 0.00000e+00 A 4 = 4.92297e−08 A 6 = 6.76632e−10
15th Surface
K = 0.00000e+00 A 4 = −1.56151e−06 A 6 = 3.94324e−11
A 8 = 3.89519e−12 A10 = −1.21217e−14 A12 = 1.18319e−17
19th Surface
K = 0.00000e+00 A 4 = −1.56151e−06 A 6 = 3.94324e−11
A 8 = 3.89519e−12 A10 = −1.21217e−14 A12 = 1.18319e−17
20th Surface
K = 0.00000e+00 A 4 = 4.92297e−08 A 6 = 6.76632e−10

VARIOUS DATA

| | |
|---|---|
| Focal Length | 35.00 |
| Fno | 1.00 |
| Half Angle of View | 31.72 |
| Image Height | 21.64 |
| BF | 0.10 |
| d25 | 0.10 |

NUMERICAL EXAMPLE 23
UNIT: mm
SURFACE DATA

| Surface No. | r | d | nd | νd |
|---|---|---|---|---|
| 1 | 43.558 | 1.80 | 1.69895 | 30.1 |
| 2* | 60.509 | 3.98 | | |
| 3 | 121.002 | 2.41 | 1.49700 | 81.5 |
| 4 | −507.521 | 6.78 | | |
| 5 (SP) | ∞ | 2.36 | | |
| 6 | −124.482 | 1.50 | 2.00330 | 28.3 |
| 7 | ∞ | 1.50 | 1.49700 | 81.5 |
| 8 | 402.886 | 3.43 | | |
| 9* | −465.811 | 2.00 | 1.49700 | 81.5 |
| 10 | −103.041 | −2.00 | | |
| 11* | −465.811 | −3.43 | | |
| 12 | 402.886 | −1.50 | 1.49700 | 81.5 |
| 13 | ∞ | 1.50 | | |
| 14 | 402.886 | 3.43 | | |
| 15* | −465.811 | 2.00 | 1.49700 | 81.5 |
| 16 | −103.041 | 1.70 | 1.88300 | 40.8 |
| 17 | −299.030 | 1.44 | | |
| 18 | −106.107 | 6.87 | 1.48749 | 70.4 |
| 19* | −35.070 | 1.20 | | |
| 20 | 32.823 | 6.31 | 1.49700 | 81.5 |
| 21 | 480.969 | 6.81 | | |
| 22 | ∞ | 3.00 | 1.51633 | 64.1 |
| 23 | ∞ | 0.10 | | |
| Image Plane | ∞ | | | |

ASPHERIC DATA
2nd Surface
K = 0.00000e+00 A 4 = 4.08957e−07 A 6 = −5.56282e−10
9th Surface
K = 0.00000e+00 A 4 = −2.15617e−06 A 6 = −3.25248e−09
A 8 = 1.70004e−11 A10 = −9.65529e−14 A12 = 1.62524e−16
11th Surface
K = 0.00000e+00 A 4 = −2.15617e−06 A 6 = −3.25248e−09
A 8 = 1.70004e−11 A10 = −9.65529e−14 A12 = 1.62524e−16
15th Surface
K = 0.00000e+00 A 4 = −2.15617e−06 A 6 = −3.25248e−09
A 8 = 1.70004e−11 A10 = −9.65529e−14 A12 = 1.62524e−16
19th Surface
K = 0.00000e+00 A 4 = 4.46773e−07 A 6 = −5.83941e−09
A 8 = 5.31116e−12 A10 = −1.07179e−14

VARIOUS DATA

| | |
|---|---|
| Focal Length | 31.99 |
| Fno | 1.20 |
| Half Angle of View | 24.38 |
| Image Height | 14.50 |
| BF | 0.10 |
| d23 | 0.10 |

NUMERICAL EXAMPLE 24
UNIT: mm
SURFACE DATA

| Surface No. | r | d | nd | νd |
|---|---|---|---|---|
| 1 | −1663.968 | 2.00 | 1.61800 | 63.4 |
| 2 | 71.473 | 0.30 | | |
| 3* | 92.922 | 2.04 | 1.54000 | 56.0 |
| 4* | 108.037 | 0.50 | | |
| 5 | 39.338 | 15.64 | 1.48749 | 70.2 |
| 6 | 1004.404 | 1.68 | | |
| 7 (SP) | ∞ | 2.33 | | |
| 8 | 60.041 | 10.92 | 1.49700 | 81.5 |
| 9 | −49.535 | 0.30 | | |
| 10 | −71.257 | 5.59 | 1.69680 | 55.5 |
| 11 | −140.988 | 5.89 | | |
| 12 | −91.635 | 1.50 | 1.59551 | 39.2 |
| 13 | ∞ | 1.60 | | |
| 14* | 213.232 | 2.30 | 1.77250 | 49.5 |
| 15* | 576.812 | 1.26 | | |
| 16 | −124.828 | −1.26 | | |
| 17* | 576.812 | −2.30 | 1.77250 | 49.5 |
| 18* | 213.232 | −1.60 | | |
| 19 | ∞ | 1.60 | | |
| 20* | 213.232 | 2.30 | 1.77250 | 49.5 |
| 21* | 576.812 | 1.26 | | |
| 22 | −124.828 | 1.50 | 1.98612 | 16.5 |
| 23 | ∞ | 1.00 | 1.51633 | 64.1 |
| 24 | ∞ | 0.10 | | |
| 25 | 140.590 | 5.21 | 1.79360 | 37.1 |
| 26 | −85.259 | 10.33 | | |
| 27 | ∞ | 3.00 | 1.51633 | 64.1 |
| 28 | ∞ | 0.10 | | |
| Image Plane | ∞ | | | |

ASPHERIC DATA
3rd Surface
K = 0.00000e+00 A 4 = 1.29859e−06 A 6 = 6.82258e−09
A 8 = 1.75850e−11 A10 = −2.68142e−14
4th Surface
K = 0.00000e+00 A 4 = 4.27604e−06 A 6 = 9.79087e−09
A 8 = 1.77416e−11 A10 = −1.97887e−14
14th Surface
K = 0.00000e+00 A 4 = −6.23100e−06 A 6 = 5.29938e−09
A 8 = −4.53625e−11 A10 = 6.33782e−14
15th Surface
K = 0.00000e+00 A 4 = −4.46191e−06 A 6 = 3.27854e−09
A 8 = −3.42859e−11 A10 = 4.89042e−14
17th Surface
K = 0.00000e+00 A 4 = −4.46191e−06 A 6 = 3.27854e−09
A 8 = −3.42859e−11 A10 = 4.89042e−14
18th Surface
K = 0.00000e+00 A 4 = −6.23100e−06 A 6 = 5.29938e−09
A 8 = −4.53625e−11 A10 = 6.33782e−14
20th Surface
K = 0.00000e+00 A 4 = −6.23100e−06 A 6 = 5.29938e−09
A 8 = −4.53625e−11 A10 = 6.33782e−14
21st Surface
K = 0.00000e+00 A 4 = −4.46191e−06 A 6 = 3.27854e−09
A 8 = −3.42859e−11 A10 = 4.89042e−14

VARIOUS DATA

| | |
|---|---|
| Focal Length | 35.50 |
| Fno | 0.95 |
| Half Angle of View | 31.36 |
| Image Height | 21.64 |
| BF | 0.10 |
| d28 | 0.10 |

NUMERICAL EXAMPLE 25
UNIT: mm
SURFACE DATA

| Surface No. | r | d | nd | νd |
|---|---|---|---|---|
| 1 | 43.323 | 11.34 | 1.48749 | 70.2 |
| 2 | 1026.458 | 6.87 | | |
| 3* | 224.417 | 2.40 | 1.77250 | 49.5 |
| 4* | 67.659 | 5.58 | | |
| 5 (SP) | ∞ | 7.24 | | |
| 6 | ∞ | 2.00 | 1.51633 | 64.1 |
| 7 | ∞ | 1.50 | | |
| 8 | 323.649 | 2.47 | 1.65943 | 60.8 |
| 9 | −369.996 | 1.71 | | |
| 10 | −111.236 | 2.00 | 1.89293 | 39.3 |
| 11 | −157.686 | −2.00 | | |
| 12 | −111.236 | −1.71 | | |
| 13 | −369.996 | −2.47 | 1.65943 | 60.8 |
| 14 | 323.649 | −1.50 | | |
| 15 | ∞ | 1.50 | | |
| 16 | 323.649 | 2.47 | 1.65943 | 60.8 |
| 17 | −369.996 | 1.71 | | |
| 18 | −111.236 | 2.00 | 1.89293 | 39.3 |
| 19 | −157.686 | 0.10 | | |
| 20 | ∞ | 1.80 | 1.51633 | 64.1 |
| 21 | ∞ | 2.95 | | |
| 22* | −35.701 | 2.50 | 1.54400 | 56.0 |
| 23* | −42.066 | 0.15 | | |
| 24 | 75.163 | 9.49 | 1.48749 | 70.2 |
| 25 | −41.912 | 0.11 | | |
| 26 | −125.469 | 6.08 | 1.88300 | 40.8 |
| 27 | −4397.925 | 11.79 | | |
| 28 | ∞ | 3.00 | 1.51633 | 64.1 |
| 29 | ∞ | 0.10 | | |
| Image Plane | ∞ | | | |

ASPHERIC DATA
3rd Surface
K = 0.00000e+00 A 4 = 1.29798e−06 A 6 = −3.96015e−09
A 8 = 4.15359e−12 A10 = −2.08355e−15
4th Surface
K = 0.00000e+00 A 4 = 3.17673e−06 A 6 = −3.76681e−09
A 8 = 5.14754e−12 A10 = −3.01761e−15
22nd Surface
K = 0.00000e+00 A 4 = 1.81465e−05 A 6 = 3.61890e−10
A 8 = −5.09761e−11 A10 = 5.10749e−14
23rd Surface
K = 0.00000e+00 A 4 = 2.06653e−05 A 6 = 2.60284e−09
A 8 = −4.72922e−11 A10 = 4.87368e−14

VARIOUS DATA

| | |
|---|---|
| Focal Length | 50.00 |
| Fno | 0.95 |
| Half Angle of View | 23.40 |
| Image Height | 21.64 |
| BF | 0.10 |
| d29 | 0.10 |

NUMERICAL EXAMPLE 26
UNIT: mm
SURFACE DATA

| Surface No. | r | d | nd | νd |
|---|---|---|---|---|
| 1* | 34.442 | 3.39 | 1.51633 | 64.1 |
| 2* | 49.387 | 14.11 | | |
| 3 (SP) | ∞ | 8.00 | | |
| 4* | −40.752 | 1.50 | 1.54658 | 55.9 |
| 5* | −56.972 | 1.11 | | |
| 6* | 59.695 | 6.31 | 1.54658 | 55.9 |
| 7* | 67.405 | 4.60 | | |
| 8* | −49.479 | −4.60 | | |
| 9* | 67.405 | −6.31 | 1.54658 | 55.9 |
| 10* | 59.695 | −1.11 | | |
| 11* | −56.972 | 1.11 | | |
| 12* | 59.695 | 6.31 | 1.54658 | 55.9 |
| 13* | 67.405 | 4.60 | | |
| 14* | −49.479 | 1.87 | 1.54658 | 55.9 |
| 15* | −39.271 | 11.00 | | |
| 16 | ∞ | 3.00 | 1.51633 | 64.1 |
| 17 | ∞ | 0.10 | | |
| Image Plane | ∞ | | | |

ASPHERIC DATA
1st Surface
K = 0.00000e+00 A 4 = 1.88779e−07 A 6 = 3.81432e−09
A 8 = −6.92099e−12 A10 = 1.47763e−14 A12 = 2.09285e−18
2nd Surface
K = 0.00000e+00 A 4 = 3.34279e−07 A 6 = 4.78843e−09
A 8 = −1.29872e−11 A10 = 2.79285e−14 A12 = −1.08478e−17
4th Surface
K = 0.00000e+00 A 4 = −1.15373e−07 A 6 = 1.61379e−08
A 8 = −1.23993e−10 A10 = 2.56881e−13 A12 = 1.87005e−16
5th Surface
K = 0.00000e+00 A 4 = −4.26715e−06 A 6 = −7.78873e−09
A 8 = 2.53451e−11 A10 = −3.37826e−13 A12 = 9.95687e−16
6th Surface
K = 0.00000e+00 A 4 = −9.31759e−06 A 6 = −5.59292e−08
A 8 = 1.47485e−10 A10 = −4.23025e−13 A12 = −3.93468e−16
7th Surface
K = 0.00000e+00 A 4 = −4.47037e−06 A 6 = −6.44026e−08
A 8 = 2.05905e−10 A10 = −6.27518e−13 A12 = 7.31725e−16
8th Surface
K = 0.00000e+00 A 4 = −1.37402e−06 A 6 = 6.20006e−09
A 8 = −1.27963e−11 A10 = 6.01445e−14 A12 = −1.20501e−16
9th Surface
K = 0.00000e+00 A 4 = −4.47037e−06 A 6 = −6.44026e−08
A 8 = 2.05905e−10 A10 = −6.27518e−13 A12 = 7.31725e−16
10th Surface
K = 0.00000e+00 A 4 = −9.31759e−06 A 6 = −5.59292e−08
A 8 = 1.51573e−10 A10 = −4.08206e−13 A12 = −2.41308e−16
11th Surface
K = 0.00000e+00 A 4 = −4.26715e−06 A 6 = −7.78873e−09
A 8 = 2.53451e−11 A10 = −3.37826e−13 A12 = 9.95687e−16
12th Surface
K = 0.00000e+00 A 4 = −9.31759e−06 A 6 = −5.59292e−08
A 8 = 1.47485e−10 A10 = −4.23025e−13 A12 = −3.93468e−16
13th Surface
K = 0.00000e+00 A 4 = −4.47037e−06 A 6 = −6.44026e−08
A 8 = 2.05905e−10 A10 = −6.27518e−13 A12 = 7.31725e−16
14th Surface
K = 0.00000e+00 A 4 = −1.37402e−06 A 6 = 6.20006e−09
A 8 = −1.27963e−11 A10 = 6.01445e−14 A12 = −1.20501e−16
15th Surface
K = 0.00000e+00 A 4 = −3.44872e−06 A 6 = 2.97587e−08
A 8 = −1.68641e−10 A10 = 5.42072e−13 A12 = −7.60286e−16

VARIOUS DATA

| | |
|---|---|
| Focal Length | 50.00 |
| Fno | 1.50 |
| Half Angle of View | 23.40 |
| Image Height | 21.64 |
| BF | 0.10 |
| d17 | 0.10 |

TABLE 1 summarizes various values in each numerical example.

TABLE 1

| | EX1 | EX2 | EX3 | EX4 | EX5 | EX6 | EX7 | EX8 | EX9 | EX10 | EX11 | EX12 | EX13 |
|---|---|---|---|---|---|---|---|---|---|---|---|---|---|
| Hm2 | 14.331 | 23.145 | 16.252 | 13.062 | 14.699 | 28.562 | 12.242 | 16.554 | 2.594 | 13.911 | 9.394 | 12.886 | 16.459 |
| dpupil | 11.741 | 7.585 | 9.884 | 17.848 | 11.448 | 16.012 | 21.336 | 8.858 | 5.995 | 17.497 | 7.794 | 10.820 | 35.302 |
| Pm1 | 30.106 | 45.751 | 32.528 | 30.175 | 30.224 | 57.434 | 26.500 | 33.518 | 9.862 | 30.178 | 28.378 | 26.960 | 33.778 |
| Δdf | 1.327 | 17.89 | 11.96 | 5.939 | 3.572 | 3.598 | 5.698 | 11.94 | 0.242 | 8.518 | 3.575 | 3.168 | 5.854 |
| φfr | −0.005 | −0.008 | 0.004 | 0.010 | 0.003 | −0.003 | 0.001 | 0.005 | −0.055 | −0.009 | 0.001 | 0.012 | 0.001 |
| φfr/φtotal | −0.235 | −0.269 | 0.126 | 0.221 | 0.095 | −0.096 | 0.013 | 0.147 | −0.425 | −0.443 | 0.042 | 0.388 | 0.046 |
| Hm2/f | 0.299 | 0.723 | 0.508 | 0.603 | 0.459 | 0.893 | 0.704 | 0.517 | 0.335 | 0.290 | 0.209 | 0.403 | 0.514 |
| dpupil/f | 0.245 | 0.237 | 0.309 | 0.824 | 0.358 | 0.500 | 1.228 | 0.277 | 0.775 | 0.365 | 0.173 | 0.338 | 1.103 |
| Pm1/Ppupil | 0.941 | 1.072 | 0.966 | 1.324 | 1.842 | 0.987 | 1.449 | 0.995 | 1.784 | 0.943 | 1.261 | 0.800 | 1.003 |
| Fno | 1.500 | 0.750 | 0.950 | 0.950 | 1.950 | 0.550 | 0.950 | 0.950 | 1.400 | 1.500 | 2.000 | 0.950 | 0.950 |
| φb/φtotal | — | 0.164 | 0.317 | 0.553 | −0.362 | — | 0.212 | — | −0.104 | 0.401 | — | −0.208 | −0.451 |
| Δdf/f/Fno | 0.018 | 0.745 | 0.394 | 0.289 | 0.057 | 0.204 | 0.345 | 0.393 | 0.022 | 0.118 | 0.040 | 0.104 | 0.193 |
| abs(θm) | 17.193 | 0.000 | 0.000 | 0.000 | 0.000 | 0.000 | 0.000 | 0.000 | 34.972 | 26.193 | 0.000 | 0.000 | 0.000 |
| β | — | — | — | 0.663 | — | — | 0.627 | 0.615 | — | — | — | — | — |
| | EX14 | EX15 | EX16 | EX17 | EX18 | EX19 | EX20 | EX21 | EX22 | EX23 | EX24 | EX25 | EX26 |
| Hm2 | 27.927 | 19.451 | 21.110 | 12.438 | 11.170 | 14.747 | 21.786 | 20.061 | 15.003 | 11.542 | 13.486 | 20.455 | 14.145 |
| dpupil | 19.121 | 11.275 | 32.145 | 13.179 | 9.933 | 15.693 | 16.334 | 25.170 | 11.460 | 15.096 | 15.911 | 27.784 | 18.579 |
| Pm1 | 54.914 | 49.376 | 43.827 | 26.535 | 28.275 | 29.485 | 43.025 | 43.241 | 35.250 | 34.000 | 34.42 | 41.638 | 29.621 |
| Δdf | 2.252 | 3.321 | 4.921 | 3.864 | 3.999 | 2.502 | 4.590 | 5.336 | 3.467 | 6.260 | 3.3553 | 5.243 | 6.1738 |
| φfr | −0.001 | 0.003 | 0.002 | 0.010 | 0.001 | −0.007 | 0.000 | 0.005 | 0.006 | 0.003 | 0.0113 | 0.0043 | −0.007 |
| φfr/φtotal | −0.018 | 0.255 | 0.094 | 0.316 | 0.028 | −0.329 | −0.008 | 0.266 | 0.214 | 0.084 | 0.4021 | 0.2166 | −0.331 |
| Hm2/f | 0.873 | 0.195 | 0.406 | 0.389 | 0.516 | 0.307 | 0.681 | 0.401 | 0.429 | 0.361 | 0.3799 | 0.4091 | 0.2829 |
| dpupil/f | 0.598 | 0.113 | 0.618 | 0.412 | 0.459 | 0.327 | 0.510 | 0.503 | 0.327 | 0.472 | 0.4482 | 0.5557 | 0.3716 |
| Pm1/Ppupil | 0.944 | 0.988 | 0.801 | 0.788 | 1.176 | 0.922 | 0.941 | 0.830 | 1.007 | 1.275 | 0.9211 | 0.7911 | 0.8886 |
| Fno | 0.550 | 2.000 | 0.950 | 0.950 | 0.900 | 1.500 | 0.700 | 0.960 | 1.000 | 1.200 | 0.95 | 0.95 | 1.5 |
| φb/φtotal | — | — | — | — | 0.237 | — | — | — | — | 0.307 | — | — | — |
| Δdf/f/Fno | 0.128 | 0.017 | 0.100 | 0.127 | 0.205 | 0.035 | 0.205 | 0.111 | 0.099 | 0.163 | 0.0995 | 0.1104 | 0.0823 |
| abs(θm) | 0.000 | 12.378 | 0.000 | 0.000 | 0.000 | 18.670 | 0.000 | 0.000 | 0.000 | 0.000 | 0.000 | 0.000 | 0.000 |
| β | — | — | — | — | — | — | — | — | — | — | — | — | — |

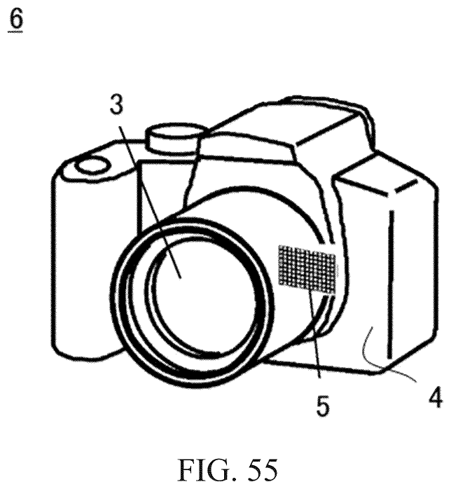

Referring now to FIG. 55, a description will be given of a digital still camera (image pickup apparatus) using the optical system according to any one of the above examples as an imaging optical system. FIG. 15 explains an image pickup apparatus 6 having the optical system according to any one of the above examples. In FIG. 15, reference numeral 4 denotes a camera body, and reference numeral 3 denotes an imaging optical system corresponding to any one of the optical systems OS1 to OS26 according to each example. Reference numeral 5 denotes an image sensor (photoelectric conversion element) such as a CCD sensor or CMOS sensor, which is built into the camera body 4 and configured to receive and configured to photoelectrically convert an optical image formed by the imaging optical system 3. The camera body 4 may be a so-called single-lens reflex camera having a quick return mirror, or a so-called mirrorless camera without a quick return mirror.

The optical system according to each example can be used for imaging cameras of smartphones and distance detecting cameras, lens interchangeable type cameras, lens fixed cameras, lens attached film (disposable cameras), and the like. It may also be used, for example, for visual line (line of sight) detection, biometric recognition, and facial expression recognition in camera finders and XR devices. It may also be used for external recognition applications such as XR devices and automatic robots.

Each example can provide an optical system and image pickup apparatus, each of which has a reduced size and high optical performance over a wide focus range.

While the disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2023-147355, which was filed on Sep. 12, 2023, and which is hereby incorporated by reference herein in its entirety.

What is claimed is:

1. An optical system comprising:
a first transmissive reflective surface;
a second transmissive reflective surface located closer to an image than the first transmissive reflective surface; and
a lens located closer to an object than the first transmissive reflective surface or closer to the image than the second transmissive reflective surface,
wherein the first transmissive reflective surface is configured to move in an optical axis direction during focusing, and
wherein the lens is separated from each of the first transmissive reflective surface and the second transmissive reflective surface.

2. The optical system according to claim 1, wherein the lens is located closest to the object.

3. The optical system according to claim 1, wherein the following inequality is satisfied:
$$- 1. \leq φ fr / φtotal \leq 0.42$$
where φfr is refractive power of a portion of the optical system on an object side of the first transmissive reflective surface, and φtotal is power of the optical system.

4. The optical system according to claim 1, wherein in a case where an on-axis marginal ray is reflected by the second transmissive reflective surface, the following inequality is satisfied:
$$0.15 \leq Hm 2 / f \leq 3.$$
where Hm2 is a distance from an optical axis to a reflection point in a direction perpendicular to the optical axis, and f is a focal length of the optical system.

5. The optical system according to claim 1, wherein the following inequality is satisfied:
$$0. \leq dpupil / f \leq 2.$$
where dpupil is a distance from a surface closest to an object of the optical system to an entrance pupil of the optical system, and f is a focal length of the optical system.

6. The optical system according to claim 1, wherein the following inequality is satisfied:
$$0.6 \leq Pm 1 / Ppupil \leq 2.$$
where Pm1 is an effective diameter of the first transmissive reflective surface, and Ppupil is an entrance pupil diameter of the optical system.

7. The optical system according to claim 1, wherein the following inequality is satisfied:
0.5≤Fno≤2.5
where Fno is an F-number of the optical system.

8. The optical system according to claim 1, further comprising a lens that is disposed on an object side of the first transmissive reflective surface, separated from the first transmissive reflective surface, and configured to move integrally with the first transmissive reflective surface during focusing,
wherein the following inequality is satisfied:
$$- 1. \leq φ b / φtotal \leq 0.7$$
where φb is refractive power of a portion of the optical system on an object side of a lens unit that moves integrally with the first transmissive reflective surface during focusing, and φtotal is power of the optical system.

9. The optical system according to claim 1, wherein the following inequality is satisfied:
$$0.005 \leq \vert Δ df \vert / f / Fno \leq 1.$$
where |Δdf] is a moving amount during focusing from infinity to a distance corresponding to 10 times a focal length of the optical system, f is a focal length of the optical system, and Fno is an F-number of the optical system.

10. The optical system according to claim 1, wherein a distance between the first transmissive reflective surface and the second transmissive reflective surface changes during focusing.

11. The optical system according to claim 1, further comprising an aperture stop configured to move integrally with the first transmissive reflective surface in the optical axis direction during focusing.

12. The optical system according to claim 1, further comprising a lens disposed outside an area between the first transmissive reflective surface and the second transmissive reflective surface, and configured to move in the optical axis direction during focusing.

13. The optical system according to claim 1, wherein during focusing, each of the first transmissive reflective surface and the second transmissive reflective surface are configured to not rotate by 0.5° or more around an optical axis.

14. The optical system according to claim 1, wherein the following inequality is satisfied:
0.0≤|θm|≤8.0
where θm (°) is the smaller of an open angle of the first transmissive reflective surface and an open angle of the second transmissive reflective surface.

15. The optical system according to claim 1, wherein at least one of the first transmissive reflective surface and the second transmissive reflective surface is provided on a cemented surface of two light transmitting members.

16. The optical system according to claim 1, wherein at least one of the first transmissive reflective surface and the second transmissive reflective surface is spherical.

17. The optical system according to claim 1, further comprising an image stabilizing unit disposed on an object side of the first transmissive reflective surface.

18. The optical system according to claim 17, wherein the following inequality is satisfied:
0.6≤β≤1.5
where β is a lateral magnification of a unit disposed on an image side of the second transmissive reflective surface.

19. An image pickup apparatus comprising:
an optical system; and
an image sensor,
wherein the optical system includes:
a first transmissive reflective surface;
a second transmissive reflective surface located closer to an image than the first transmissive reflective surface; and
a lens located closer to an object than the first transmissive reflective surface or closer to the image than the second transmissive reflective surface,
wherein the first transmissive reflective surface moves in an optical axis direction during focusing, and
wherein the lens is separated from each of the first transmissive reflective surface and the second transmissive reflective surface.
